(19) United States
(12) Patent Application Publication
(10) Pub. No.: US 2002/0152133 A1
(43) Pub. Date: Oct. 17, 2002

(54) Marketplaces for on-line contract negotiation, formation, and price and availability querying

(76) Inventors: John Thorne King, Alpharetta, GA (US); William Allman LeVine, Alpharetta, GA (US); Kevin Cronin, Long Valley, NJ (US); Joyce M. Nuszbaum, Lawrenceville, GA (US); Peter Shizek, Mosen (CH)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/096,404

(22) Filed: Mar. 11, 2002

Related U.S. Application Data
(60) Provisional application No. 60/274,705, filed on Mar. 9, 2001.

(51) Int. Cl. G06F 17/60

(52) U.S. Cl. 705/26

(57) ABSTRACT

An on-line marketplace enables negotiation and formation of a contract between a buyer and seller. Through a requisition check, buyers are able to check the price and/or availability of goods with one or more sellers. After knowing price and availability, the buyers send orders for desired goods to the sellers through the marketplace and enter into a legally binding contract upon acceptance. The terms and conditions of the contract are determined from any prior agreement, from country-specific terms on the marketplace for the supplier, from technical disclaimers for data on the goods, and from any agreed upon modifications. The marketplace permits automation and expedition in the ordering process by automatically submitting orders upon confirmation of the requisition check and by automatically accepting orders. The marketplace offers full integration with customers' ERP systems and also offers a simpler integration involving data transfer from the customer's system, such as file transfer called UltraLite.

### CROSS-REFERENCE TO RELATED APPLICATIONS

This application claims priority to, and incorporates by reference, co-pending U.S. application Ser. No. 60/274,705 entitled “System and Method for online negotiation process,” filed on Mar. 9, 2001.

### FIELD OF THE INVENTION

The present invention relates to systems and methods providing an on-line marketplace and, more particularly, to systems and methods that enable on-line negotiation, contract formation and/or querying into price and availability of desired goods. According to another aspect, the invention relates to on-line sourcing integrated with on-line order to cash.

### BACKGROUND

On-line marketplaces have been touted as offering improved efficiencies to buyers and sellers. These on-line marketplaces include business-to-business exchanges, such as both vertical and horizontal exchanges. A number of patents have issued to such exchanges, such as U.S. Pat. Nos. 5,809,144 to Sirbu et al., 6,055,579 to Kennedy et al., 6,141,153 to Conklin et al., 6,061,691 to Fox, 6,035,283 to Solomon, 5,794,207 to Walker et al., and 5,924,082 to Silverman et al. These patents describe methods for purchasing and delivering goods, including price negotiation, goods delivery, and payment. These patents are hereby incorporated by reference.

Many of the exchanges described in these patents are of limited practical use. In theory, suppliers have an infinite amount of goods to provide and buyers can use these exchanges to find the lowest price. In reality, however, many additional factors must be considered in a complicated relationship between a buyer and seller of goods. The buyer needs to use goods for a particular purpose and may or not have some flexibility in the types of goods that it is willing to receive. In addition to the type of goods, the buyer may have a timeline when the goods must be received. On the other hand, the supplier typically has a limited quantity of goods that it can deliver and may be considering multiple options as to who receives the goods in a given time interval. These and other real-world factors often are not sufficiently addressed within on-line marketplaces. As a result, many of these on-line marketplaces do not provide a practical solution.

The on-line marketplaces provide some success with large trading partners. For example, a supplier may establish its own private on-line marketplace serving multiple buyers. Between multiple buyers and multiple sellers, however, many on-line marketplaces have not fared well. Often, the cost to a buyer or supplier in integrating with an on-line marketplace is rather high and must be incurred before any tangible results have been realized. The on-line marketplace therefore in effect creates a barrier entry even though many on-line marketplaces seek to reduce barriers to entry and reduce overall costs. The difficulty in using an on-line marketplace is especially problematic for smaller companies who are even less able to afford the integration process to the on-line marketplace.

Many on-line marketplaces also have not fared well because of existing trading relationships between buyers and suppliers. Over the years, buyers and suppliers have built up strong relationships which do not justify the interjection of a third party. Furthermore, even if the parties are willing to allow a third party to manage their relationship, the parties may be unwilling to the terms imposed by that third party. In other words, the parties may have an existing agreement in place and one or both parties may be unwilling to unravel that agreement in order to redefine their relationship.

Another limitation of conventional on-line exchanges is that they are not equipped to handle the sourcing of goods. In a typical sourcing relationship, the parties enter into a master agreement and the supplier agrees to deliver a given quantity of goods at certain times throughout the contract term. This type of transaction is not simply the delivery of a certain quantity of goods at one time for given price. Because a sourcing relationship is a more long-term relationship which may reflect fluctuations in demand and/or supply, conventional on-line exchanges do not provide adequate support for these types of arrangements.

### SUMMARY

The invention addresses the above problems by providing systems and methods for creating on-line marketplaces. According to one aspect of the invention, the marketplace permits a buyer to issue a requisition check inquiring into at least one of the price and availability of goods. The marketplace receives this requisition check and forwards it to the sellers or suppliers of the goods. Each supplier then issues a response indicating the price and/or availability of the goods. Based on this requisition check, the buyer then formulates an order which is passed through the marketplace to the suppliers. The suppliers can accept the order or issue a counterproposal. The marketplace tracks the requisition checks, responses to the requisition checks, submitted orders, and responses to orders.

The marketplaces, according to an aspect of the invention, create legally binding contracts between the buyers and suppliers. The marketplaces maintain terms and conditions of contracts that govern the transactions conducted between the buyers and suppliers. The marketplace maintains these terms and conditions based upon the supplier whereby different suppliers may have different terms and conditions. Furthermore, the marketplace maintains terms and conditions adapted to the law of the country to which the goods will be shipped. In order to comply with certain country-specific requirements, the marketplaces allow the customers to review the terms and conditions of a sale before accepting an offer. Advantageously, the marketplaces do not completely displace any existing agreements between buyers and suppliers. Instead, the terms and conditions of the contract between a buyer and supplier can be dictated by the terms of a preexisting agreement. Furthermore, the parties may mutually agree to depart from the terms of such a prior agreement or from the terms set forth on the marketplace and these modifications become part of the legally binding contract. The marketplace also maintains technical disclaimers on specific goods with these technical disclaimers concerning data sheets posted on the marketplace with detailed specifications on specific goods, and these technical disclaimers form part of the contract between the parties.

As mentioned above, one problem with conventional on-line exchanges is the difficulty in integrating the exchanges with the customers' systems. According to another aspect of the invention, the marketplaces can fully integrate with the customers' Enterprise Resource Planning (ERP) system and handle messaging that occurs between the buyers' and suppliers' ERP systems. As an alternative, the marketplaces offer a simpler approach that do not require full integration with the customers' ERP system. With this simpler approach, commonly referred to as UltraLite integration, the marketplace itself handles some of the messaging with the other customers' ERP system and allows for a browser interface or file transfer interface. This type of integration is less expensive and imposes less of a barrier to entry for joining the marketplace. Thus, from this file transfer to the marketplace, the marketplace can handle the placement of orders to suppliers and can handle change requests. After using this approach, the customer may later choose to adopt the full integration having both outbound and inbound messaging capability.

In the ordering process, the marketplace provides buyers with various automation options. One option that the marketplace provides to buyers is the option to Auto-Submit orders. If this option is selected, then an order will be automatically submitted by the marketplace if the supplier confirms the price and availability of requested goods. An Auto-Accept option allows an order to be processed as requested with the price and quantity of goods or with a best alternative. An order can also be accelerated by permitting those items that have been accepted by the suppliers to be placed in one order and the remaining items which are awaiting supplier approval to be placed in a second possible order. These options may be selected individually or in any combination in order to expedite the processing of orders according to the desires of the customers.

According to another aspect, the invention relates to systems and methods for providing sourcing of goods. The sourcing process according to a preferred embodiment allows buyers to issue a request for quote (RFQ) and receive responses from suppliers. Upon a match between a response and the RFQ, the marketplace forms a master agreement. Orders under this master agreement can be initiated through the demand forecasting. From a forecast, a price and availability request is sent from the buyer to the supplier and, upon a match, an order is created. The order is subject to a legally binding contract which can be changed by the parties upon mutual assent. The sourcing process according to the invention also provides for auditing versus a contract and reconciling invoices, payments, shipped goods, received goods, and the contract itself.

### BRIEF DESCRIPTION OF DRAWINGS

The accompanying drawings, which are incorporated in and form a part of the specification, illustrate preferred embodiments of the present invention and, together with the description, disclose the principles of the invention. In the drawings:

FIG. 1 is a diagram of a network including a marketplace system (“marketplace”) according to an embodiment of the invention;

FIG. 2 is a flow chart of a general method of operation for the marketplace;

FIG. 3 is a more detailed diagram of the network of FIG. 1;

FIG. 4 is a more detailed flow chart of operation for the marketplace;

FIG. 5 is an order process performed by the marketplace with an Auto-Submit option;

FIG. 6 is an order process performed by the marketplace with an Auto-Submit and accelerate option;

FIG. 7 is an order process performed by the marketplace with an Auto-Accept option;

FIG. 8 is an order process performed by the marketplace with full automation by using Auto-Submit and Auto-Accept options;

FIG. 9 is an order process with full automation using a partial integration with the buyer;

FIG. 10 is a process flow for a requisition check process;

FIGS. 11(A) and 11(B) are a flow chart of a requisition check response process;

FIGS. 12(A) and 12(B) are a flow chart for a confirm order process;

FIG. 13 is a flow chart for a confirm order response process;

FIGS. 14(A) and 14(B) are a flow chart for an order change process initiated by the buyer;

FIGS. 15(A) and 15(B) are a flow chart for an order change process initiated by the supplier;

FIG. 16 is a flow chart for a shipment notification process;

FIG. 17 is a flow chart for a customer inquiry process;

FIGS. 18(A) to 18(F) are examples of flow charts illustrating a repeat order process;

FIG. 19(A) to 19(I) are examples of flow charts for a negotiation centric order process;

FIG. 20 is a flow chart of a process adopting manual UltraLite integration;

FIG. 21 is a flow chart of a process adopting automatic UltraLite integration;

FIG. 22 is a flow chart of a process adopting UltraLite integration with direct to order;

FIG. 23 is a flow chart of an UltraLite change order process;

FIG. 24 is a flow chart of operation for UltraLite integration with an inbound messaging option;

FIG. 25(A) is a flow chart illustrating a sourcing process and order to cash process and FIG. 25(B) is a more detailed flow chart of the sourcing process;

FIG. 26 is a flow chart for sourcing with forecast;

FIG. 27 is a flow chart for audit/reconcile;

FIG. 28 is a flow chart for a cash process;

FIG. 29 is a main interface to the marketplace according to another embodiment of the invention;

FIGS. 30(A) to 30(F) are interfaces illustrating search capabilities of the marketplace;

FIGS. 31(A) to 31(C) are interfaces for generating a requisition check;

FIGS. 32(A) to 32(D) are interfaces presenting the terms and conditions for using the marketplace;

FIGS. 33(A) to 33(C) are interfaces explaining dispute resolution procedures;

FIGS. 34(A) to 34(I) are interfaces presenting suppliers terms and conditions based on country and technical disclaimers;

FIG. 35 is an interface to an ordering application;

FIGS. 36(A) to 36(H) illustrate interfaces for generating a requisition check;

FIG. 37 is an interface illustrating transmission of the requisition check;

FIG. 38 is an interface providing a summary of an order;

FIGS. 39(A) to 39(D) illustrate interfaces showing terms and conditions governing an order;

FIG. 40 is an interface requiring the buyer to enter an approval code;

FIGS. 41(A) and 41(B) provide information on open orders;

FIG. 42 is an example of an interface for uploading files to the marketplace;

FIGS. 43(A) to 43(F) are interfaces illustrating a one-step ordering process;

FIGS. 44(A) and 44(B) are interfaces providing information on changed orders;

FIG. 45 is an interface showing information on shipped orders;

FIG. 46 is an interface showing an alternative approach to initiating an order;

FIG. 47 is an example of another type of interface for managing orders;

FIGS. 48(A) to 48(F) are interfaces showing payment processes;

FIG. 49 is an interface illustrating the sourcing process; and

FIGS. 50(A) and 50(B) are logical diagrams of a system for implementing the marketplace.

### DETAILED DESCRIPTION

Reference will now be made in detail to preferred embodiments of the invention, non-limiting examples of which are illustrated in the accompanying drawings.

I. Overview

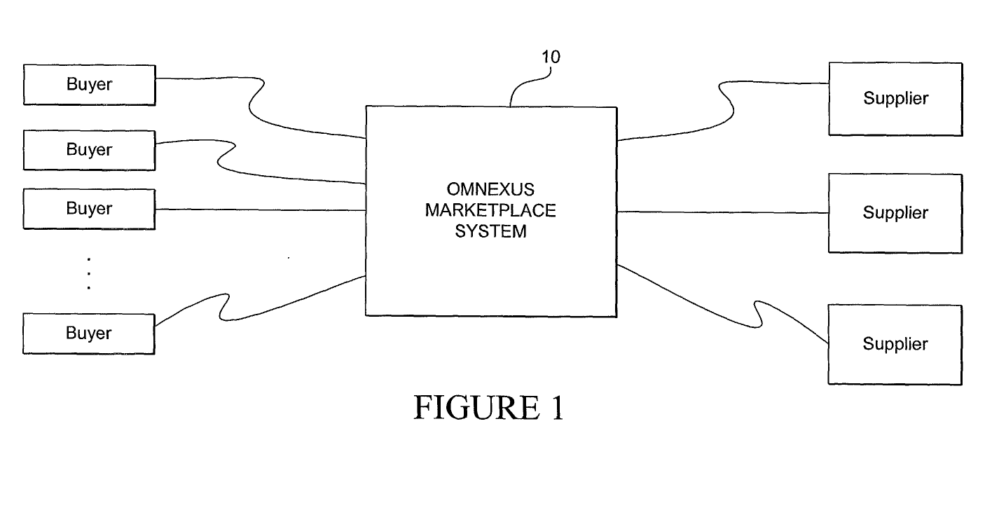

A marketplace 10 according to a preferred embodiment of the invention will now be described with reference to FIG. 1. This marketplace 10 permits buyers and sellers, such as suppliers, to enter into transactions for the purchase of goods. Through the marketplace, the buyers are able to review catalogs of goods from the suppliers, place orders for the goods, and transfer payment to the suppliers. The marketplace 10 has a number of advantages in additional features which makes it unique over conventional on-line marketplaces, such as other business-to-business exchanges.

The buyers and suppliers using the marketplace 10 may comprise a variety of different types of entities. For example, the buyers may comprise resellers, distributors, franchisees, retail chains, manufacturers, etc. The marketplace 10 is geared primarily to businesses, but in some aspects of the invention, the buyer could be a consumer. The supplier may comprise any seller of goods, such as but not limited to a manufacturer, distributor, reseller, franchiser, or in even some aspects a retail store.

The buyers and suppliers preferably access the marketplace 10 through a computer. Thus, for the purposes of this description, the interfaces and user devices will be for a computer. The invention, however, is not limited to just user devices which comprise computers.

As will be appreciated by those skilled in the art, users are able to access networks in numerous ways other than just through a PC. For example, the user may use a mobile phone, personal data assistant (PDA), lap-top computers, digital TV, WebTV, and other TV products. The invention may be used with these types of products and can accommodate new products as well as new brands, models, standards or variations of existing products.

In addition to using any type of product or device, the customers can access the marketplace 10 in any suitable manner. The network will, of course vary, with the product receiving the information but includes, but is not limited to, AMPS, PCS, GSM, NAMPS, USDC, CDPD, IS-95, GSC, Pocsag, FLEX, DCS-1900, PACS, MIRS, e-TACS, NMT, C-450, ERMES, CD2, DECT, DCS-1800, JTACS, PDC, NTT, NTACS, NEC, PHS, or satellite systems. For a lap-top computers, the network may comprise a cellular digital packet data (CDPD) network, any other packet digital or analog network, circuit-switched digital or analog data networks, wireless ATM or frame relay networks, EDGE, CDMAONE, or generalized packet radio service (GPRS) network. For a TV product, the network may include the Internet, coaxial cable networks, hybrid fiber coaxial cable systems, fiber distribution networks, satellite systems, terrestrial over-the-air broadcasting networks, wireless networks, or infrared networks. The same type of networks that deliver information to mobile telephones and to lap-top computers as well as to other wireless devices, may also deliver information to the PDAs.

Similarly, the same types of networks that deliver information to TV products may also deliver information to desk-top computers. It should be understood that the types of networks mentioned above with respect to the products are just examples and that other existing as well as future-developed networks may be employed and are encompassed by the invention. The communications between customers and the marketplace 10 involves not only HTML but also XML, WAP, HDML, and other protocols.

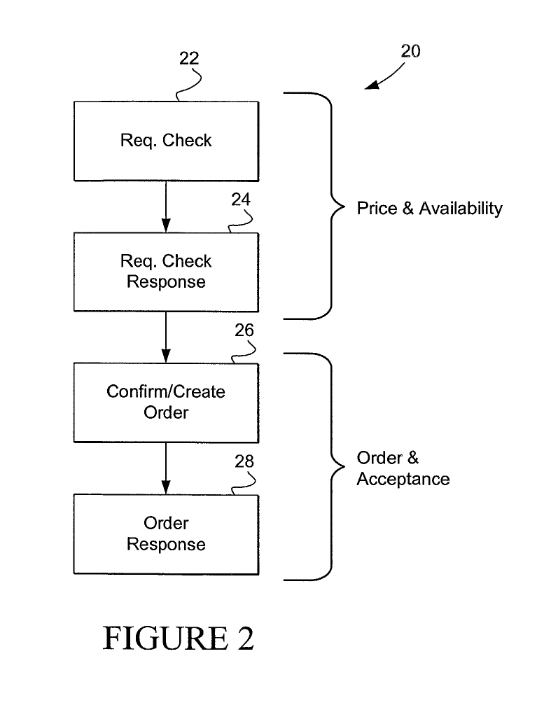

A method 20 of operation for using the marketplace 10 will now be described with reference to FIG. 2. At 22, the buyer issues a requisition check to one or more of the suppliers. At 24, the one or more suppliers issues a response to that check which then allows the buyer at 26 to formulate an order. Finally, at 28, the supplier can confirm or accept that order. The method 20 generally involves the ability to do a price and availability check through the buyer and suppliers actions at 22 and 24. The requisition check may therefore be a check into price or may be a check as to availability. Thus, through 22 and 24, the buyer can determine what goods are available and the price of those goods.

Once the buyer then knows the price of available goods, the buyer and seller can then form a contract at 26 and 28. As will be explained in more detail below, the buyer and supplier enter into a legally binding contract through their actions at 26 and 28 with all of the terms and conditions of the contract being agreed to by the parties and available for review. Also, as discussed in more detail below, the terms of the binding contract can vary depending upon if the parties have a preexisting agreement in place, based on the supplier, based on the country or countries involved in an order, and even based on the goods themselves.

As described above, the marketplace 10 is suitable for many different types of buyers and suppliers. In the preferred embodiment of the invention, the marketplace 10 is especially useful when one of the buyers or suppliers is fragmented. For example, in the plastics industry, the buyers are generally smaller companies and are fairly fragmented whereas the suppliers comprise a relatively small number of large companies. For the purposes of this description, the marketplace 10 will be described with reference to this scenario. Those skilled in the art will appreciate that the marketplace 10 can be adopted in other industries and by other groups of buyers and suppliers.

II. System Overview

The marketplace 10 is a global, independent e-marketplace serving the complete needs of the plastics industry. The marketplace 10 allows registered buyers to access information and place orders for multiple products from multiple registered suppliers. The marketplace 10 further facilitates an online negotiation process between the buyers and suppliers. While this document relates to a plastics industry e-marketplace, the technology and processes disclosed herein could be used in a wide variety of e-marketplaces.

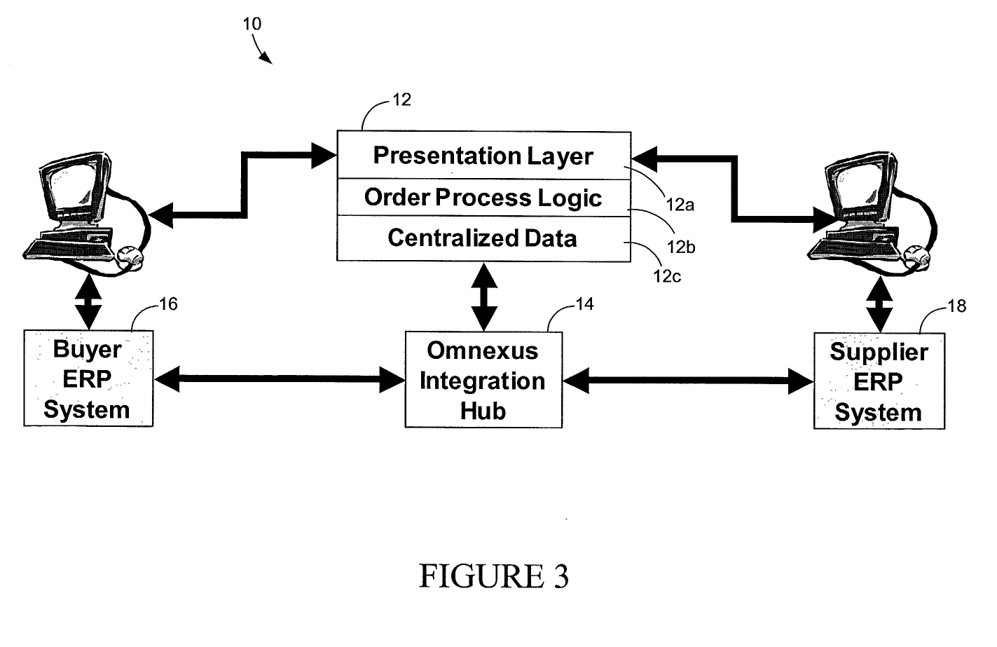

A more detailed diagram of the marketplace 10 is shown in FIG. 3. The marketplace 10 includes an order application unit 12 and an integration hub 14. The integration hub 14 performs messaging between the buyers and suppliers, such as between a buyers ERP system 16 and a suppliers ERP system 18. The buyers ERP system 16 stores demand requirements, contract information, and information on internal trading partners. The buyers ERP system 16 initiates orders and stores order confirmation. The suppliers ERP system 18 stores supply capability, product price and availability, contract information, and information on internal trading partners. The suppliers ERP system 18 also stores orders. The ERP systems 16 and 18 may be comprised, at least in part, by enterprise resource planning connectivity provided through Elemica of Wayne, Pa. The ERP systems 16 and 18 are not limited to this type of ERP system but may be solutions provided through other companies.

The order application unit 12 preferably has a three layer model in which a centralized data layer 12c stores data for transactions, business policy, and trading partner identification. An order process logic layer 12b provides business logic for handling messages and other communications between the buyers and suppliers, in handling orders, and in handling requisition checks. A presentation layer 12a enables exception handling, accelerates adoption, and supports browser based buying. In essence, this three layer model permits the presentation of information, including any necessary transporting, to be separated from the business logic or process logic layer 12b, which in turn is separated from the manner in which data is stored and accessed.

In the preferred embodiment, the marketplace 10 incorporates non-repudiation. For browser access, the marketplace 10 requires a “Legal” digital signature by requiring users to log into the marketplace 10 using a user ID and password. A unique buyer authentication code is used to initiate the placement of any order. The marketplace 10 adopts secure messaging, such as HTTPS and VPN technology, to ensure message security through encryption, verification of sender, and validation of requests and corresponding responses. The marketplace 10 preferably exchanges data with its customers through XML, and more preferably, through ChemXML eStandards.

To initiate an order, a registered buyer logs on to the marketplace 10, such as through the portal or website, using an industry standard Internet browser on any means available to access the Internet, such as a personal computer, hand held device, or mobile telephone. Once on the marketplace 10, the buyer selects the ordering function. The buyer then builds an order by selecting a previously stored order, accessing the on-line product catalog to build a new order, or a combination of both. The product catalog is a database of products provided by suppliers belonging to the marketplace 10. The buyer inputs the required fields, such as supplier, product type, quantity, and delivery date, of an order template by using a “1 step process” or completing line item details of each item on the order. An order can contain multiple products from multiple suppliers. Additionally, the buyer can indicate whether the order is to be auto accepted if the response falls within an acceptable range. A buyer then submits the completed order, referred to as a “Req Check” or a Price and Availability (P&A) Check, as an XML message to the marketplace 10. Additionally, a buyer's Enterprise Resource Planning (ERP) system could perform the entire ordering process.

The marketplace 10 receives the Req Check and records the line items from the Req Check, so that the marketplace 10 can maintain the status of the buyer's order. The marketplace 10 also creates a separate Req Check message for each supplier indicated by the buyer. Depending on the supplier's preference, the marketplace 10 places the Req Check message on a manual browser so the supplier can access it or the marketplace sends the Req Check message to the supplier's ERP system via an Integration Hub. The marketplace also sends an e-mail notification of Req Check to each supplier.

The Integration Hub routes and sends messages to and from the suppliers′ (or buyers') ERP systems. The supplier then manually or automatically responds to the Req Check. The supplier responds (automatically or manually) by either agreeing with all of the line items (e.g., product, quantity, and price), creating a counter proposal (e.g., different product, different quantity, or different delivery date), or rejecting all of the line items. The supplier creates (automatically or manually) an XML Req Check Response message and sends the message to the Omnexus Marketplace.

Once received by the marketplace, the marketplace assesses the status of the message (i.e., initial Req Check changed or unchanged). According to the status of the message and the preferences set for the specified buyer, various tasks are performed by the marketplace. For example, the marketplace verifies that the products entered by the supplier are in the product catalogue. If a particular product entered by a supplier is not in the product catalogue, the marketplace notifies the supplier via, for example, e-mail. Moreover, if the buyer has indicated that the order is auto-acceptance, the marketplace turns the status of all line items into proceed. Additionally, the buyer's order is updated with the XML Req Check Response from each supplier. The marketplace sends an email notification to the buyer that a Req Check Response has been sent from the supplier. The marketplace further sends the Req Check Response to the buyer. The Req Check Response can be sent directly to a buyer's ERP system or can be placed on the manual browser for access by the buyer.

Once the buyer receives the Req Check Response, the buyer either accepts the whole response, accepts some of the line items and rejects others, or restarts the Check Requisition process. Acceptance is based on three levels: exact match, tolerance rules, or automatic acceptance. If accepted by the buyer, a Confirm or Create Order message is created automatically by the marketplace or manually by the buyer depending on the buyer's preferences. The marketplace sends the supplier a “Confirm Order” XML message. An e-mail notification of Confirm Order is sent to each supplier.

Once the Confirm Order message is received by the supplier, the supplier can accept the order, accept only certain line items and reject certain line items of the order, or reject the entire order. In any case, a purchase order acknowledgement is sent to the marketplace via an XML message, “Confirm Order Response”. An e-mail notification is sent to the customer that a Confirm Order response has been sent from the supplier. The customer order is updated with the final status from the supplier. The customer and supplier then have the ability to agree on changing the order via phone, email, or negotiation tools provided by the marketplace.

A Change Order via the marketplace can be initiated by the buyer or the supplier. The change order process is very similar to the ordering process. When the supplier ships the product to the buyer, an XML message is sent to the marketplace. The marketplace sends an email notification to the buyer that a Order Status has been sent from the supplier. The buyer's order is updated with shipment information.

III. Process Flow Overview

A. General Process Flow

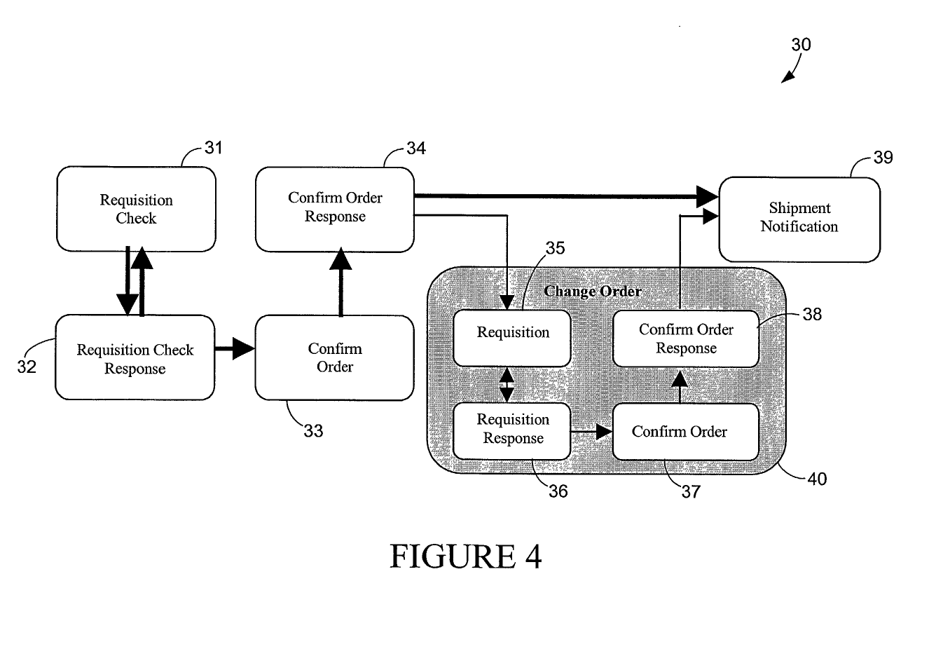

A more detailed process 30 of operation for the marketplace 10 will now be described with reference to FIG. 4. The method 30 begins at 31 with a requisition check. This requisition check allows buyers to determine the price and availability of desired goods. The marketplace 10 receives this requisition check and forwards it to the supplier which then at 32 generates a requisition check response which includes information on the price and availability of the selected goods. This requisition check can be considered as a inquiry into the availability of an order and based on the requisition check response at 32 the buyer can then confirm or create an order at 33. The marketplace 10 receives the order from the buyer and forwards the order to the relevant supplier or supplies. The supplier then generates an order response which may constitute an acceptance of the offer reflected in the order at 33. If it is, then the supplier proceeds in fulfilling the goods and provides notification to the marketplace 10 when shipment has occurred at 35. The marketplace 10 then forwards the notification to the buyer.

The method 30 also incorporates the ability to have a change order 40. A change order sub-process 40 involves the initiation of a requisition at 36 which can be from either the buyer or supplier. A requisition response is generated at 37 and forwarded to the other party through the marketplace 10. At 38, based on the requisition and requisition response, the parties can then exchange a confirm order at 38 followed by a confirm order response 39 reflecting their agreed upon change to an order.

B. Process Flow Options

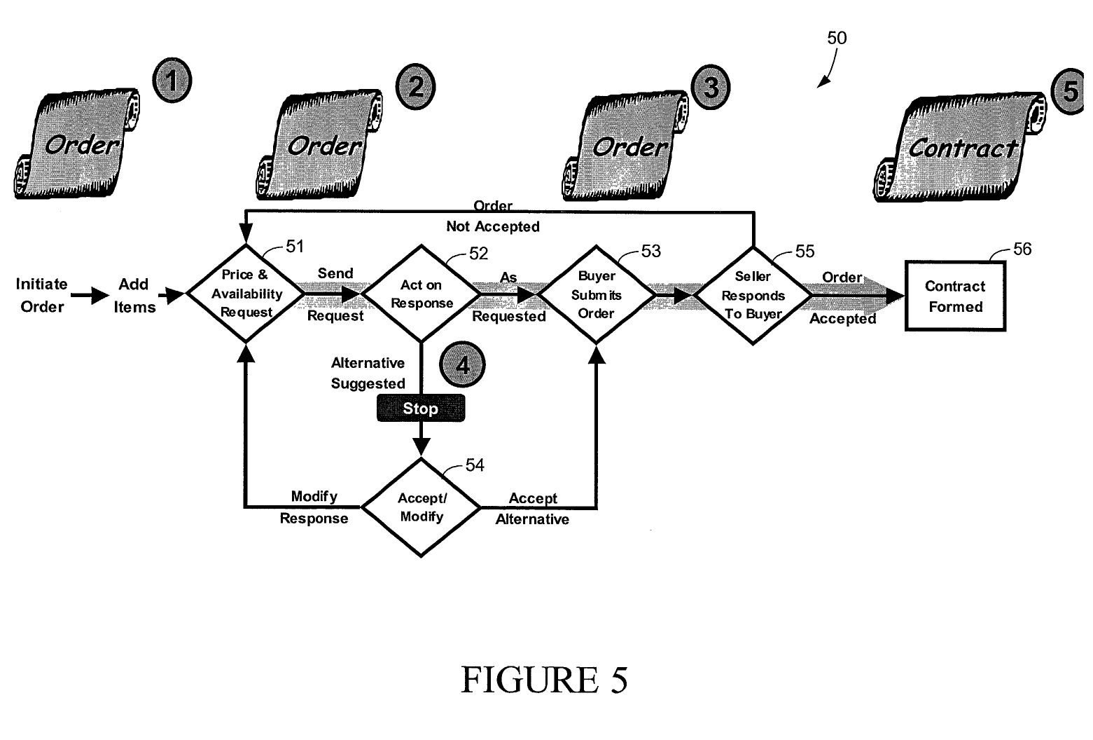

In the process 30, the buyer has options to Auto-Submit an order and also to Auto-Accept the order. The Auto-Submit and Auto-Accept options may be used in combination or individually in order to expedite processing of orders. FIG. 5 provides an example of an ordering process 50 with Auto-Submit. At 51, the buyer initiates a price and availability request after initiating an order and adding items to that order. The request is sent through the marketplace 10 to the relevant suppliers which then act on the request and issue a response at 52. When the request was issued at 51, the buyer selected the Auto-Submit option accepted the terms and conditions, and entered an authorization code. If the supplier accepts as requested at 52, then the order is placed at 53 and a binding contract has been formed. If the supplier does not accept as requested, then the order stops and the supplier at 54 can suggest an alternative. The Auto-Submit therefore bypasses the need for the buyer to confirm the order at 33 if the supplier is willing to accept as requested.

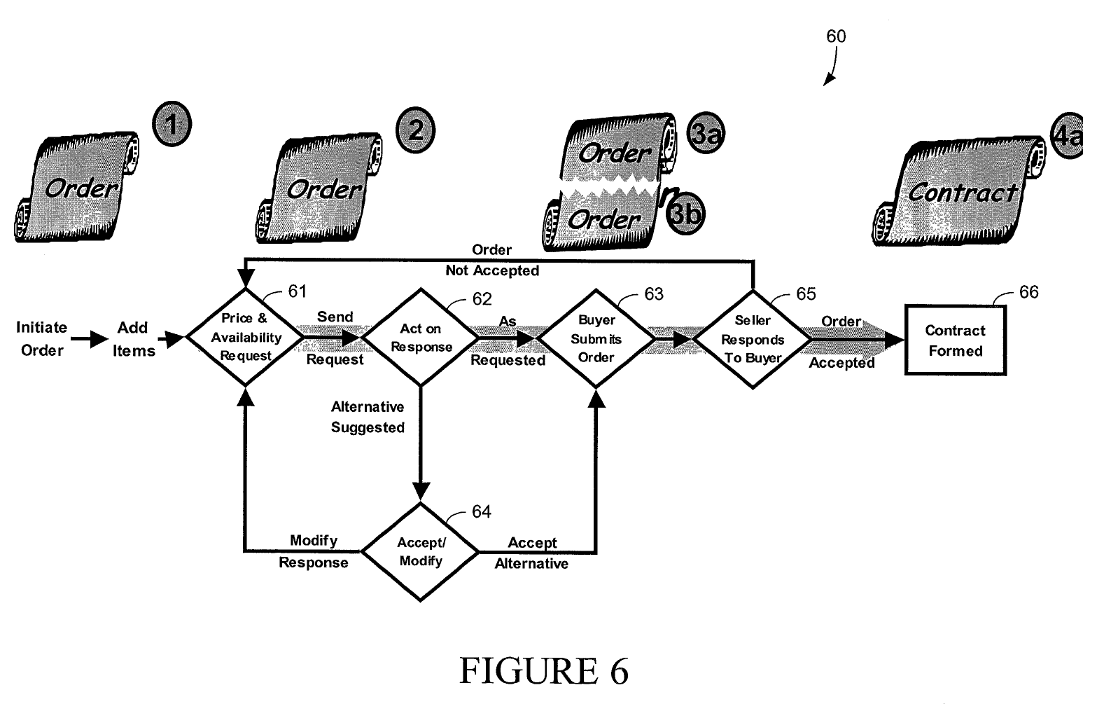

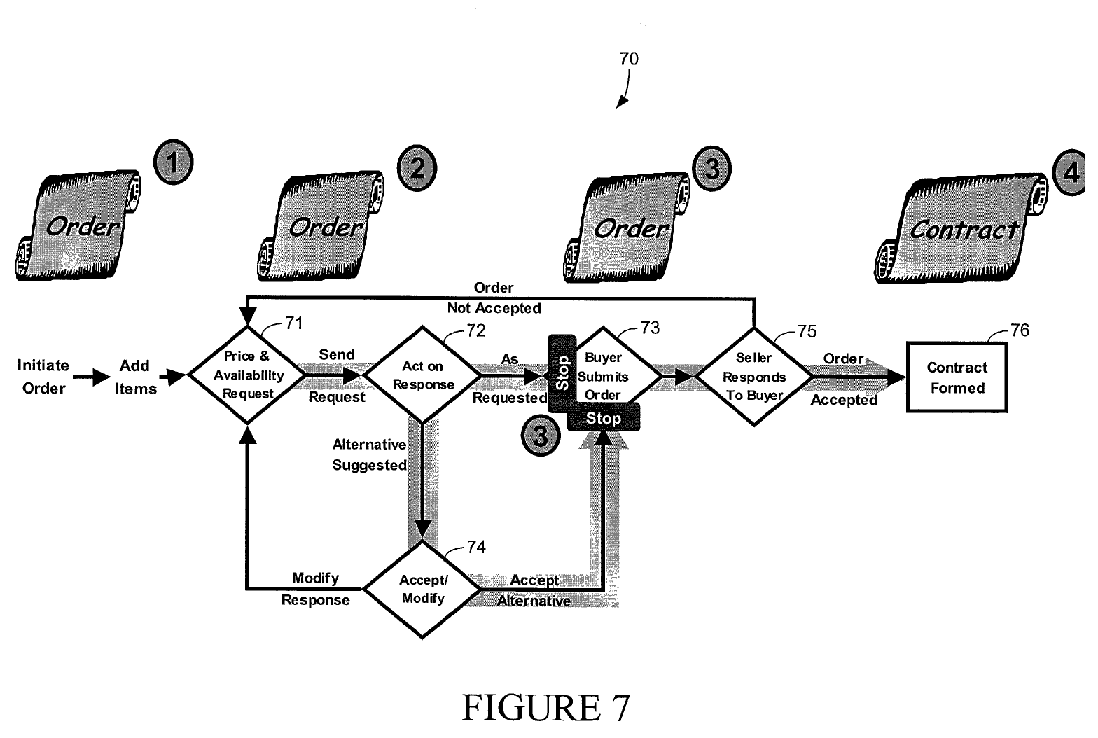

FIG. 6 provides an example of an ordering process 60 when Auto-Submit is selected with an accelerated order. At 61, the buyer initiates an order, adds items to that order, and then generates a price and availability request at 61. At 61, the buyer selects the Auto-Submit option, accepts the terms and conditions, and enters an authorization code. At 62, the supplier or suppliers then respond to the request. If some but not all of the suppliers have responded, the order may be split allowing items with suppliers who have accepted to be grouped in an order, as reflected in Order 4a. The remaining items which have not been responded to by suppliers, may proceed to a separate order if accepted by the suppliers or may be partially accepted or modified by the suppliers at 64. An ordering process 70 with Auto-Accept selected will now be described with reference to FIG. 7. The buyer initiates an order, adds items to the order and then generates a price and availability request at 71. When generating the request at 71, the buyer selects the Auto-Accept option. The supplier then acts on the response at 72. The supplier processes the order if requested if possible and, if not, processes the order with the best alternative up to a final decision point. The supplier may therefore modify the order at 74. The final decision point is at 73 at which point the buyer must execute the submit order request, accept the terms and conditions and enter an authorization code.

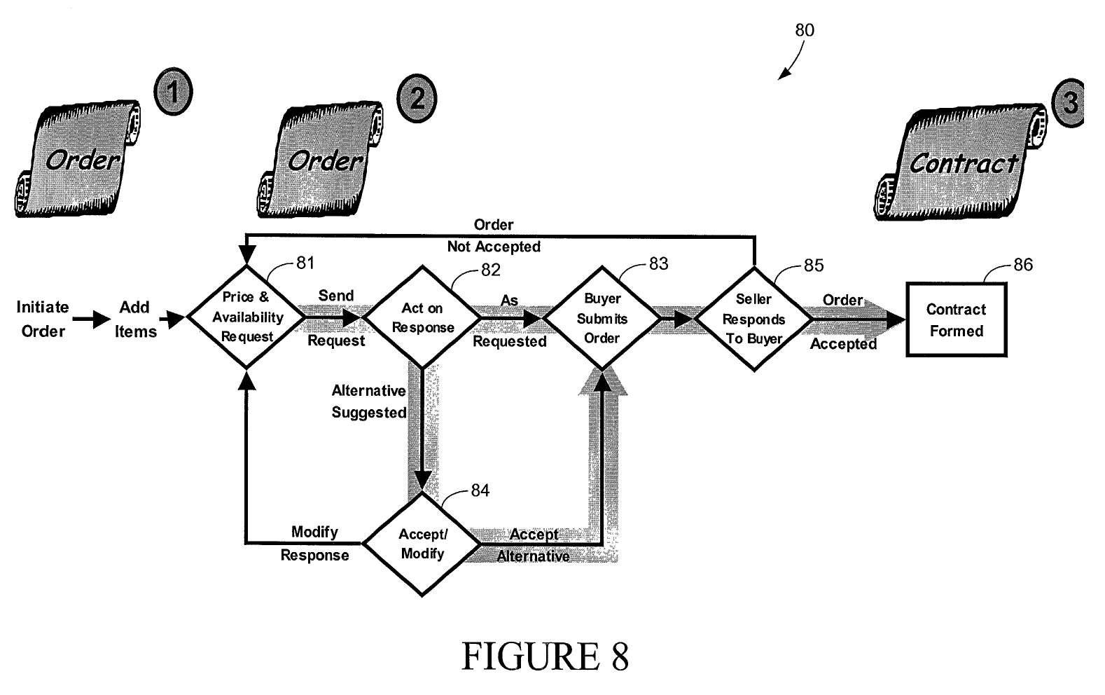

An ordering process 80 with full automation, specifically with Auto-Submit and Auto-Accept, will now be described with reference to FIG. 8. At 81, the buyer initiates an order and adds items to the order prior to generating a price and availability request at 81. When generating the request at 81, the buyer selects the Auto-Submit option, accepts terms and conditions, and enters an authorization code. The supplier then acts on the response at 82. The supplier processes the order to completion as requested if possible and, if not, processes the order with the best alternative. The process 80 is preferably implemented between buyers and suppliers having an existing trading partner agreement.

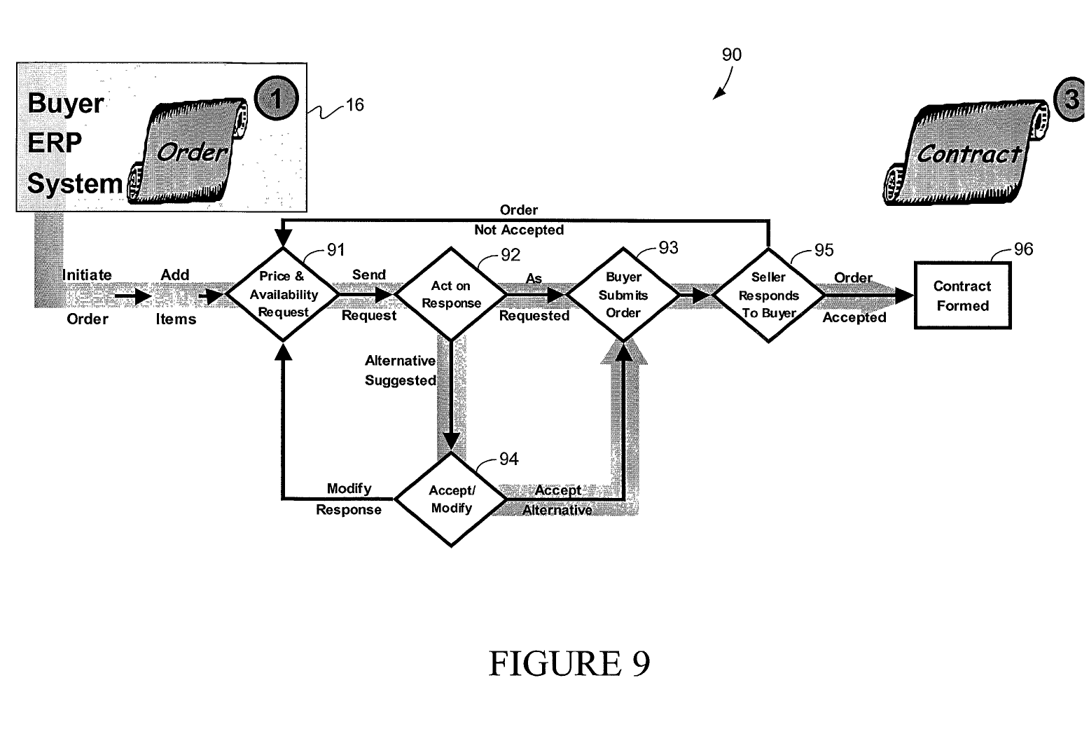

An order process 90 which involves full automation with simple buyer side integration will now be described with reference to FIG. 9. The process 90 begins with the buyers ERP system 16 initiating an order and submitting that order to the marketplace 10. This simple buyer side integration is also referred to throughout this document as UltraLite integration. Additional details of the UltraLite integration are set forth in the description below. The supplier acts on the response at 92 and can either proceed to submit an order at 93 or suggest an alternative and modify the request at 94. The marketplace 10 automatically processes the order received from the buyer. The buyer has the option of enabling the order to be processed to completion if it can be fulfilled as requested or if it can be fulfilled with the best alternative. As with the process 80, the process 90 is preferably implemented between buyers and suppliers having an existing trading partner agreement.

IV. Process Flows

An explanation will now be given of a series of process flows which describe in more detail the method 30 of operation for the marketplace 10. The process flows will be described between a buyer, a supplier, and the marketplace which in this example is operated by Omnexus. The references to Omnexus in these process flows is therefore a reference to the marketplace 10.

A. Requisition Check

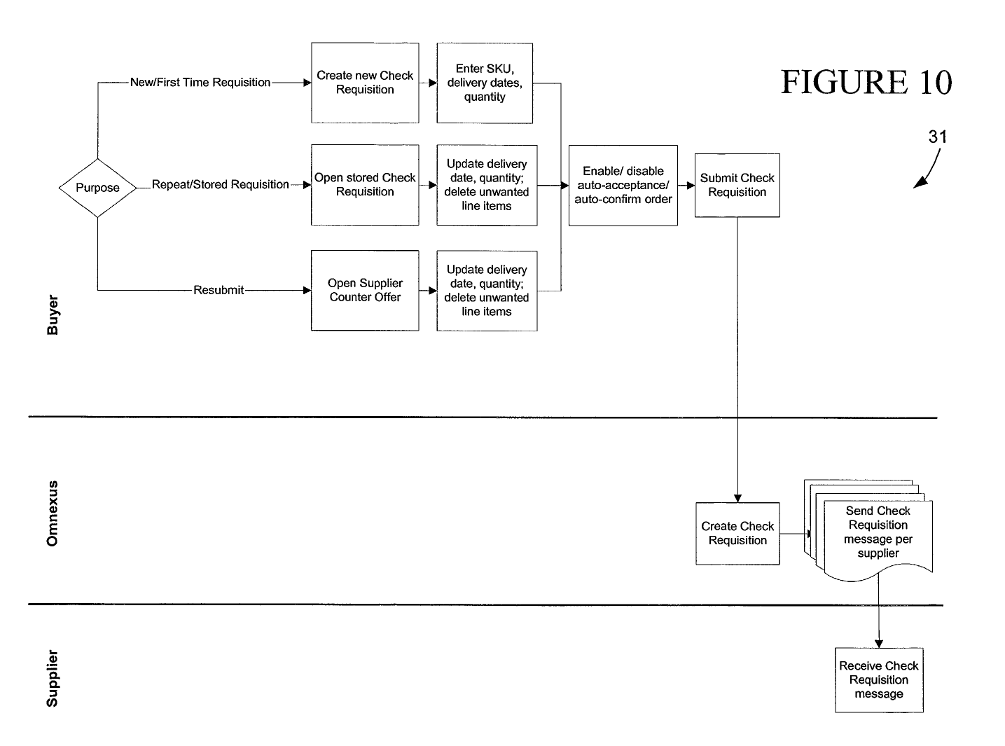

A requisition check process 31 will now be described in more detail with reference to FIG. 10. The requisition check process 31 initiates the ordering process within the marketplace 10. At this point, the buyer has identified the products to be ordered and has a delivery date in mind. The buyer creates a requisition by selecting the product(s) and delivery dates. The method of acceptance and confirmation is then chosen before the requisition check is sent to the supplier through the marketplace 10. As shown in this figure, the requisition check can be a new or first time requisition, can be a repeat or stored requisition, or can be a resubmission of a requisition check. The marketplace 10 receives the requisition check message from the buyer and evaluates the selected products and selected suppliers. The marketplace 10 routes all of the line items in the requisition check to the appropriate suppliers and a purchase order is created for each supplier.

In submitting the requisition check, the buyer can select the Auto-Accept or Auto-Submit options. If the Auto-Accept option is selected, any requisition check response from the supplier will be automatically accepted. The Auto-Accept option can be selected at a header level for all items or may be selected on a line-item level. At the line-item level, any requisition check responses from the supplier that fall within a given threshold, such as ten percent, of the requested quantity, will be automatically accepted. The Auto-Submit option, also referred to as the Auto-Confirm option, automatically triggers the create order process at 33 if a requisition response is accepted by the supplier. If a buyer chooses the Auto-Submit order option, the marketplace 10 requests a buyer purchase order and an approval code from the buyer. The

Auto-Accept and Auto-Submit options are preferably not passed on to the suppliers.

B. Requisition Check Response

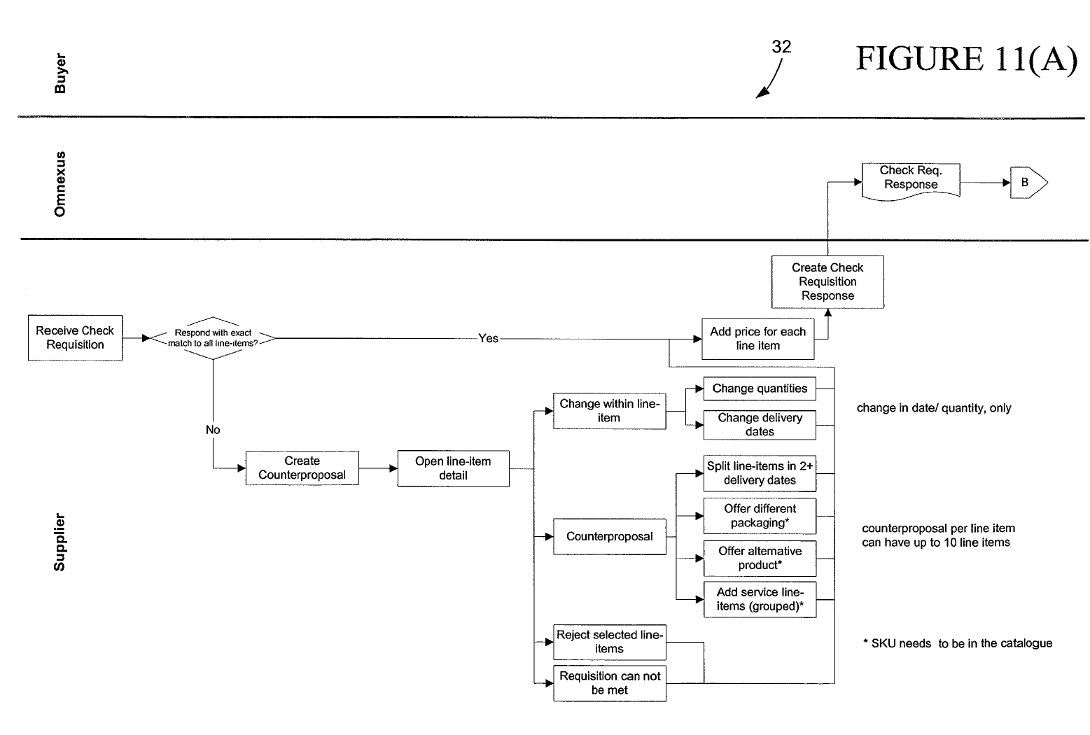

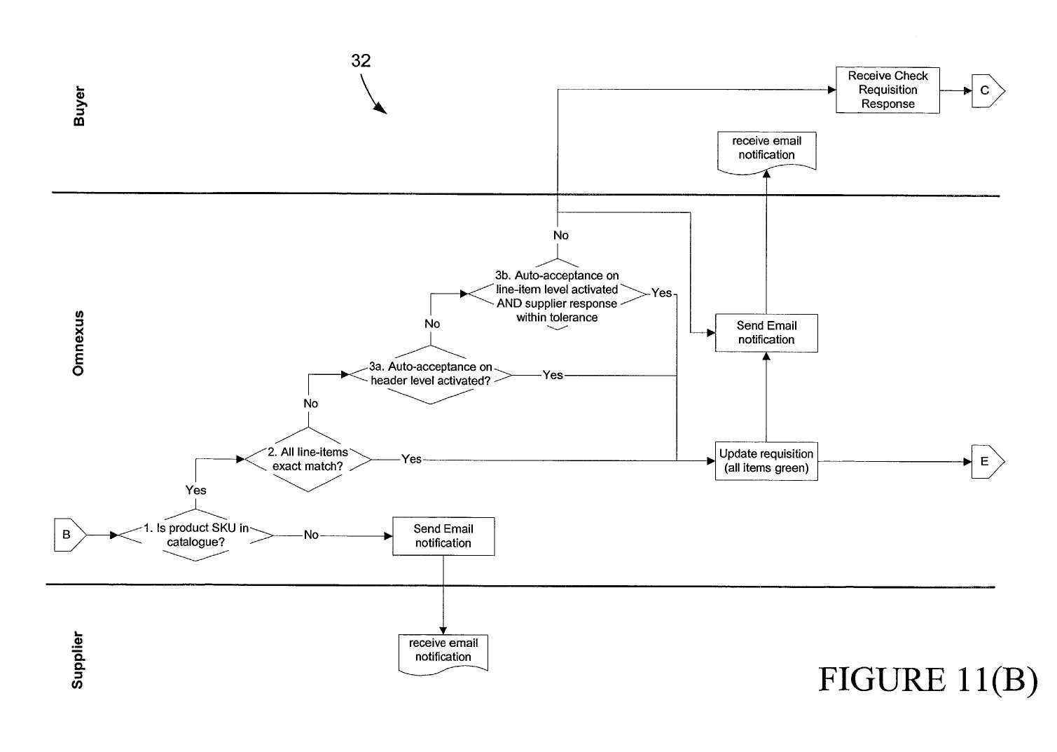

A requisition check response process 32 will now be described in more detail with reference to FIGS. 11(A) and 11(B). The requisition check response process 32 indicates only whether a supplier can fulfill a buyer's request. A positive response does not constitute a legally binding contract and only when a confirm order response at 34 is received is when a contract is legally binding. In a requisition check response at 32, the supplier can respond with an exact match to all line-items, changes within line-items, a counter-proposal, multiple counter-proposals, or a response proclaiming that a requisition cannot be met.

The marketplace 10 receives the supplies requisition check response message and assesses the status of the message, such as whether the requisition check is changed or unchanged. Based on the status of the message and settings for the specific buyer, the marketplace 10 performs additional tasks. These additional tasks performed by the marketplace 10 include validating line-items entered by supplier, creating e-mail notifications, checking auto-rules, and updating requisition panel. The marketplace 10 sends an e-mail notification to the buyer when a requisition check response is received from a supplier. The marketplace 10 also sends an e-mail notification to the buyer if a requisition check response message is Auto-Accepted on the header level. The marketplace 10 updates the status of each line-item in a requisition panel and preferably updates it through color coding. Line-items in green indicate the status of Proceed, the color indicates the status of Pending, and the color code of red indicates the status of Resubmit.

C. Confirm Order

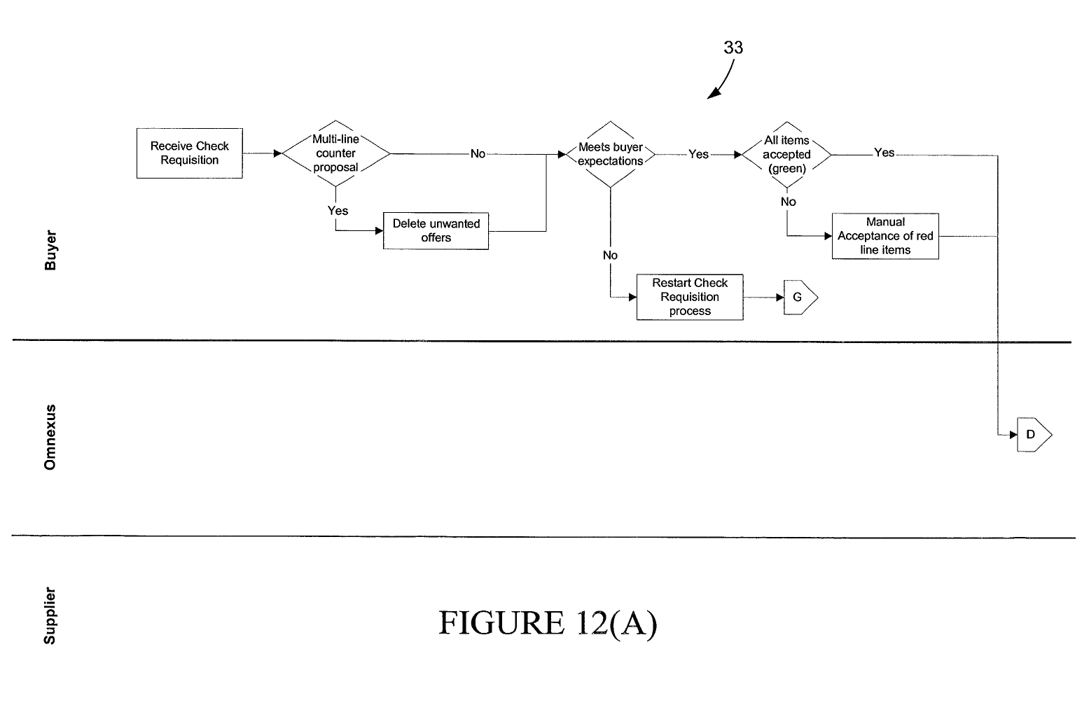

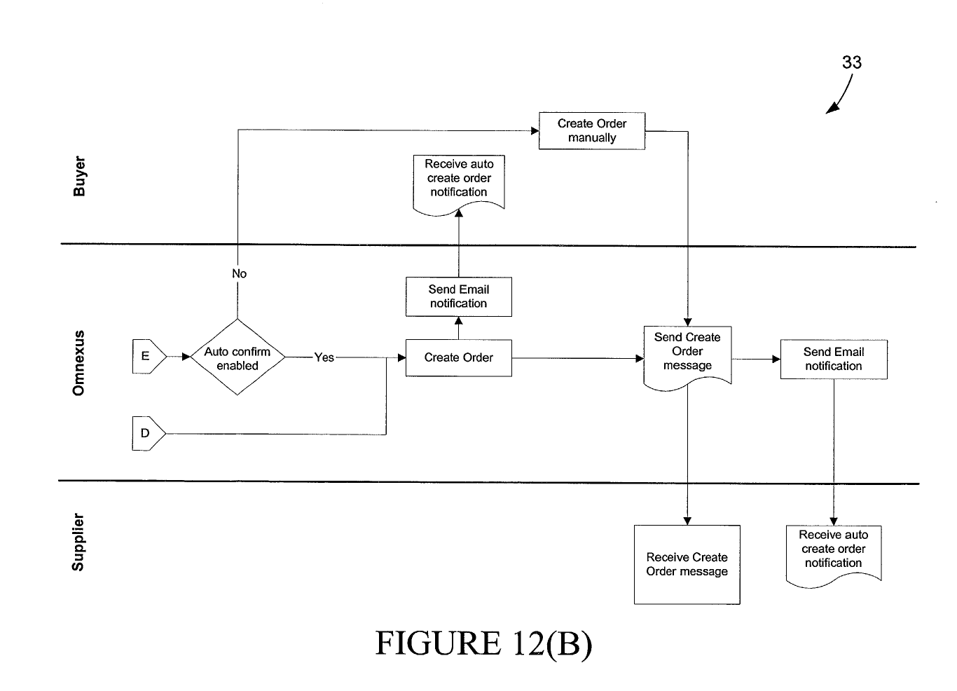

A confirm order process 33 will now be described in more detail with reference to FIGS. 12(A) and 12(B). The confirm order process 33 occurs when the buyer and supplier reach an agreement on the contents, delivery dates, and pricing of a requisition. The confirm order process 33 is initiated by the buyer and expresses the buyer's consent to the terms and conditions of the order. This process can be automated if the appropriate auto acceptance and auto submit options are chosen by the buyer and the supplier responds favorably to the requisition.

The buyer can create an order in generally two ways, either manually or automatically. For the manual creation, the buyer reviews the requisition check response from the supplier and can manually accept any unique counter proposal and confirm the order, delete unwanted counter-proposals and pick the desired proposal to confirm the order, or edit the requisition and re-start the requisition process by resubmitting a requisition check. In the automated case, the requisition bypasses the manual creation process if the supplier's response exactly matches the buyer's request, the Auto-Accept option is selected at the header level, or the Auto-Accept is enabled at the line level and the supplier response is within acceptable tolerances defined through the marketplace 10.

D. Confirm Order Response

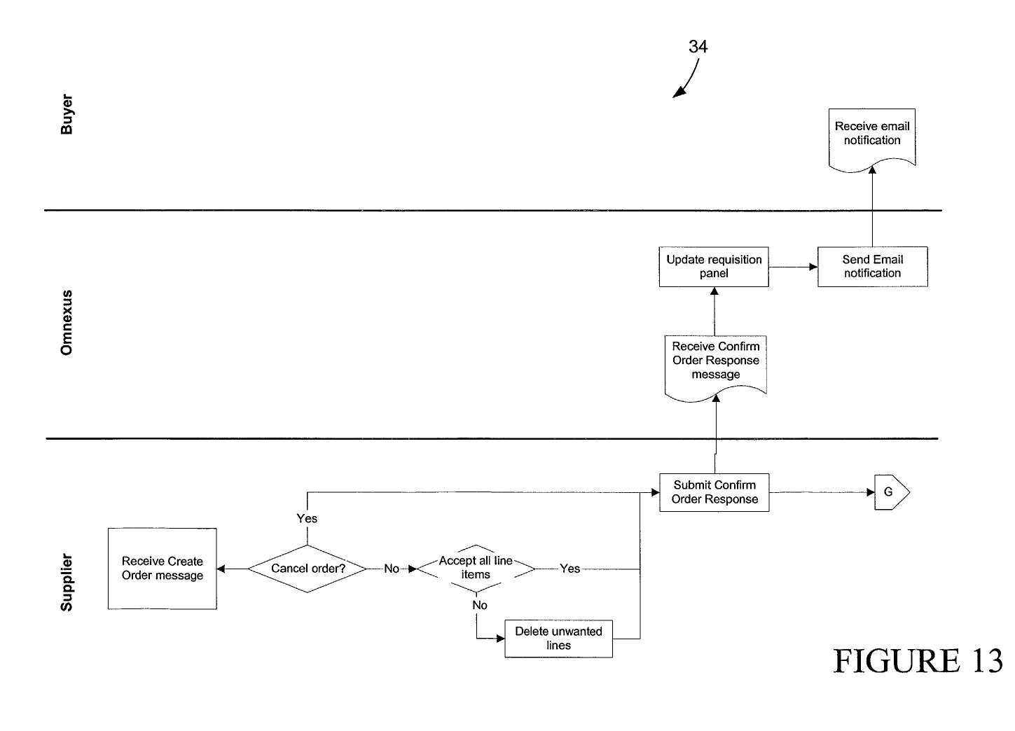

A confirm order response process 34 will now be described in more detail with reference to FIG. 13. Through the confirm order response process 34, a supplier provides final acceptance or cancellation of line items. A positive response constitutes a legally binding agreement. As shown in FIG. 13, the supplier can cancel an order, accept all line items, or delete some line items and accept the remaining items. The marketplace 10 receives the supplies confirm order response message and updates the status of each line item in the requisition panel. The marketplace 10 also sends an e-mail notification to the buyer.

E. Change Order

1. Initiated by Buyer

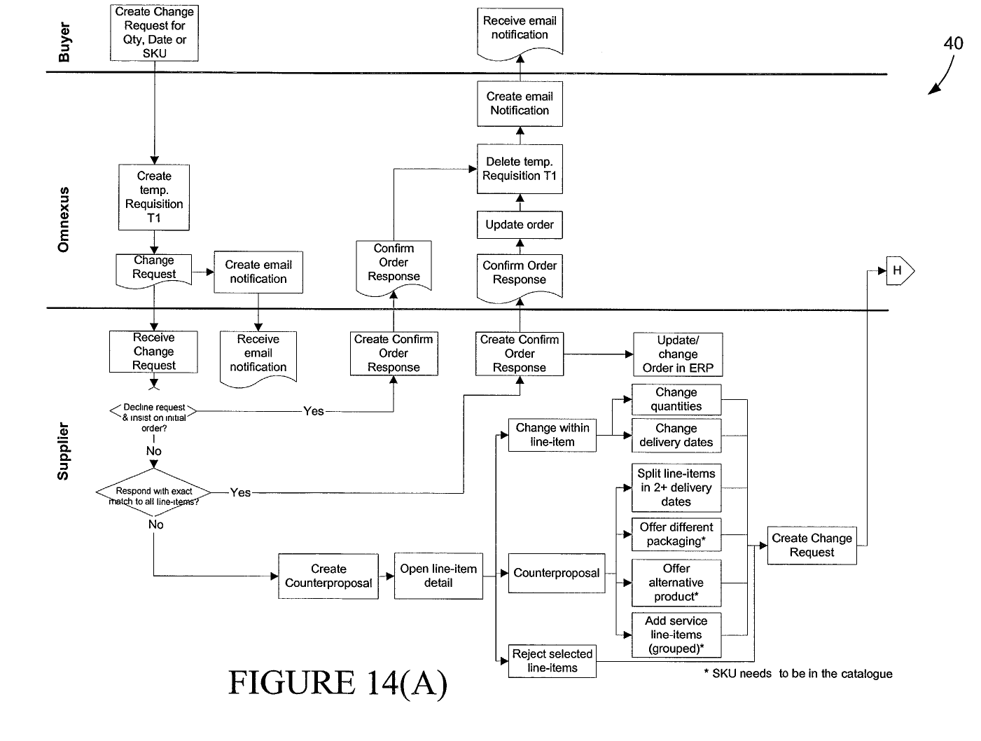

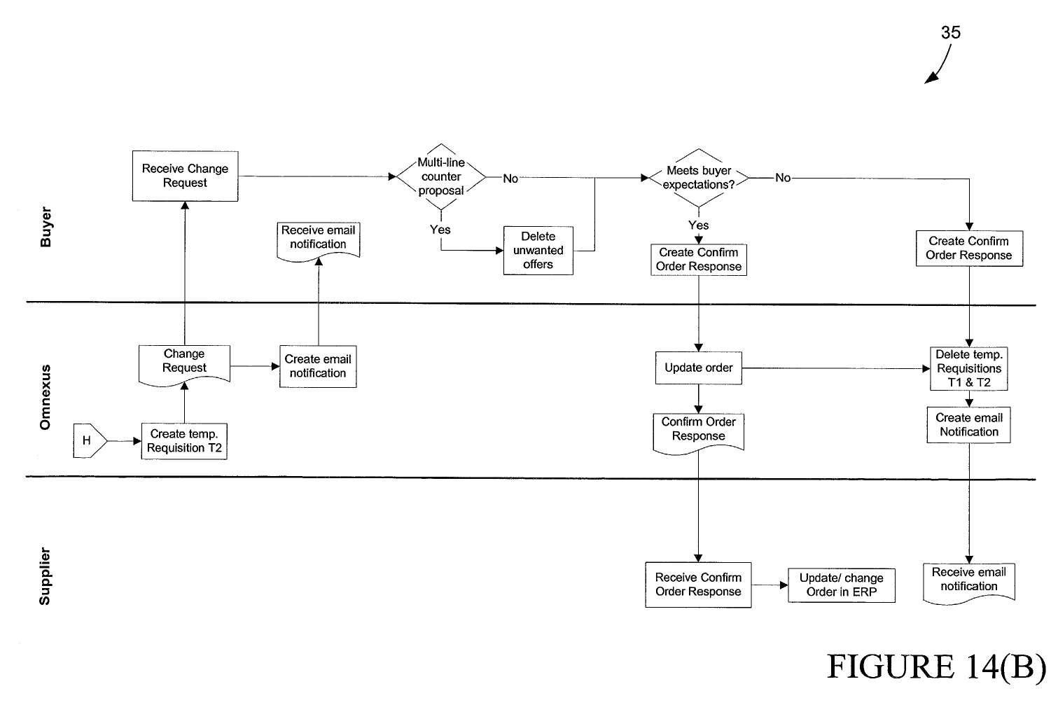

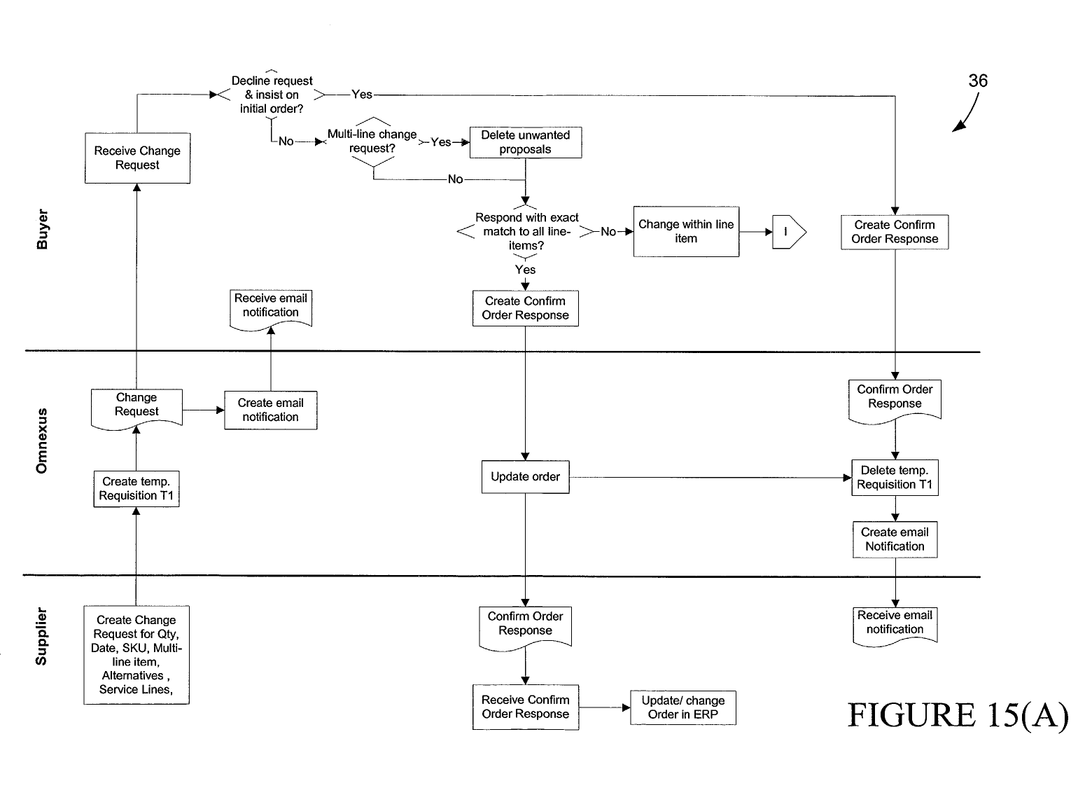

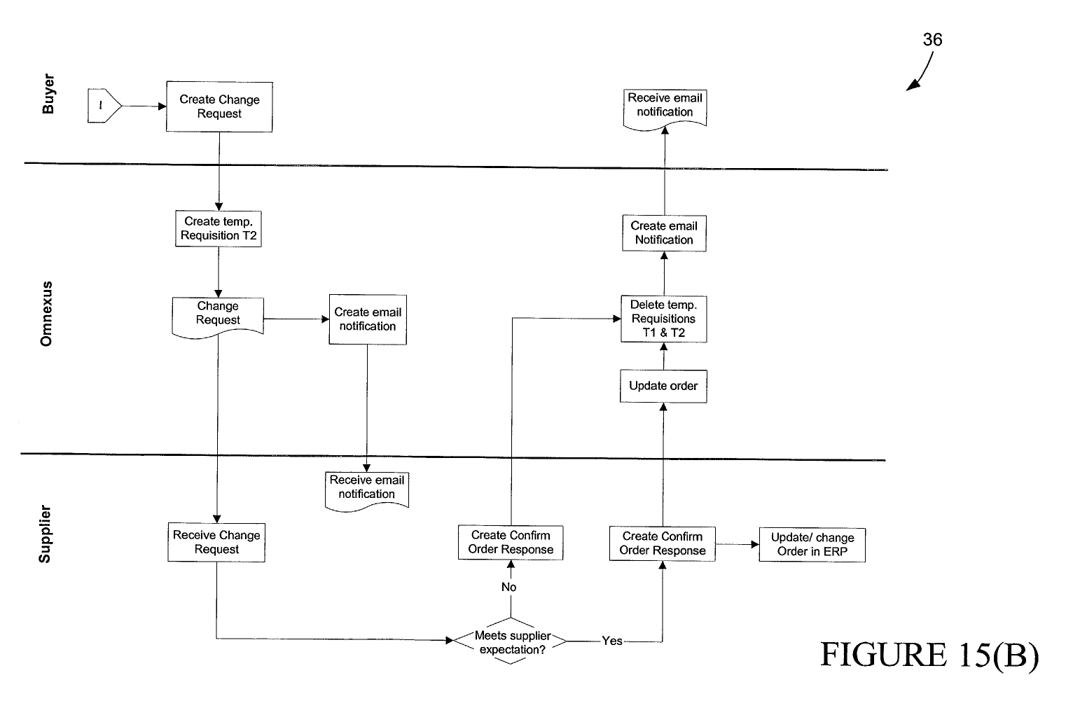

As shown in FIG. 4, the ordering process 30 accommodates a change order process 40. An example will now be given of the change order process 40 initiated by the buyer. FIGS. 14(A) and 14(B) illustrate in more detail the change order process 40 in this situation. Upon receiving a change order request, the marketplace 10 creates a temporary requisition T1 and sends a change request message and an e-mail notification to the respective supplier. The supplier can respond with a confirm order response in the case of declining the request or responding with an exact match to all line items or can respond with another change request in the case of a counter-proposal.

Based on the response from the supplier, the marketplace 10 executes different tasks. If the supplier declined the change request, the marketplace 10 receives the suppliers confirm order response message, deletes the temporary requisition T1, and sends an e-mail notification to the buyer. If the supplier accepts all line items with an exact match, the marketplace 10 receives the supplier's confirm order response message, updates the original order, deletes the temporary requisition T1, and sends an e-mail notification to the buyer. If the supplier responds with one or more counter-proposals, the marketplace 10 receives the suppliers change request, creates a new temporary requisition T2, and sends the change request and e-mail notification to the buyer.

The buyer has various alternatives to respond based on the decision made by the supplier. If the supplier declines the change request, the buyer can review the status of the original order which is still in effect. If the supplier accepts all line items with an exact match, the buyer can review the status of the updated order which is now legally binding. If the supplier responds with one or more counter-proposals, the buyer can review the suppliers counter proposals, decline them and generate a confirm order response message, or accept one of the counter proposals and generate a confirm order response message. If the buyer declines the counter proposal, the marketplace 10 deletes the temporary requisition T2 and sends an email notification to the supplier. If the buyer accepts one of the counter proposals, the marketplace 10 updates the original order, deletes the temporary requisition T2, sends an e-mail notification to the supplier, and sends a confirm order response message to the supplier.

2. Initiated by Supplier

An explanation will now be given of the change order process 40 initiated by the supplier. The supplier selects a purchase order, highlights the line-items that they wish to change, and click on a change request button. The marketplace 10 receives the change request, creates a temporary requisition T1, and sends a change request message and e-mail notification to the buyer. The buyer can create a confirm order response or an updated change request. If the buyer declines the change request, the marketplace 10 creates a confirm order response message having a decline status for the supplier, sends an e-mail notification to the supplier, and deletes the temporary requisition. If the buyer accepts all line items with an exact match, the marketplace 10 creates a confirm order response message, updates the original order, and deletes the temporary requisition. The marketplace 10 also sends an e-mail notification to the supplier. If the buyer responds with a counter proposal, the marketplace 10 refreshes the change request and sends an e-mail notification to the supplier.

In general, with either the buyer initiated or supplier initiated change order processes 40, once a change request is initiated the receiving party can choose to accept, to decline, or to send a counter proposal. Each party is limited to just one opportunity to send a counter proposal. If a counter proposal is made, the initiating party can only accept or decline it. If further negotiations are required, the parties will need to create a new change request and restart the change order process 40.

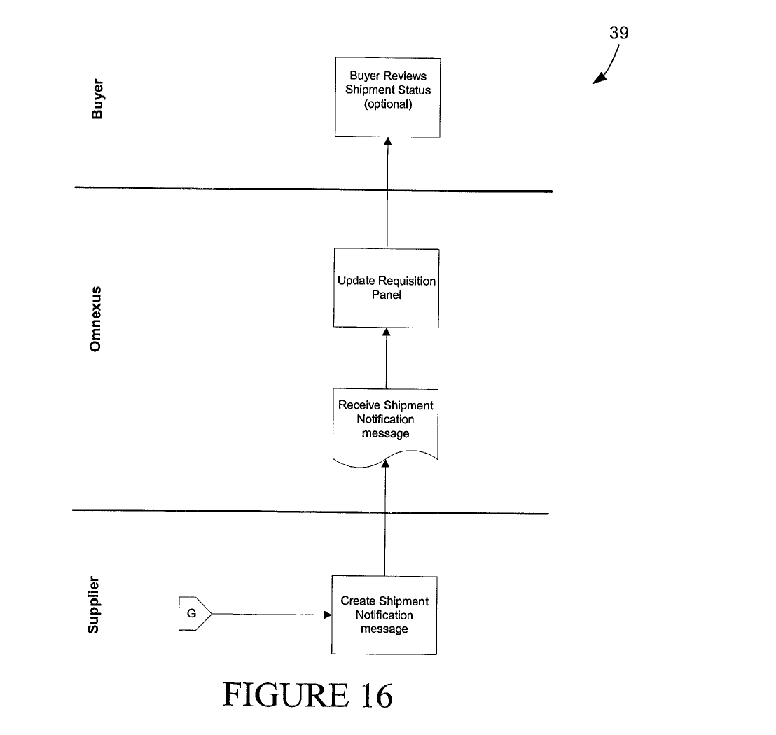

F. Shipment Notification A shipment notification process 39 will now be described with reference to FIG. 16. The shipment notification process 39, also termed Order Status, is the final step in the order process 30. Through the shipment notification process 39, the supplier notifies the buyer that a shipment or portions of an order have been sent to the buyer. The marketplace 10 receives the suppliers shipment notification and updates the requisition panel with the status of each line-item. The marketplace 10 updates the items as being “Shipped” when the supplier has shipped the item, updates the item with the status of “Cancelled” when the supplier has cancelled the line-item, and updates the status with “Partial” when the supplier has partially shipped the line-item. The buyer then has the option of revealing the shipment status through the marketplace 10.

G. Customer Inquiry

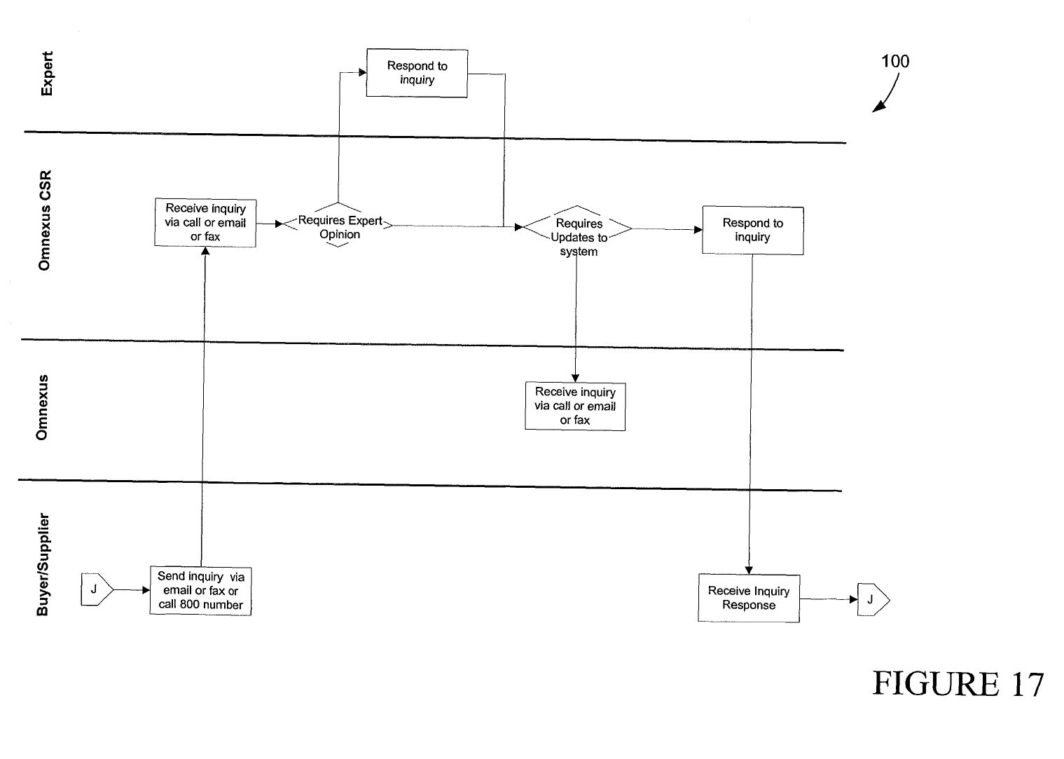

A customer inquiry process 100 is illustrated in FIG. 17. A customer, either the buyer or supplier, can generate a customer inquiry at any point during the ordering process 30. The inquiry can be received in various ways, such as but not limited to a phone call, fax, or e-mail. A customer service representative (CSR) can forward the inquiry to an expert if needed and preferably responds to the inquiry through a phone call, e-mail, or fax, depending on customers preference.

H. Examples

The order process 30 accommodates the ordering preferences of both the buyers and suppliers. In general, the ordering process can range from a repeat order process to a negotiation centric order process. A repeat order process describes the common order process where the buyer and supplier have a long standing business relationship. Products are purchased repeatedly and both parties try to lower transaction costs. The marketplace 10 provides the mechanism to keep the transaction cost low, such as through the Auto-Accept and Auto-Submit options which help to automatically create orders. If a buyer enables both of these options and a supplier is back-end integrated to the marketplace 10, the transaction costs can be minimized. The negotiation centric order process focuses on the negotiation side of purchasing. A buyer either wants to get new or updated quotes from its supplier, purchase a new product, or establish a business relationship with a new supplier. The marketplace 10 provides mechanisms for this kind of transactions. The initial negotiation between the parties can occur on the requisition check level which allows buyers to get quotes from multiple suppliers. Additional negotiations can then occur on the order change level where both the buyer and supplier have the chance to request change orders. If the counter party cannot respond to such a proposal exactly, negotiation can be expanded.

Two examples will now be given of the entire ordering process 30, with one example being of the repeat order process and the other a negotiation centric order process.

1. Repeat Order

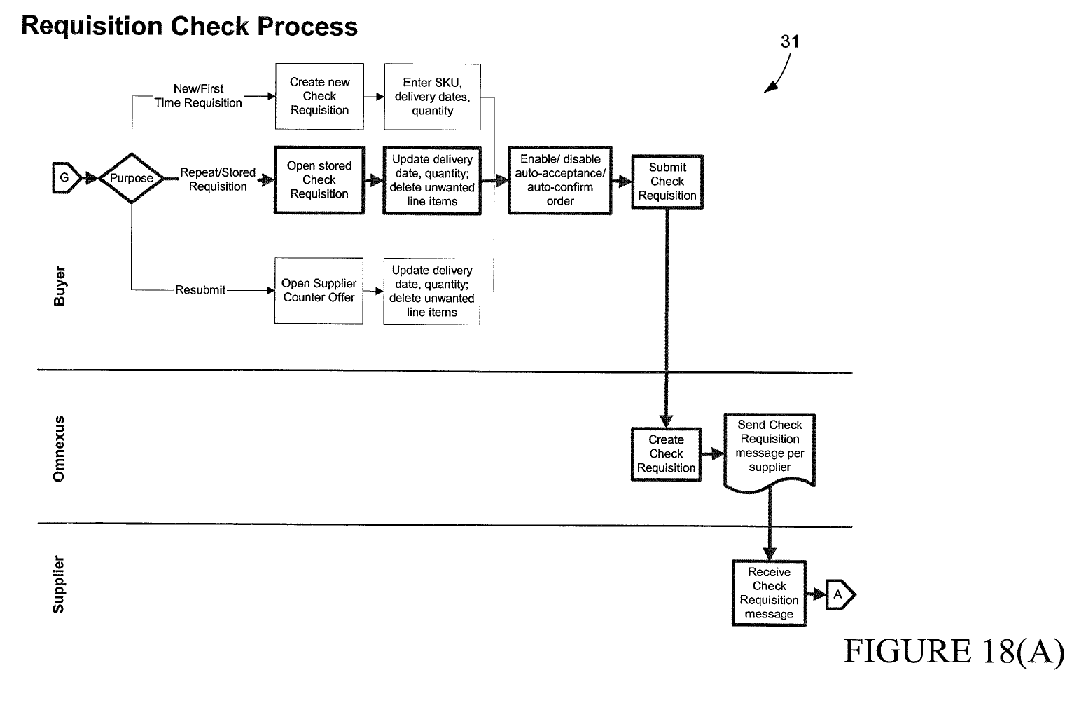

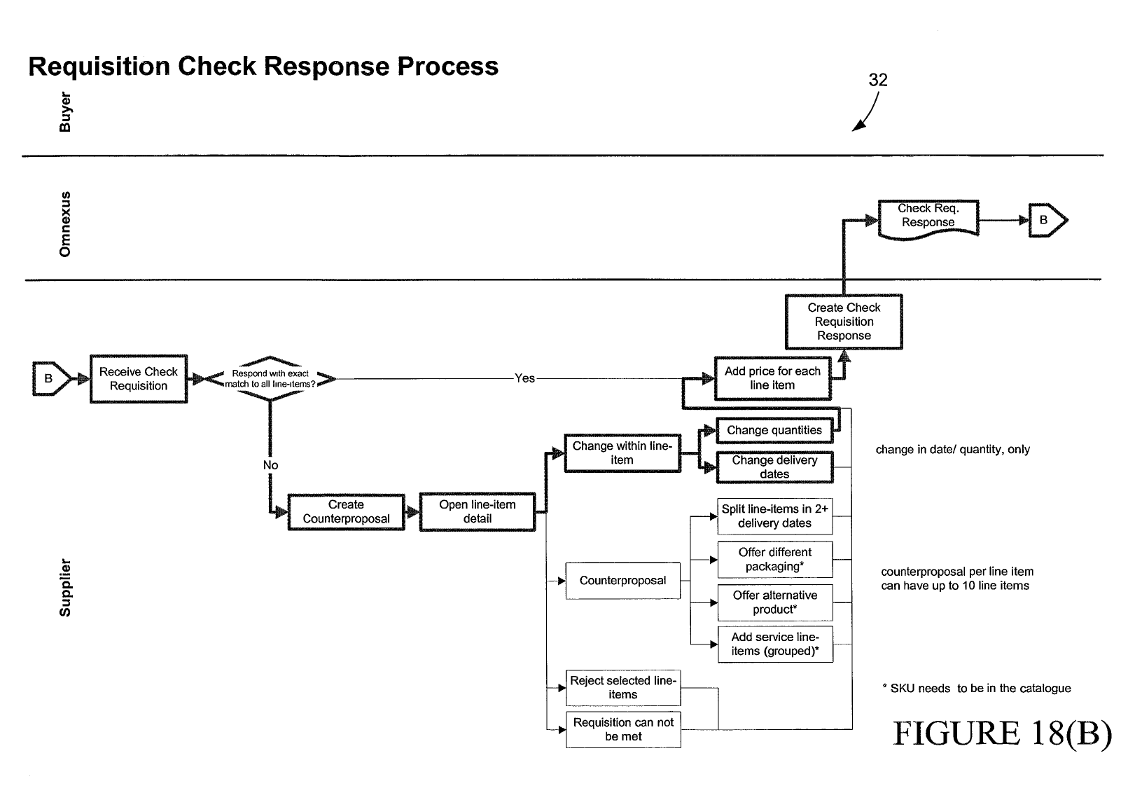

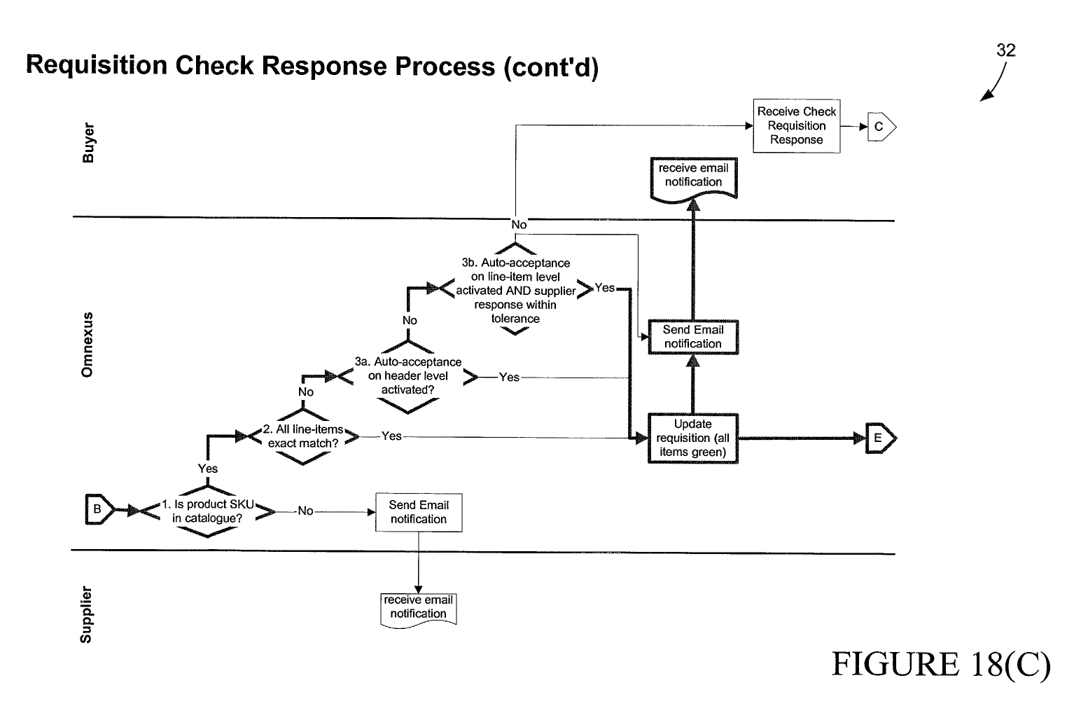

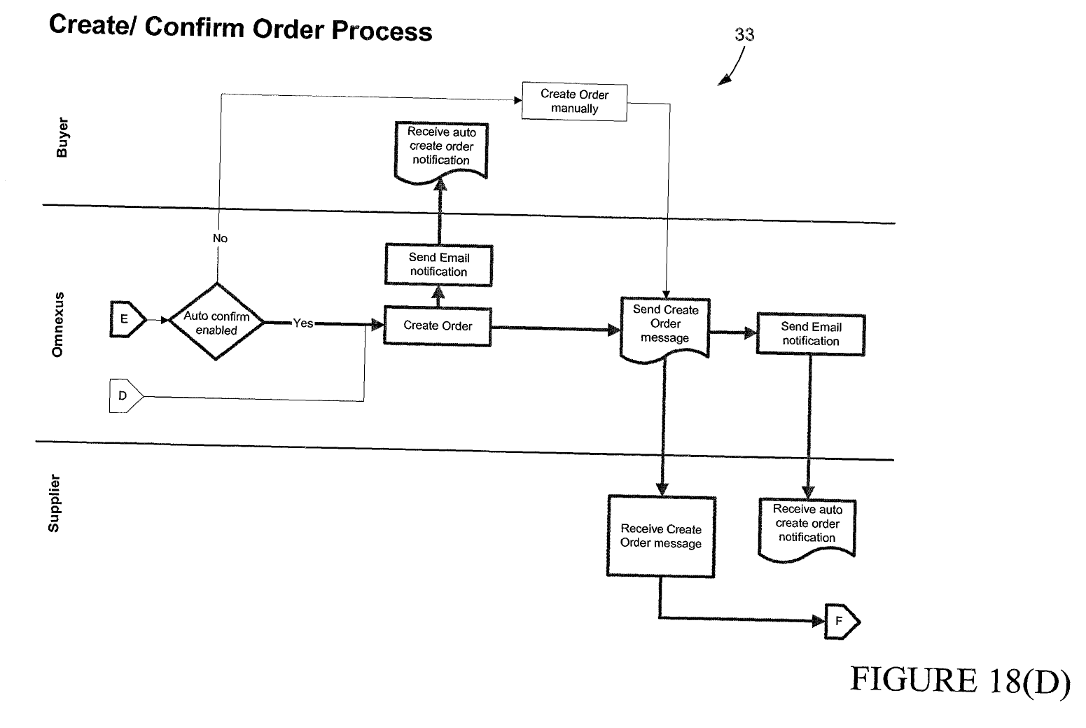

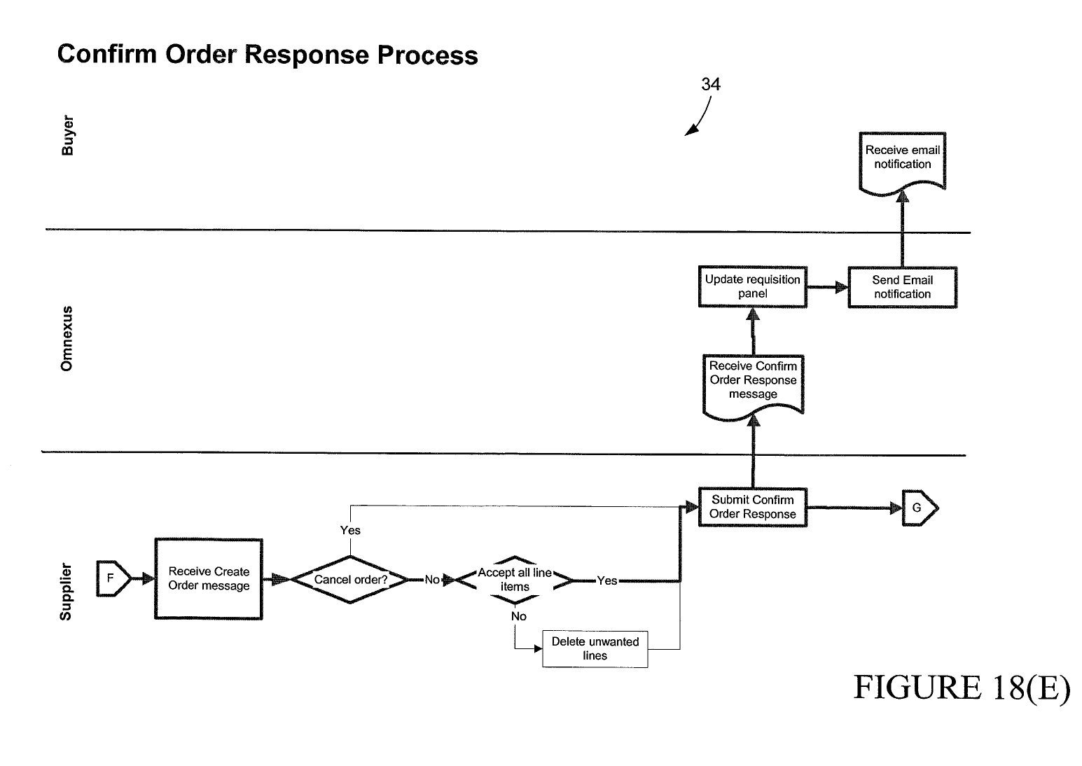

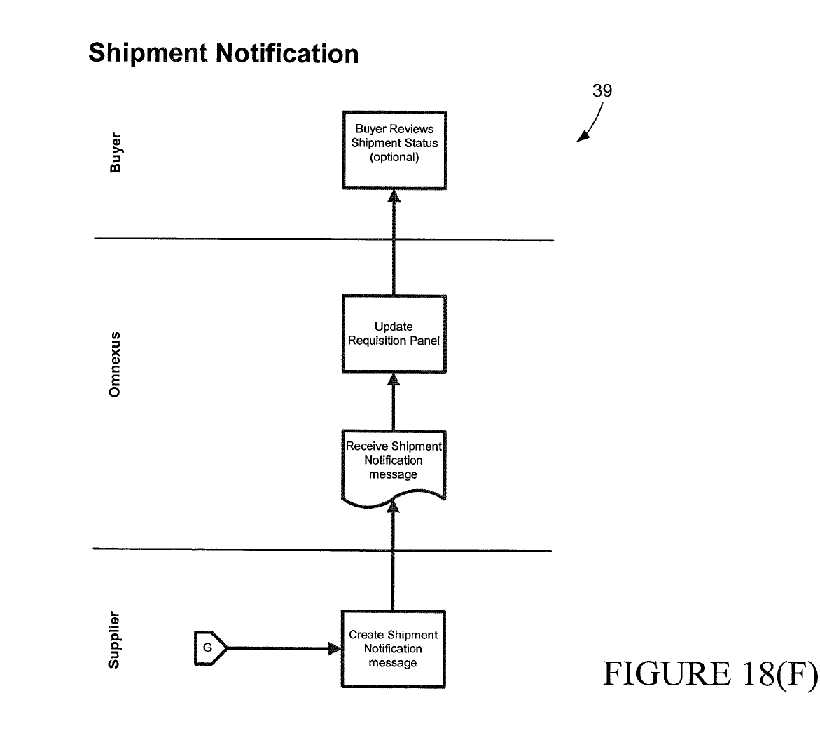

FIGS. 18(A) to 18(F) illustrate a repeat order process 30 between a buyer Injection Blow Molding, Inc. of America which is about to renew their inventory of two resins named Omnexun 2040 and 100 Natural Plustran 2080 100 Natural from the supplier Plastics and Resins Corp. These parties have a strong on-going relationship and both are registered with the marketplace 10. In this example, the products are needed by March, 2001 and today's date is Jan. 15, 2001. FIG. 18(A) illustrates the repeat order process in which the buyer, Injection Blow Molding, Inc., enters the marketplace 10, selects a stored requisition used for last month's order, and updates the quantity needed of both resins. The buyer chooses the Auto-Accept option at the line-item level and also selects the Auto-Submit option. The marketplace 10 receives the requisition check message from the buyer and routes the requisition check message to the supplier, Plastics and Resins Corp.

As shown in FIG. 18(B), the requisition check response process 32 begins with the supplier receiving the requisition check. The supplier determines that it can fulfill the request for the Omnexum resin but can only fulfill part of the buyer's request for the Plustran resin. The supplier then indicates the changed quantity and forwards the requisition check response to the marketplace 10.

As shown in FIG. 18(C), the marketplace 10 receives the requisition check response message and assesses the status of the message. Since the Auto-Accept rules were selected by the buyer at the line-item level, the marketplace 10 sets the status of the Omnexum resin line-item to green, indicating the status of proceed. The marketplace 10 also sets the status of the Plustran resin to green since in this example the quantity in the check requisition response fell within a threshold percentage of the requested quantity. The marketplace 10 then updates the requisition panel, creates an e-mail notification for the buyer, and sends the requisition check response message to the supplier.

FIG. 18(D) illustrates the create/confirm order process 33. Since the Auto-Accept option is enabled and all items on the requisition have a status of proceed, the marketplace 10 creates a confirm order message for the supplier and sends an e-mail notification to the buyer indicating that the order has been confirmed automatically. The buyer receives the e-mail notification about the response to the requisition check as well as notification that the order has been confirmed.

The confirm order response process 34 is shown in FIG. 18(E). The supplier receives the confirm order response message from the marketplace 10 and sends a confirm order response message to the marketplace 10. The marketplace 10 receives this response message and updates the status of the requisition to “supplier accepted.” The buyer receives e-mail notification from the marketplace 10 and can review the status of the order on-line.

The shipment notification process 39 is shown in FIG. 18(F). When the supplier sends the requested products, the supplier creates a shipment notification message which is sent to the marketplace 10. The marketplace 10 receives the shipment notification message and updates the status of the requisition to “shipped.” The buyer then has the option to review the shipment status through the marketplace 10.

2. Negotiation Centric Order

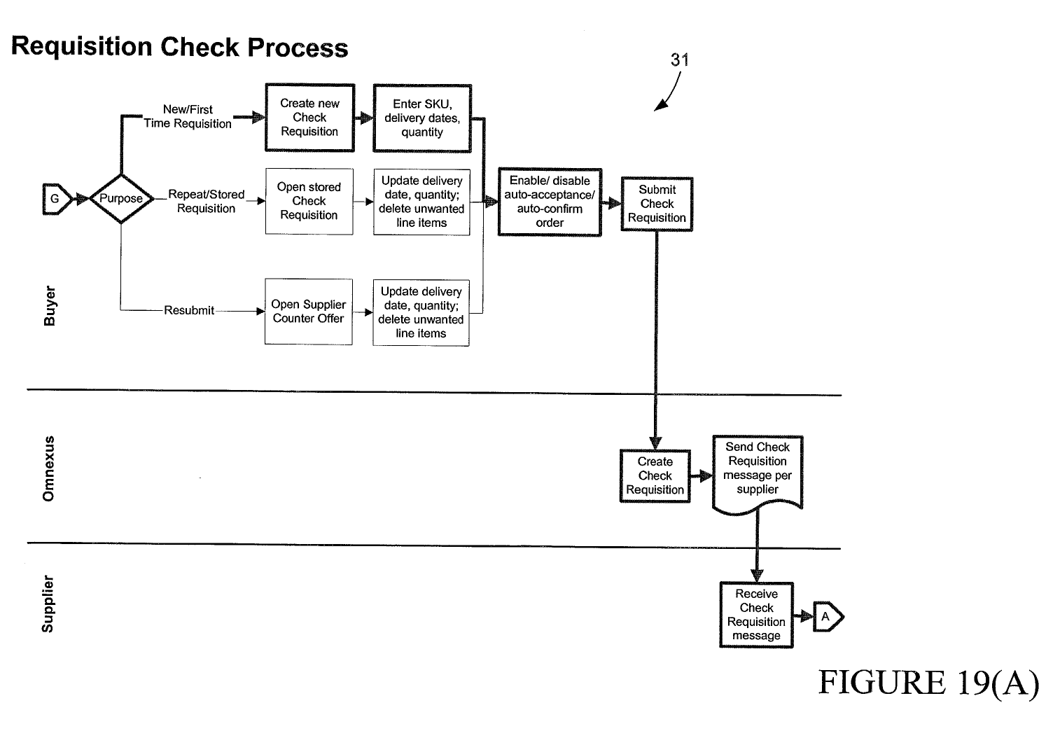

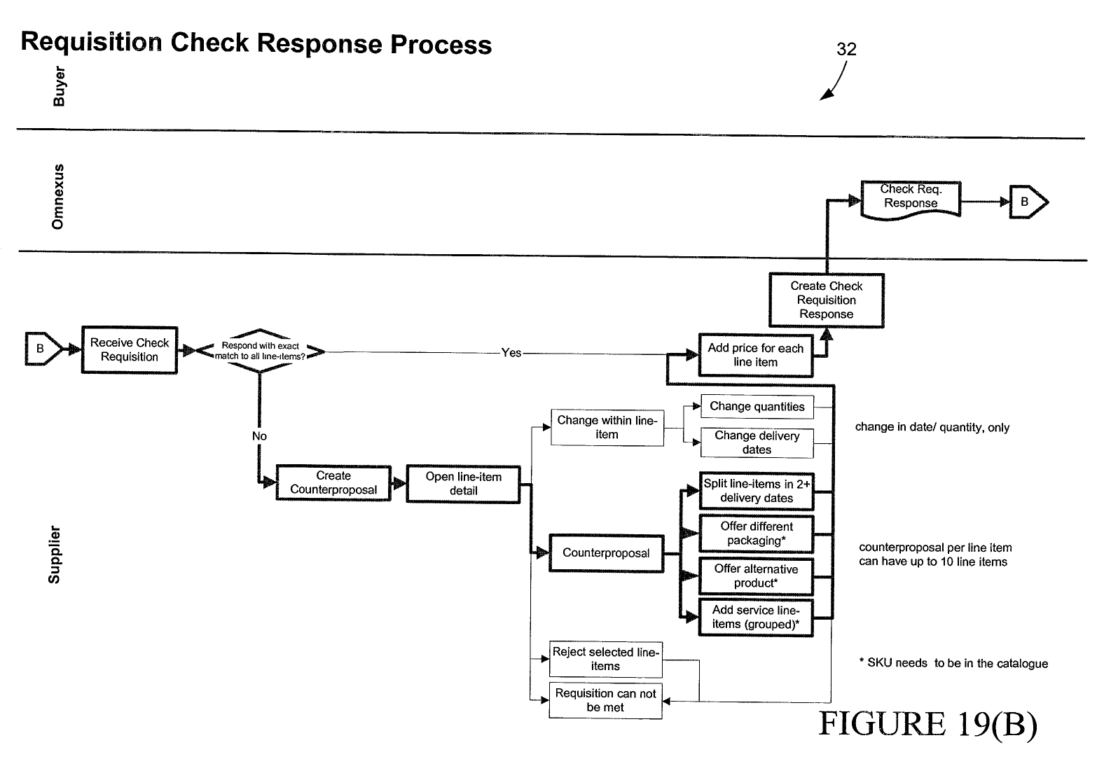

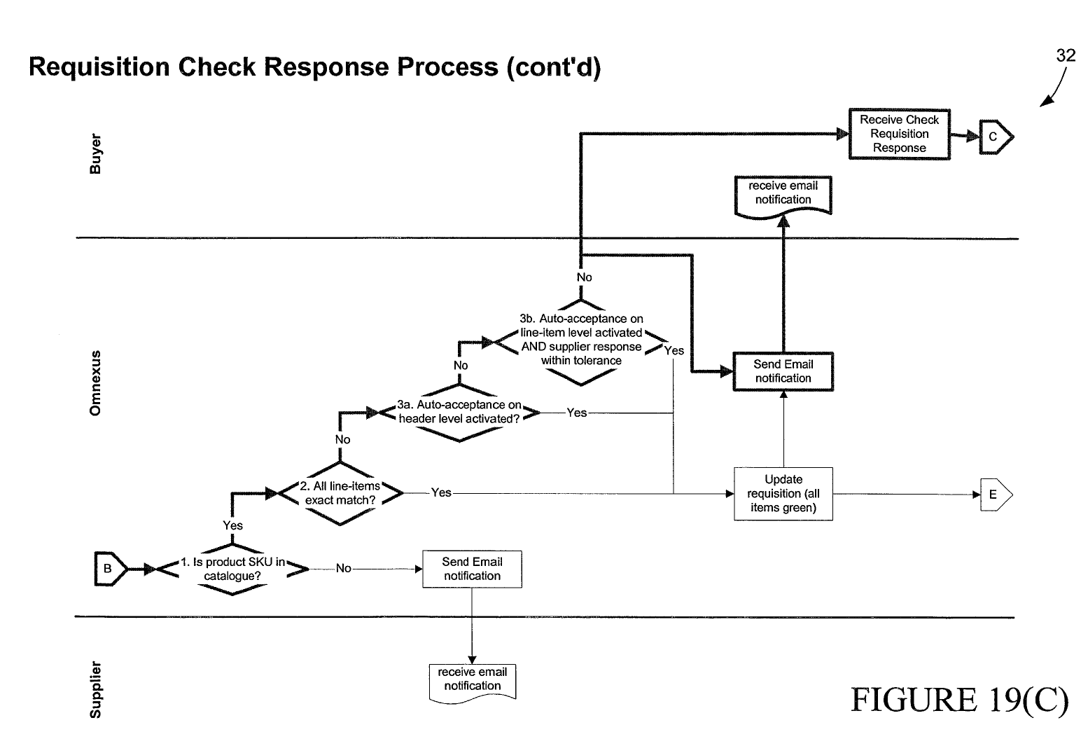

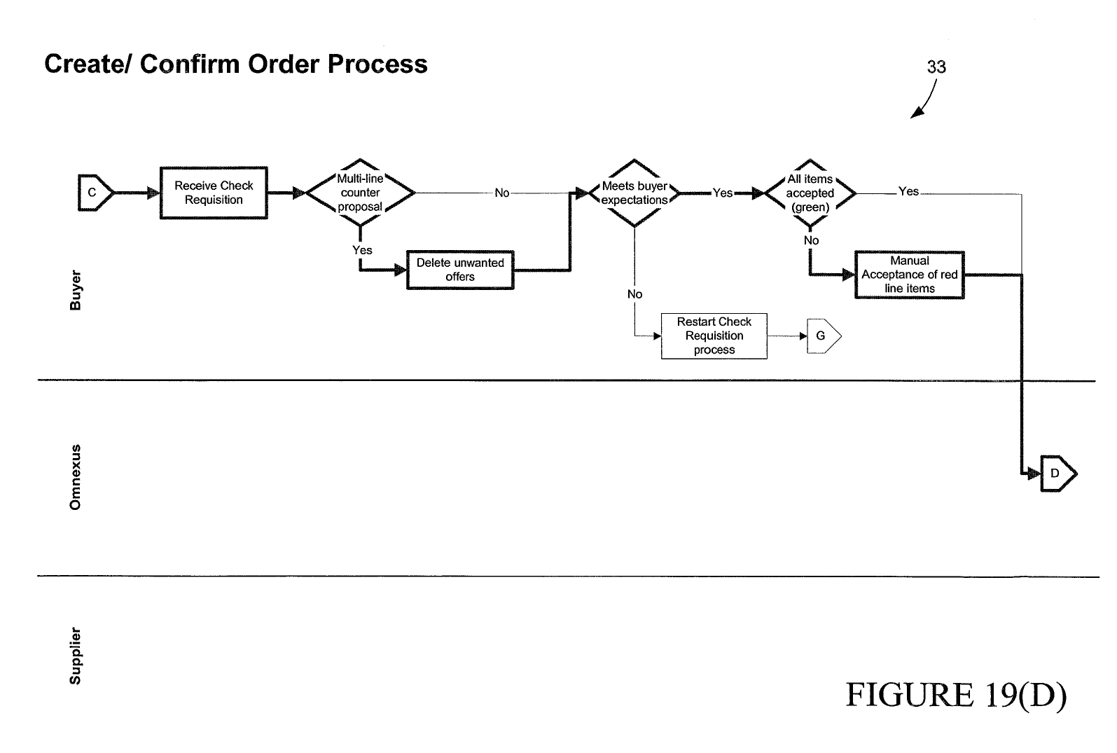

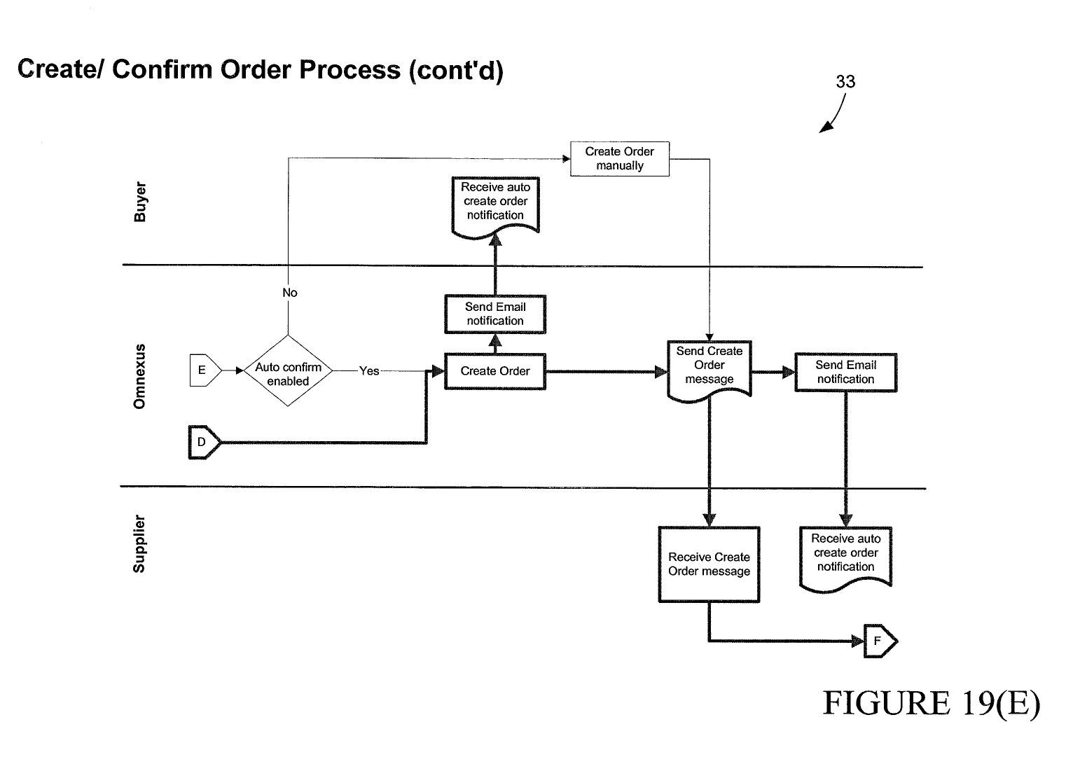

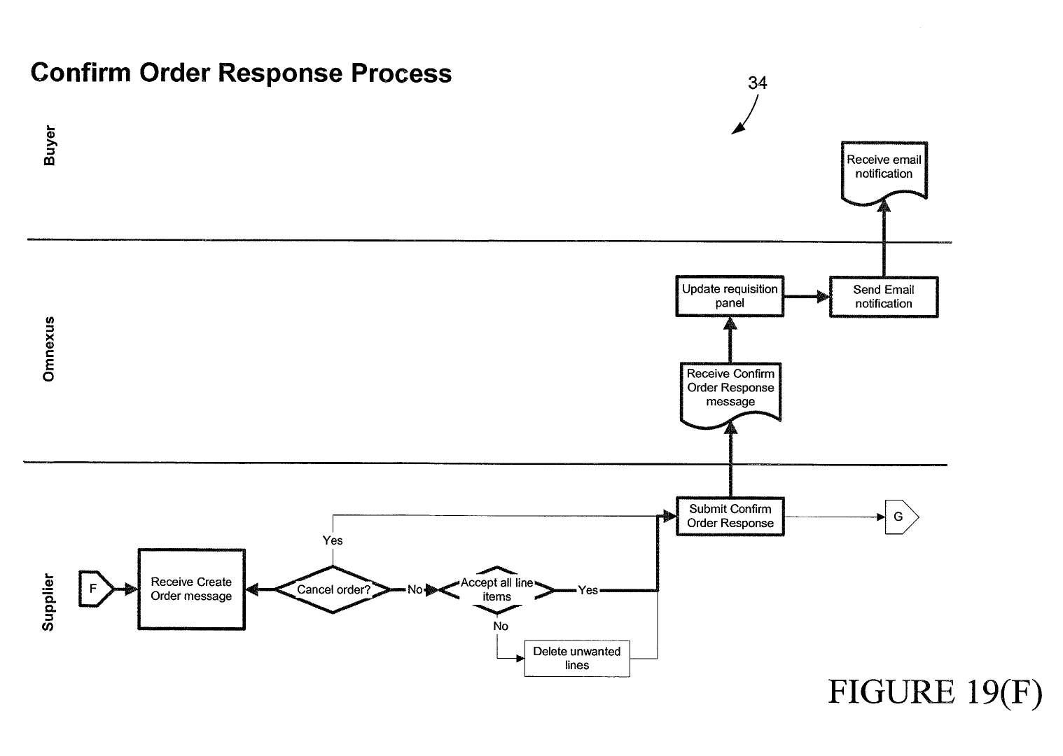

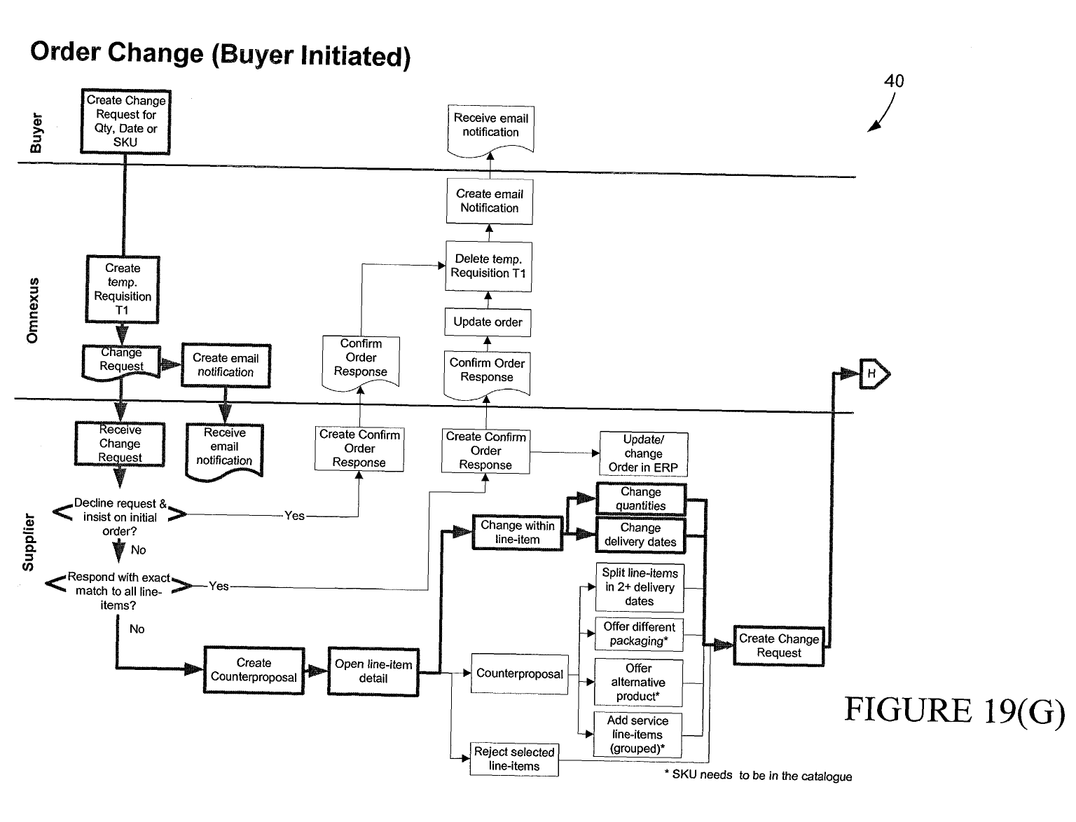

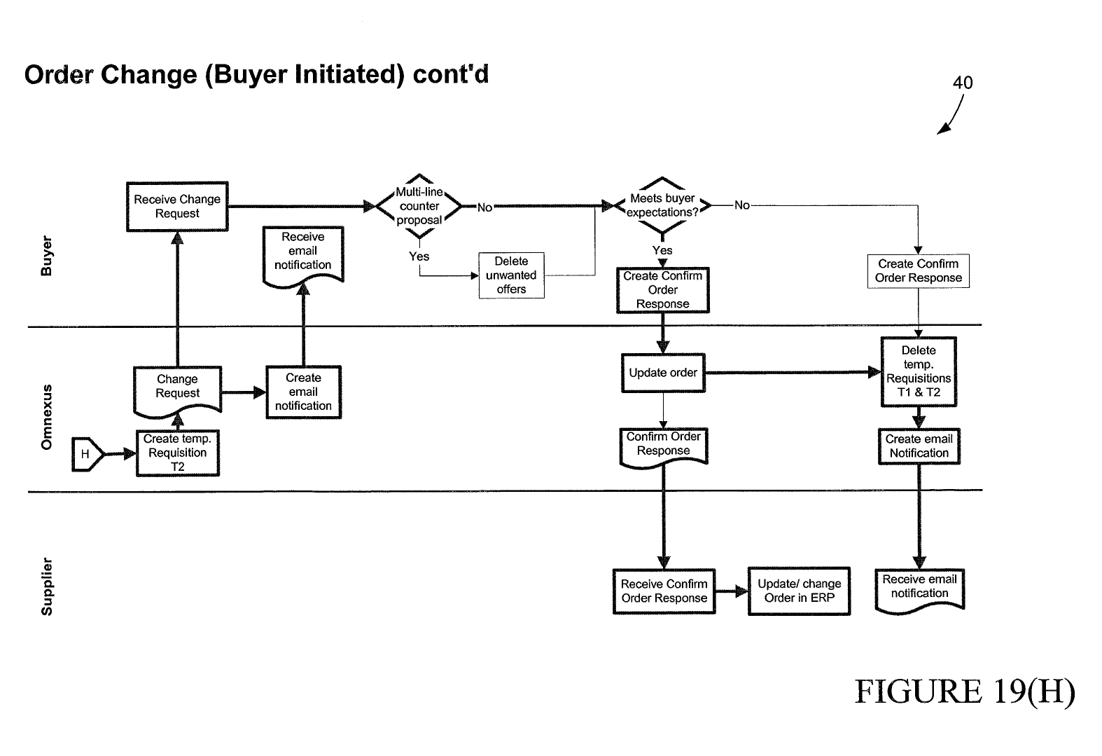

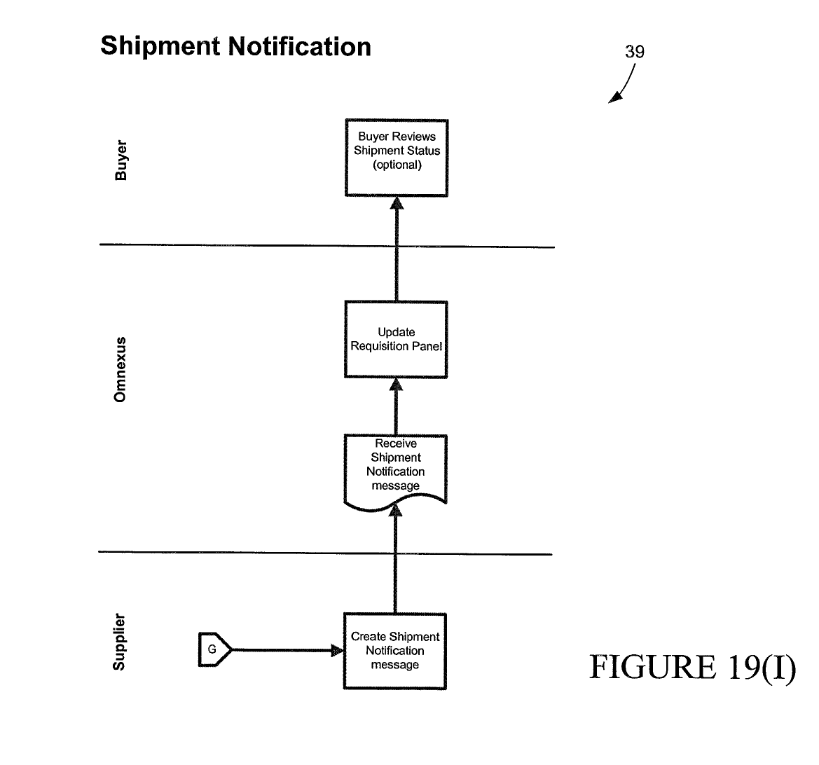

A negotiation centric order process 30 will now be described with reference to FIGS. 19(A) to 19(I). In this example, the buyer, Injection Blow Molding, Inc. of America is about to introduce a new product and needs to purchase new or additional raw materials. The buyer performed initial product research through the marketplace 10 and found a supplier, Plastics and Resins Corp., that can provide the acquired product. Plastics and Resins Corp. provides the needed product which is called Blendax 2153 100 Natural. The production of the new product at Injection Blow Molding, Inc. of America is scheduled to start in February, 2001 and today's date is Jan. 15, 2001. Both the buyer and supplier are registered with the marketplace 10 and are thus able to do business with each other through the marketplace 10.

The requisition check process 31 is shown in FIG. 19(A). The buyer, Injection Blow Molding, Inc. enters the marketplace 10, from the product catalog sees the desired product, selects a quantity of three thousand pounds, and a delivery date of Jan. 31, 2001. The buyer disables both the Auto-Accept option and the Auto-Submit option. The marketplace 10 receives the requisition check message from the buyer, evaluates the selected product and supplier, and then forwards the requisition check to Plastics and Resins Corp.

The requisition check response process 32 is shown in FIG. 19(B). The supplier, Plastics and Resins Corp., determines that the company is not able to meet the request and generates four counter proposals. The first is a change in date, the second involves adding an expediting up-charge of $700.00 for express delivery and an additional product price, the third counter proposal is the suggestion of an alternative product, and the fourth is a partial delivery on the requested date and a second delivery later in time. The marketplace 10 receives the suppliers requisition check response message and assesses the status of the message. The marketplace 10 determines that the response contains another product as requested initially and validates that it is listed in the product catalog. The marketplace 10 determines that all the Auto-Rules were disabled, updates the requisition panel, and creates an e-mail notification to the buyer indicating that the requisition check response message has been received.

The confirm order process 33 is shown in FIG. 19(D). Since the response to the requisition check has multiple counter proposals, the buyer has to decide which one to accept, if any. The buyer rules out counter proposal one since it needs to have some product at the scheduled start date. The buyer also rules out counter proposal three since it is very quality conscious and does not want to substitute the requested product. In comparing the remaining counter proposals, the buyer selects counter proposal four which has a lower price and offers the best option. The buyer then deletes counter proposals one, two, and three from the requisition and manually accepts the remaining counter proposal four. As shown in FIG. 19(E), the marketplace 10 updates the requisition and sends a confirm order message for the supplier. The marketplace 10 also sends an e-mail notification to the supplier.

The confirm order response 34 is shown in FIG. 19(F). The supplier receives the confirm order message from the buyer and decides to accept all line items. The supplier generates a confirm order response which is sent to the marketplace 10 and also updates its own ERP system 16. The marketplace 10 receives the confirm order response message and updates the status of each line item in the requisition panel accordingly.

After time, the buyer has discovered that the production can be started sooner and that the first shipment will be insufficient for production. The buyer then initiates the change order process 40 which will be described with reference to FIGS. 19(G) and 19(H). The buyer issues the change request based on quantity and delivery date and sends the change request to the marketplace 10. The marketplace 10 creates a temporary requisition T1 that stores the change request and sends a change request message and e-mail notification to the supplier, Plastics and Resins Corp. The supplier receives the e-mail notification and change request message and determines that it cannot confirm the change order and chooses to propose a different solution. The supplier then changes quantities and delivery dates and sends the counter proposal to the marketplace 10, which creates a temporary requisition T2 and sends the change request and e-mail notification to the buyer, as shown in FIG. 19(H).

The buyer then chooses to accept the counter proposal and creates a confirm order response message. The marketplace 10 updates the original order with the change in order, deletes the temporary requisitions, and sends an e-mail notification to the supplier. The supplier receives the e-mail notification and also the confirm order response message from the marketplace 10 and updates the ERP system 16.

The shipment notification process 39 is illustrated in FIG. 19(I). The supplier provides a first shipment to the supplier and sends a notification message to the marketplace 10. At the later date, the supplier sends the second shipment to the supplier and sends a corresponding shipment notification message to the marketplace 10. The marketplace 10 receives these messages, updates the status of each line item in the requisition panel, and stores the information for display by the buyer.

I. UltraLite Integration

As illustrated in FIG. 3, the marketplace 10 may integrate fully with the buyers and suppliers ERP systems 14 and 16, respectively. The full integration into the ERP systems 14 and 16 requires a rather large commitment on the side of the buyer and supplier, such as in terms of cost. UltraLite integration offers less of a commitment on the buyer and can also be performed at a lower cost. The UltraLite integration is therefore advantageous for many smaller companies who may want to use an on-line exchange, such as the marketplace 10, but which may not have all the resources necessary up front for the full integration.

UltraLite integration relies on the inherent capability of ERP systems 14 and 16 to generate customized flat file exports of orders. The marketplace 10 provides buyers with the capability for the secure automatic uploading of files to the marketplace 10. This level of integration eliminates double entry required by a browser-based marketplace approach. In combination with the marketplace 10, a buyer gets the productivity of automatic order upload, the sophisticated alternative processing of an on-line marketplace to multiple suppliers, and the management of exception handling when a supplier responds with an alternative to the original request.

A next level of integration is to enable change request. This integration enables the buyer through the same secure automatic uploading of files to request modification of existing orders. The marketplace 10 processes these change order requests and forwards them to the suppliers ERP system 16 or the marketplace browser for non-integrated suppliers. The buyer can log into the marketplace 10 to manage supplier responses to the change request if the supplier did not accept the change request. This limits the buyers work to only addressing exceptions.

This non-intrusive approach to e-market integration substantially reduces the barrier entrances to participation in business-to-business electronic commerce. A buyer is not required to add additional hardware or software to implement this basic level of outbound messaging.

After a buyer gains experience from basic outbound message integration, they may choose to integrate inbound messaging. Processing inbound messages requires a higher level of technical sophistication and generally includes additional software and hardware, such as a messaging server. The marketplace 10 has the capability to implement inbound messaging with buyers. This two step approach to outbound messages first and then inbound messages second reduces the entrance barrier and shortens the payback period for the higher cost inbound messaging implementation.

In the preferred embodiment, the UltraLite integration involves the use of JAVA code at the buyer's system for taking a flat file or an XML file as a parameter. This code creates an HTTP or HTTPS connection to the integration hub 14 and pushes the file to the marketplace 10.

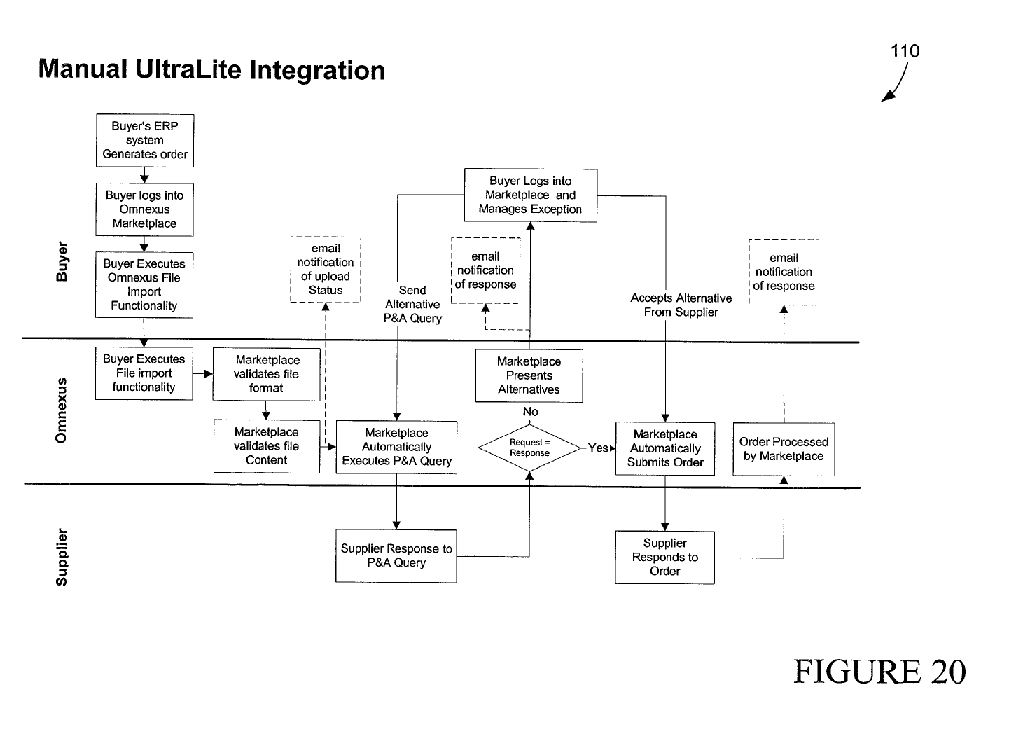

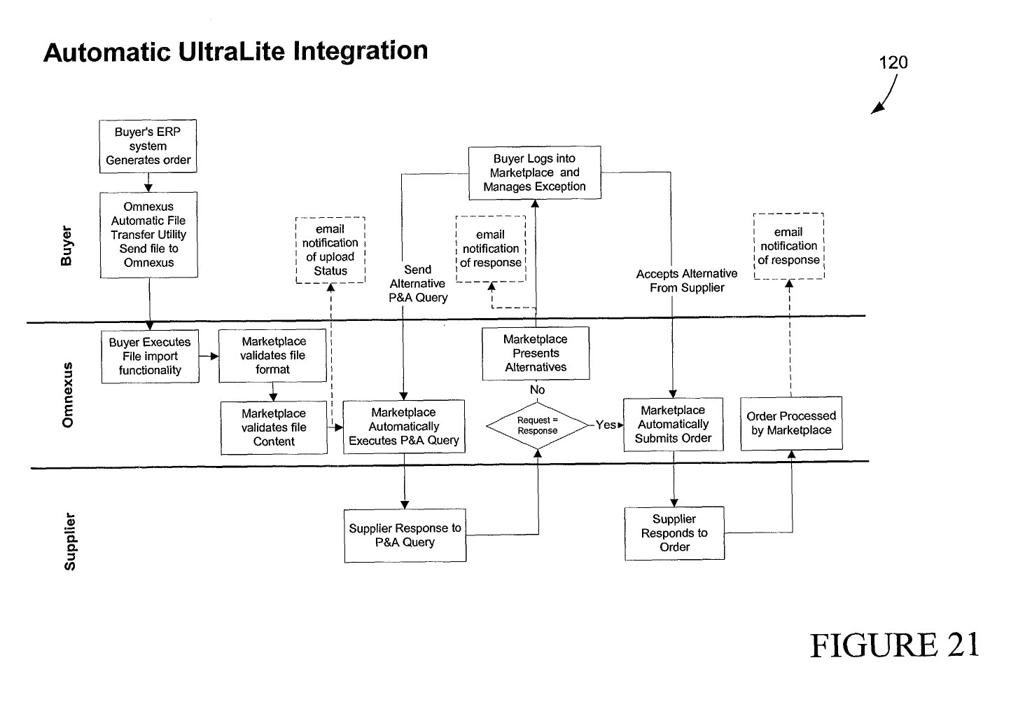

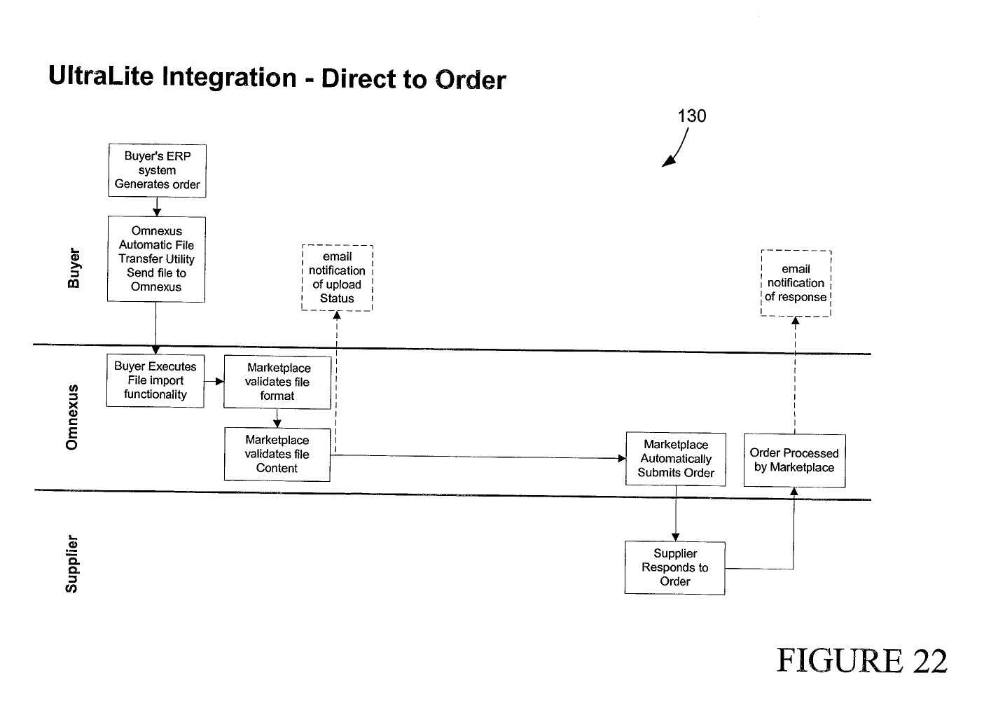

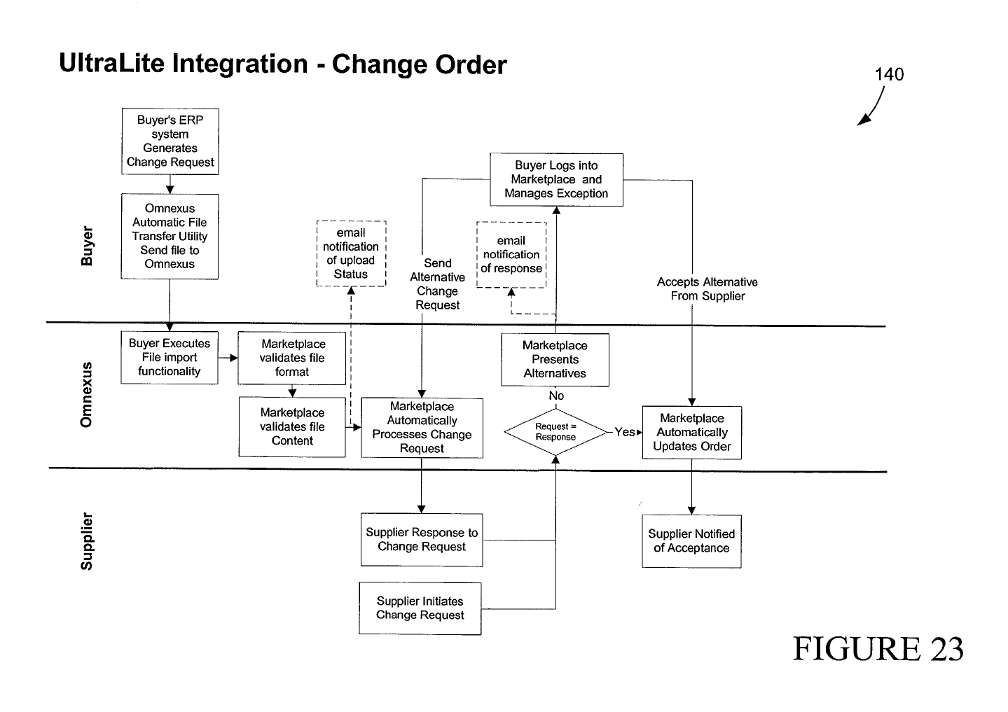

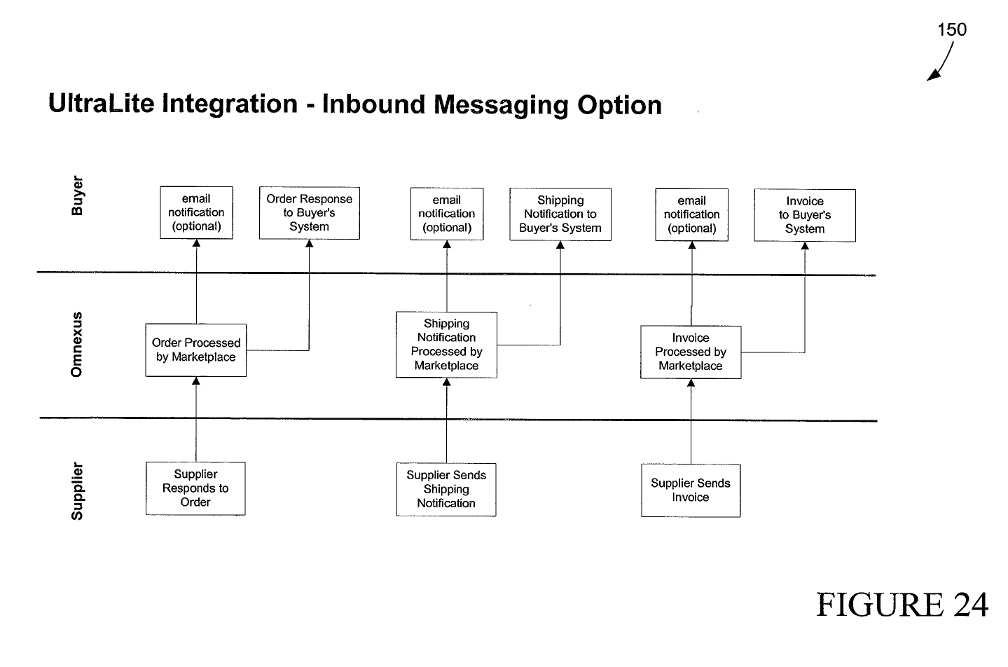

The buyer also has a JAR file which permits WebMethods communication. Process flows associated with the UltraLite integration will now be described with reference to FIGS. 20 to 24. FIG. 20 illustrates a process flow for manual UltraLite integration. The buyer generates an order through its ERP system, logs into the marketplace 10, and executes the file import functionality. The marketplace 10 receives the file from the buyer, validates the format, validate the content, and automatically executes the price and availability query. Based on the response from the supplier, the marketplace 10 presents alternatives to the buyer through e-mail notification. The buyer can also log into the marketplace 10 and manage exceptions. FIG. 21 is a method 120 of automatic UltraLite integration. The process 120 begins with the buyer generating an order through its ERP system and then automatically transferring the file to the marketplace 10. FIG. 22 illustrates a process 130 of UltraLite integration with direct to order. According to this method 130 the buyer generates an order through its ERP system and automatically transfers the file to the marketplace 10. The 10 marketplace 10 validates the file format and content and then automatically submits the order to the supplier. Based on the response from the supplier, the marketplace 10 processes the order and sends the buyer an e-mail notification of the response. FIG. 23 is a process 140 of UltraLite integration with a change order. The buyer, or supplier, generates the change request through its ERP system and then automatically transfers the file to the marketplace 10. The marketplace 10 validates the file format and content and then automatically processes the change request and sends it to the supplier. If the supplier's response matches the buyer's request, then the marketplace automatically updates the order, notifies the supplier, and also notifies the buyer. If the response does not match the request, then the marketplace 10 presents the alternatives to the buyer through an e-mail notification and allowing the buyer to log into the marketplace and manage the exceptions. A method 150 of inbound messaging through UltraLite integration is illustrated in FIG. 24. Based on a supplier's response to an order, the marketplace 10 processes the order, sends the buyer an e-mail notification, and forwards the supplier's response to the buyer's system. In a similar manner, the shipping notification and invoicing are forwarded to the buyer's system both by e-mail and inbound messaging.

J. Sourcing

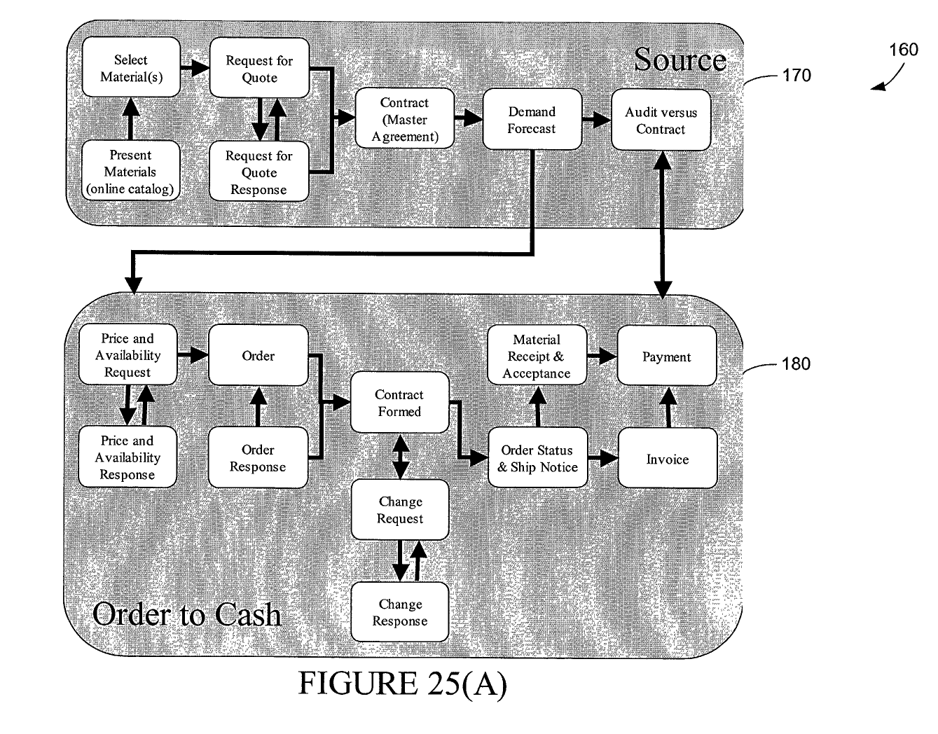

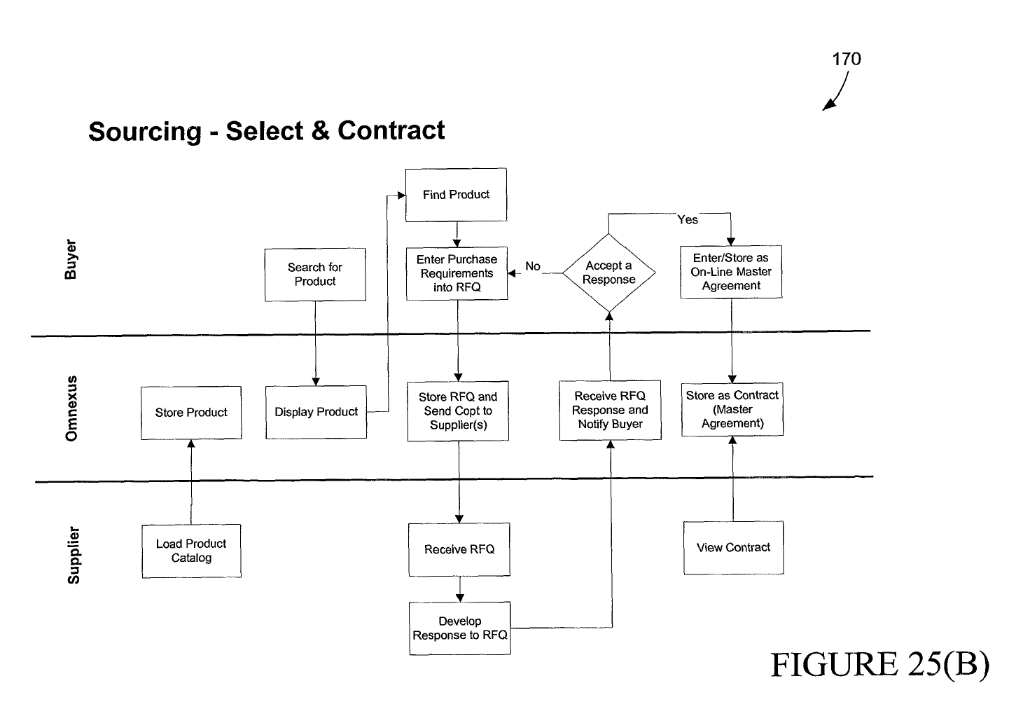

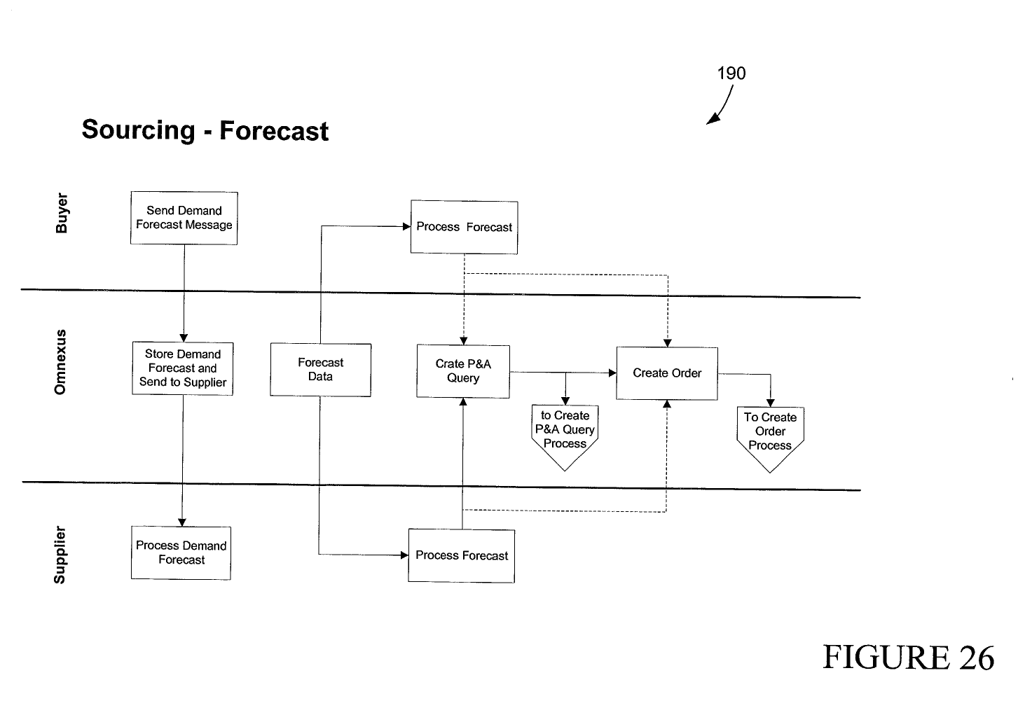

FIG. 25(A) illustrates a process 160 which includes a sourcing process 170 and an order to cash process 180. The sourcing process is shown in both FIGS. 25(A) and 25(B) and involves the suppliers loading product information into an on-line catalog stored at the marketplace 10. The buyer can search and select items from these catalogs and issue a request for Quote (RFQ). The marketplace 10 stores the RFQ and sends copies to the suppliers. The suppliers develop a response which is forwarded to the marketplace 10 which then notifies the buyer. If the buyer accepts, then the RFQ forms basis for an on-line master agreement between the parties which is stored at the marketplace 10. If the response is not accepted by the buyer, the buyer may modify it and issue a new RFQ which is sent to the supplier. After a master agreement has been formed, the sourcing involves forecasting. The forecasting is shown in more detail in FIG. 26. The forecasting process 190 begins with the buyer sending a demand forecast message through the marketplace 10 to the supplier. The marketplace 10 takes the forecast data and inputs from the buyer and supplier to create a PNA query. The PNA query is then processed in the manner described above with requisition checks and, if an order is created, the order is processed in the manner described above. As shown in FIG. 25(A), the demand forecast translates into a price and availability request and can ultimately lead to an order. The order is subject to a legally binding contract but the parties may mutually agree upon changes, as shown by the change request and change response steps within the order to cash process 180. Once the goods have been shipped, the shipment notice is sent to the buyers through the marketplace and invoicing may also occur through the marketplace 10.

K. Audit/Reconcile

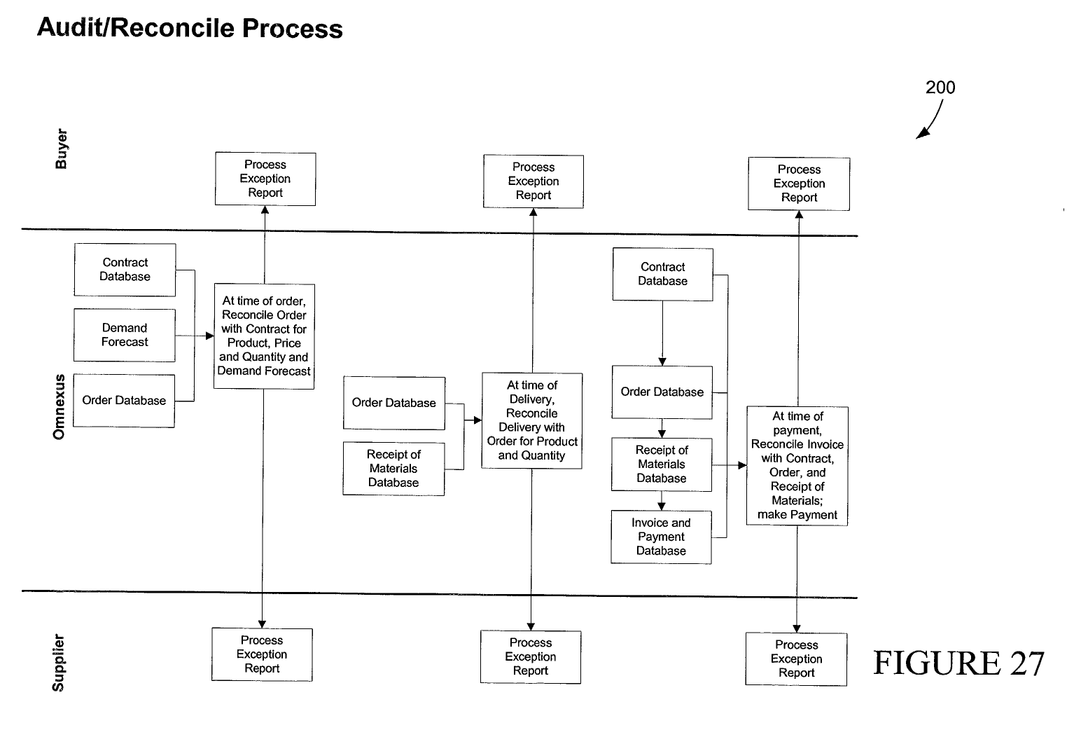

An audit/reconcile process 200 will now be described in more detail with reference to FIG. 27. At the time of an order, the marketplace 10 reconciles the order with the contract for product, price, and quantity and also with the demand forecast. The marketplace 10 then generates process exception reports which are forwarded to the buyer and supplier. At the time of delivery, the marketplace 10 reconciles the delivery with the orders for product and quantity and generates exception reports which are forwarded to the buyer and supplier. Finally, at the time of payment, the marketplace 10 reconciles the invoice with the contract, orders, and receipt of materials. The marketplace 10 also reconciles any payments that have been made and generates exception reports to the buyer and supplier.

The marketplace 10 is therefore uniquely positioned to handle the sourcing of goods to buyers and associated issues in sourcing. The marketplace 10 enables buyers and suppliers to form and enter into a master agreement and handles demand forecasting. The marketplace 10 accommodates orders under this master agreement and all related issues, such as change requests, shipping, invoicing, materials receipt, and payment. Under the master agreement, the marketplace 10 also performs the necessary auditing and reconciling based on the orders, the contract, invoices, payment, and receipt of materials.

L. Cash

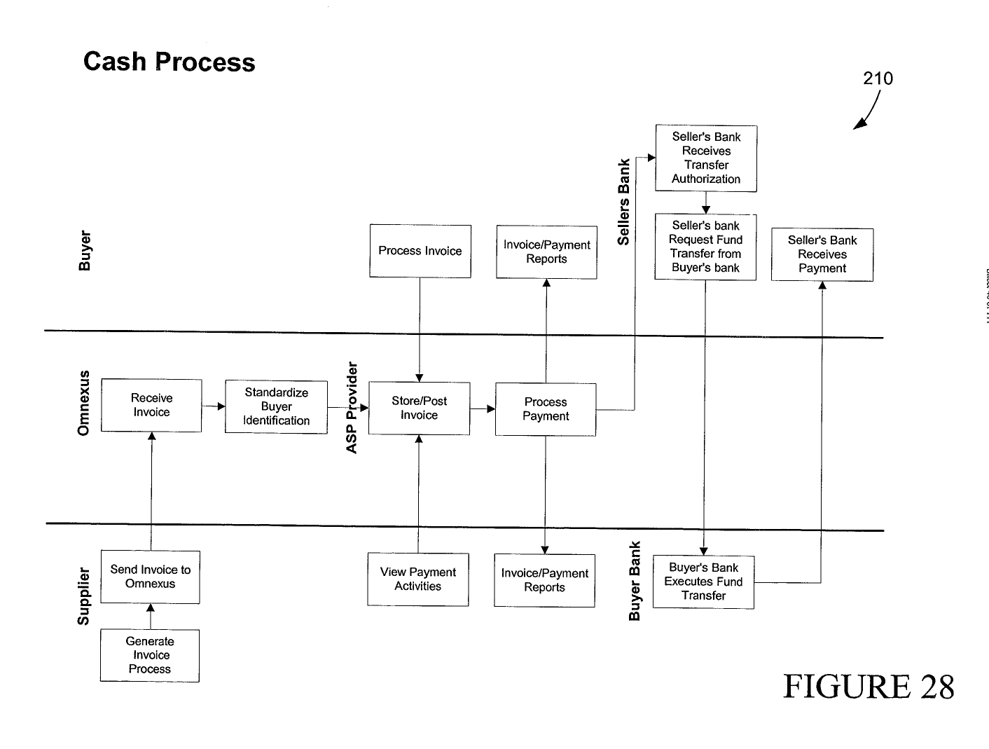

A cash process 210 is illustrated in FIG. 28. The supplier generates an invoice and sends the invoice to the marketplace 10. The marketplace 10 standardizes the buyer identification and stores as well as posts the invoice. The buyer can then process the invoice and make payment, such as through an ASP provider. The marketplace 10 is involved in the payment process and provides reports to the buyer and supplier and lets the supplier view all payment activities. The actual payment from the buyer begins with the seller's bank receiving transfer authorization and requesting fund transfer from the buyer's bank. The buyer's bank then executes the fund transfer so that the seller's bank receives payment.

V. USER INTERFACES

A. Main Interface

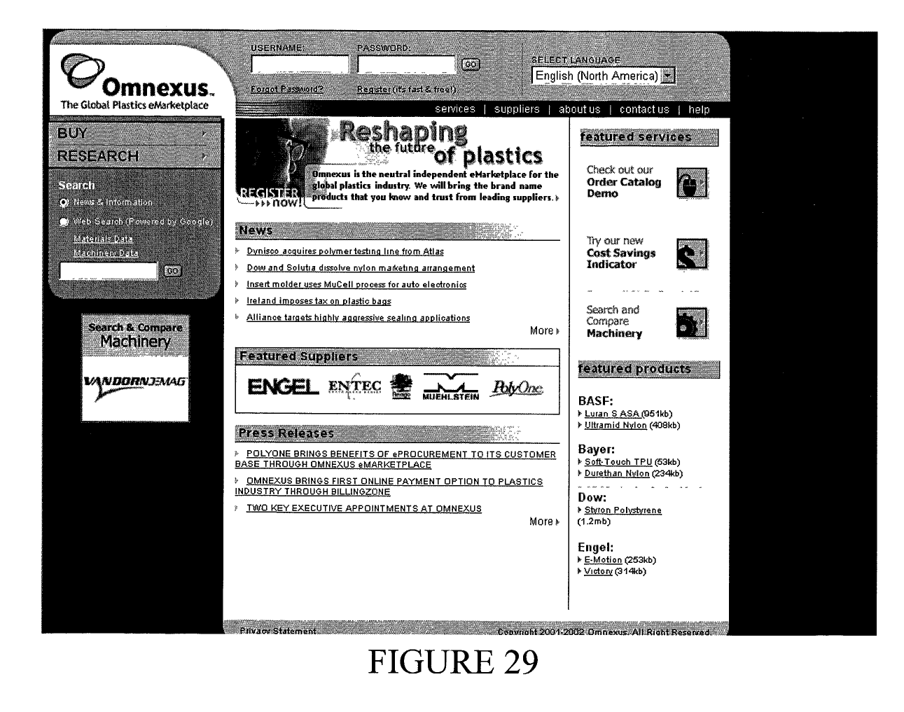

An exemplary set of user interfaces for enabling the process flows described above will now be described with reference to FIGS. 29 to 49. It should be understood that these interfaces are just one way in which the process flows may be embodied and that the invention is therefore not limited to these particular interfaces. Furthermore, the processes may be implemented with other numbers of interfaces. In other words, the steps or acts within a process may be implemented with a greater number or fewer number of interfaces than illustrated in these Figures.

FIG. 29 illustrates a main interface, or home page, to the marketplace. Through this main interface, visitors can read news, review press releases, learn more about featured products, or use featured services, such as an order catalog, a cost savings indicator, or search and compare machinery. Though this main interface, users of the marketplace can also enter their user name and password to log in to the marketplace. Additionally, through this main page, visitors can perform research, such as research on materials, machinery, events, press room, or news. In conducting research on news, the visitor can research certain markets, such as automotive, appliances, chemicals, computers, construction, medical, and packaging, can research processing, such as auxiliary equipment, molding and tooling, primary equipment, rapid prototyping, semi finish goods, or software, and can research materials, such as elastomers, engineering resins, or thermoplastics. The main page also allows the visitor to select a preferred language and region and also allows visitors to perform a search. The main page also provides advertising opportunities and an opportunity to highlight featured suppliers.

B. Search Capabilities

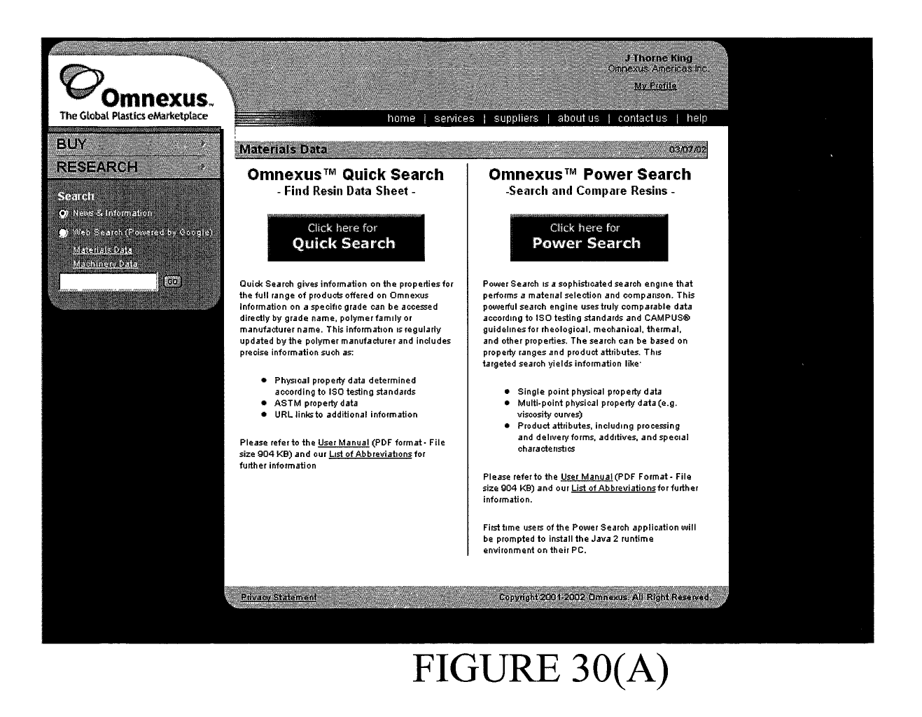

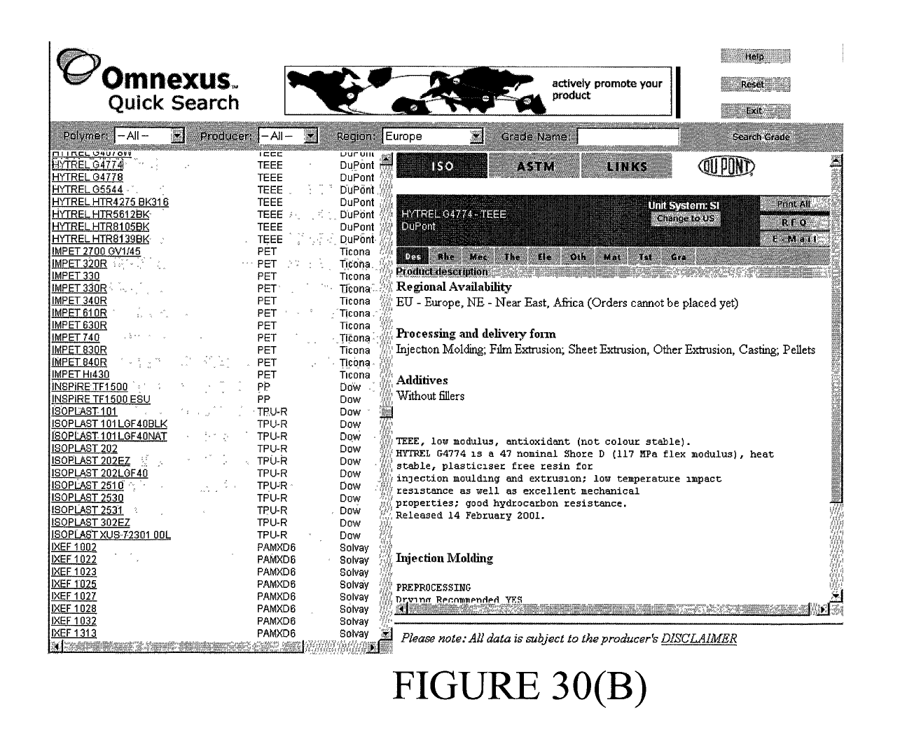

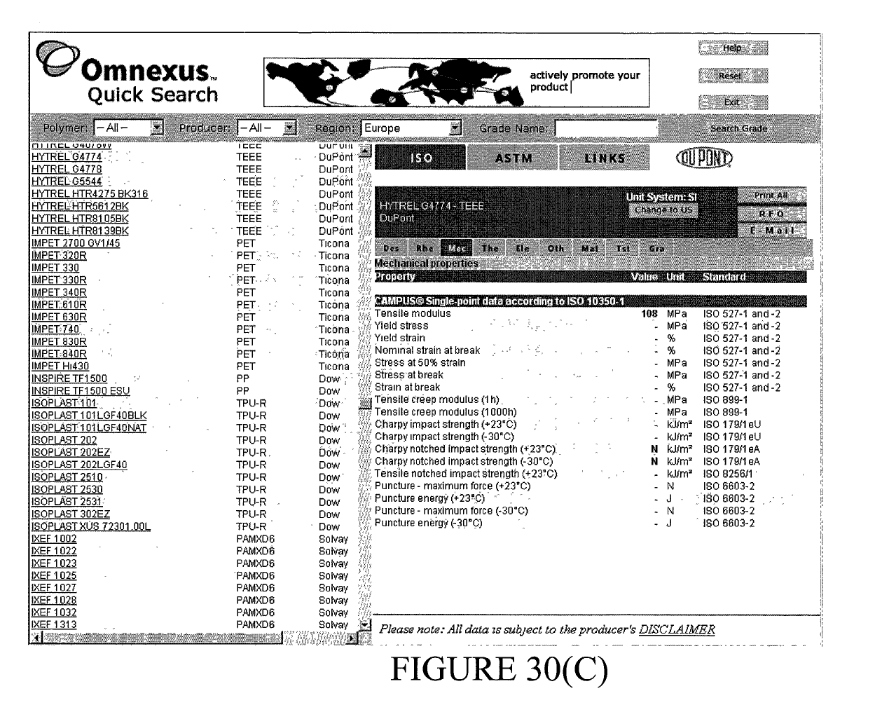

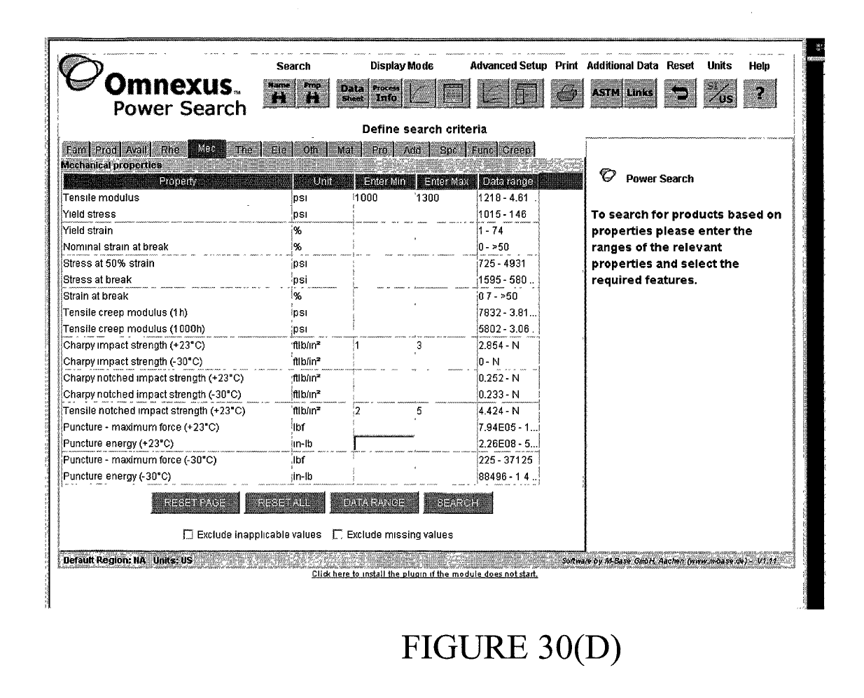

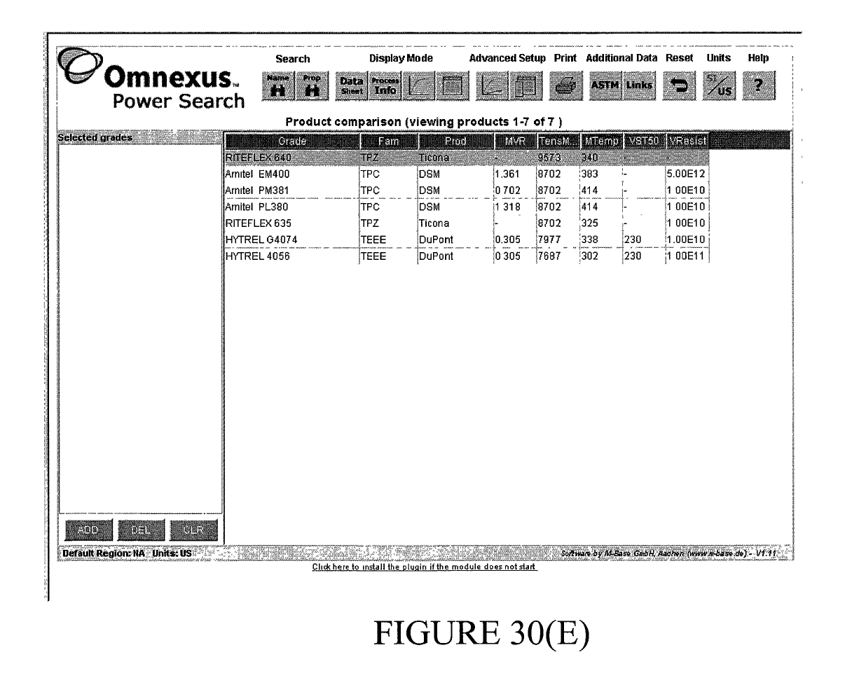

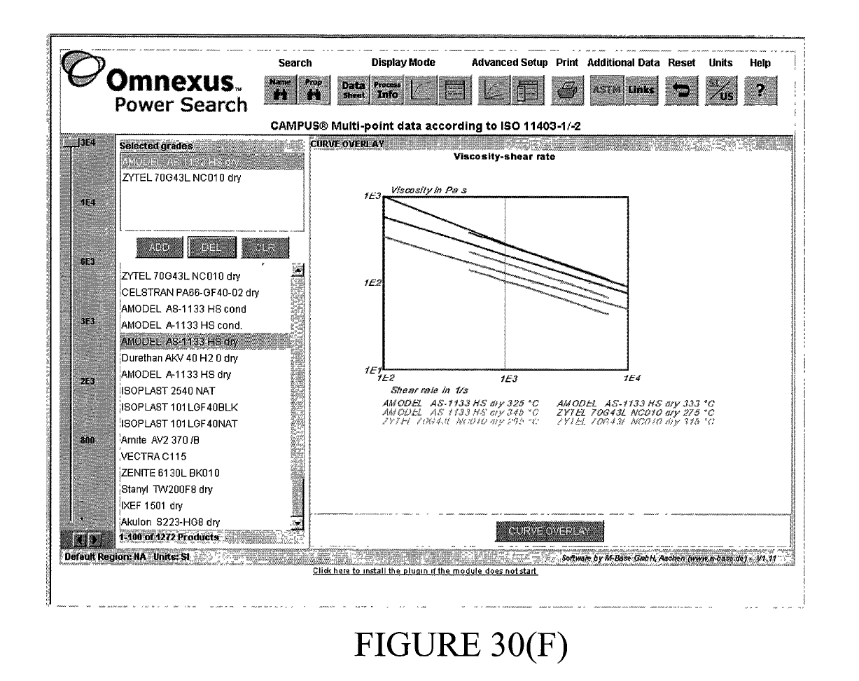

Upon selection of the “Materials Data” link in the search area of the main page, the marketplace then provides the interface shown in FIG. 30(A). The marketplace provides the visitor with the option to perform a quick search or a power search. FIGS. 30(B) and 30(C) provide examples of search results through the quick search. As shown in FIG. 30(B), a visitor can select the type of goods, the producer, the region, and a grade name and see all goods that meet that criteria. In the example shown in FIG. 30(B), the list of polymers in Europe are shown in list form in a box on the left hand side of the interface and can view characteristics of a good selected from the list in a box on the right hand side of the interface. For the description of the goods, the visitor can choose between ISO and ASTM and can also select between SI or US units. In this example, the characteristics that can be reviewed include a product description, rheological properties, mechanical properties, thermal properties, electrical properties, other properties, material specific properties, test specimen production information, and multi-point data. As shown in these figures, the visitor can generate an RFQ or select the E-Mail link so that a data sheet can be sent to a desired e-mail address. In order to generate the RFQ, the visitor must first log in to the marketplace. For each of the goods, the visitor can also select the “LINKS” to access links provided by the supplier of those goods, such as links to a homepage for the supplier, datasheets, or other such relevant information.

FIGS. 30(D) to 30(F) illustrate the use of the powersearch option presented in FIG. 30(A). In general, the powersearch allows a visitor to perform material selection and comparison and to search based on property ranges and product attributes. FIG. 30(D) illustrates one example of search results and reveals how a visitor can obtain information on the properties of the goods. For example, the marketplace can provide material families, material producers, regional availability, rheological properties, mechanical properties, thermal properties, electrical properties, other properties, material specific properties, processing and delivery form, additives, special characteristics, multi-point data, and creep data. The interface has a number of buttons at the top for allowing the visitor to select the display mode, with these modes including data sheet mode which is illustrated in FIG. 30(D), process information, multi-point data which is shown in FIG. 30(F), or property table which is shown in FIG. 30(E). The powersearch also allows a visitor to create a curve overlay whereby multiple materials can be selected and the marketplace provides comparison between those materials and a table set up button where the visitor can select which properties to be displayed in a table.

C. Request for Quote

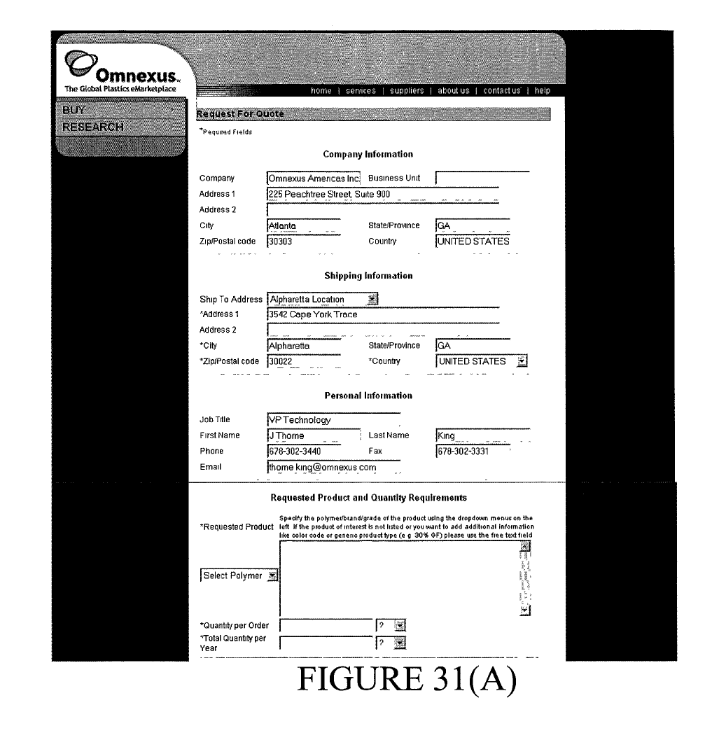

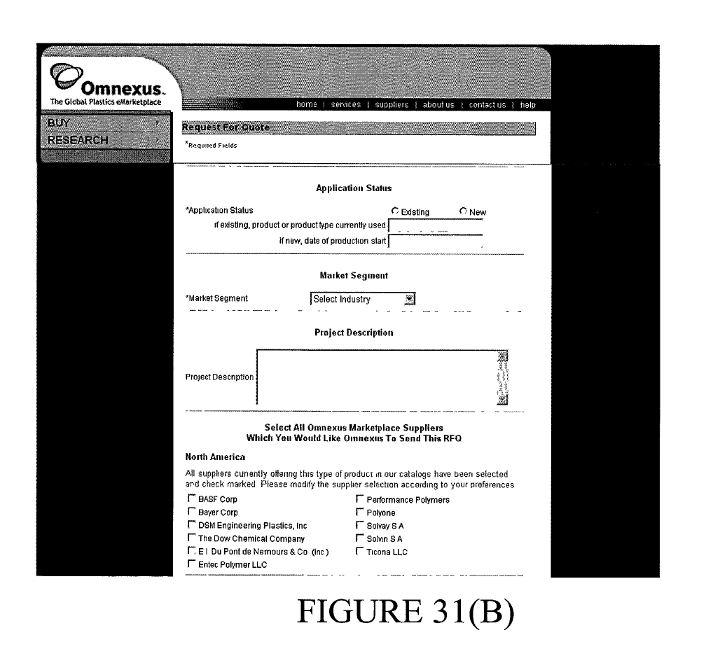

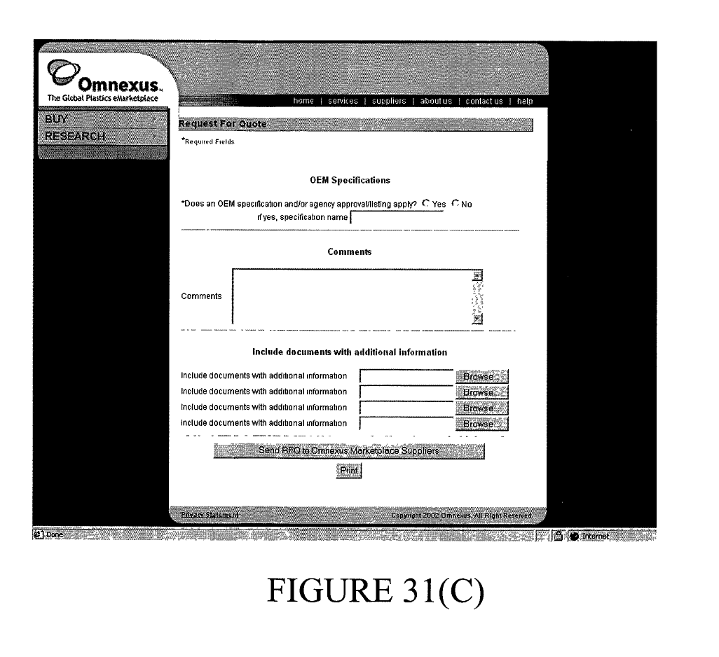

An explanation will now be given illustrating how a user can issue an RFQ. FIGS. 31 (A) to 31(C) illustrate the interface provided to the user by which the user generates the RFQ. Through this interface, the user enters company information, shipping information, personal information, requested product and quantity requirements, application status, market segment, product description, and a list of suppliers from which the user can select. The user can also enter any OEM specifications, provide comments, and include documents having additional information. After entering all of this information, the user can print the RFQ before sending it or select the “Send RFQ To Omnexus Marketplace Suppliers” button to send the RFQ.

D. Contract Formation

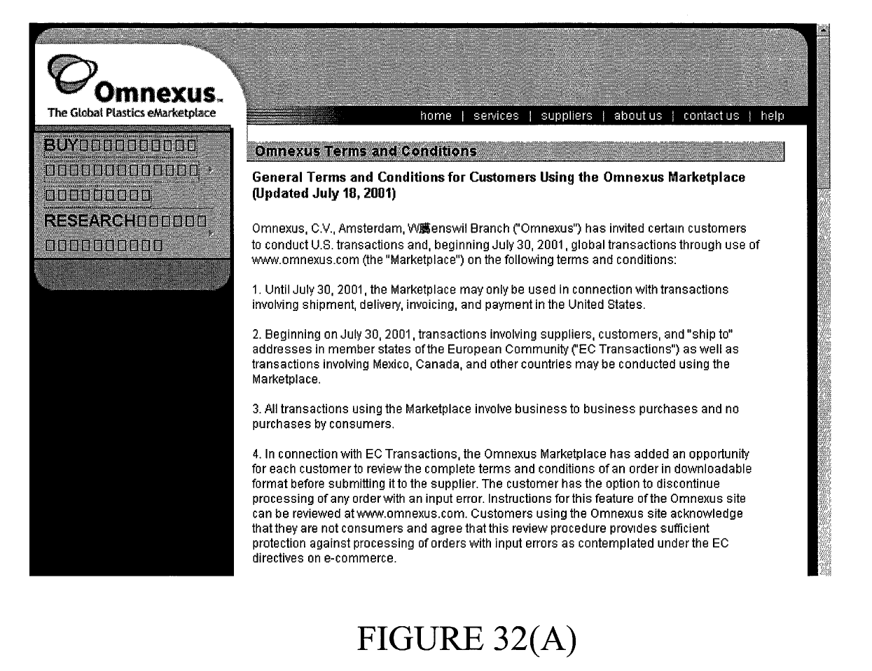

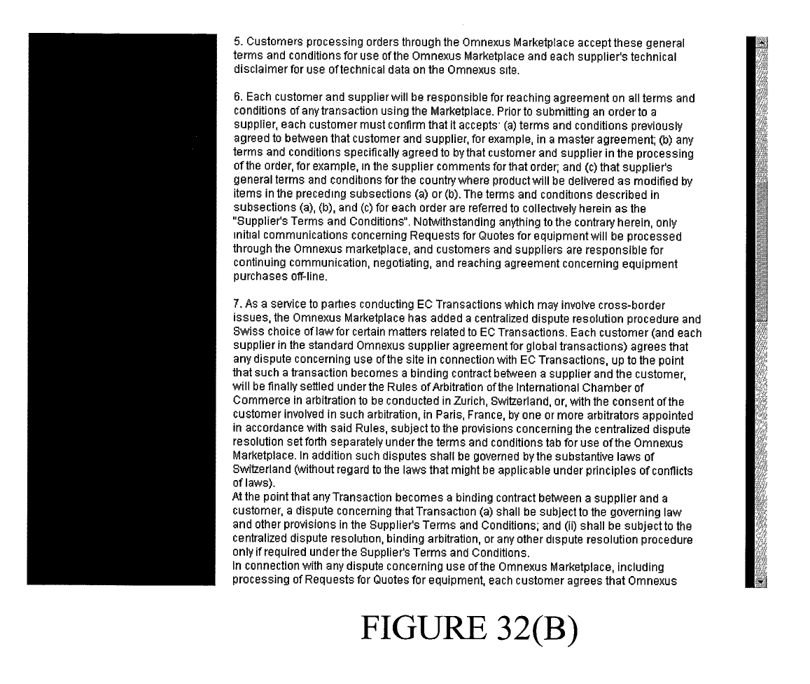

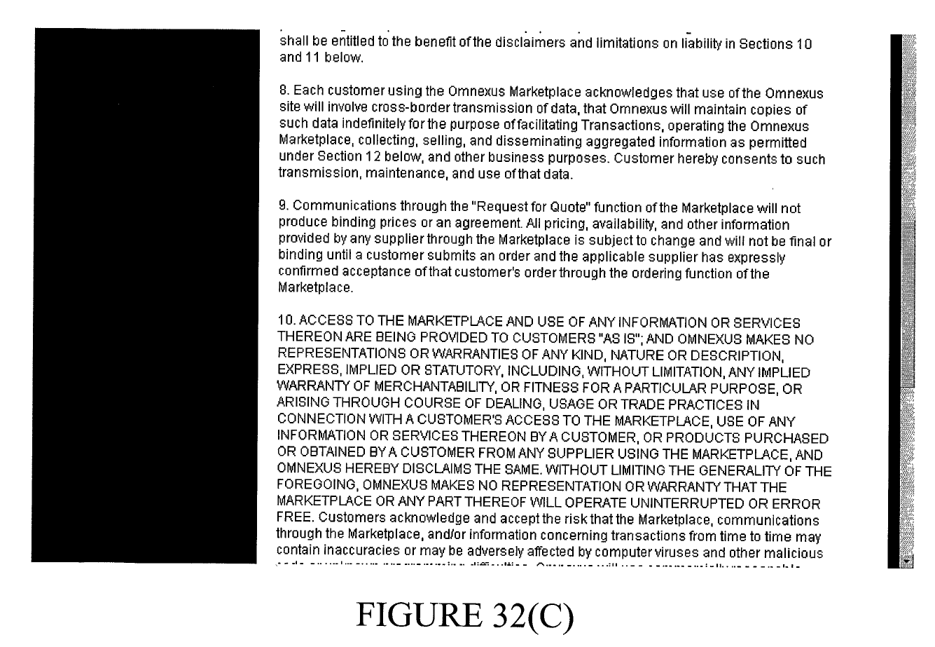

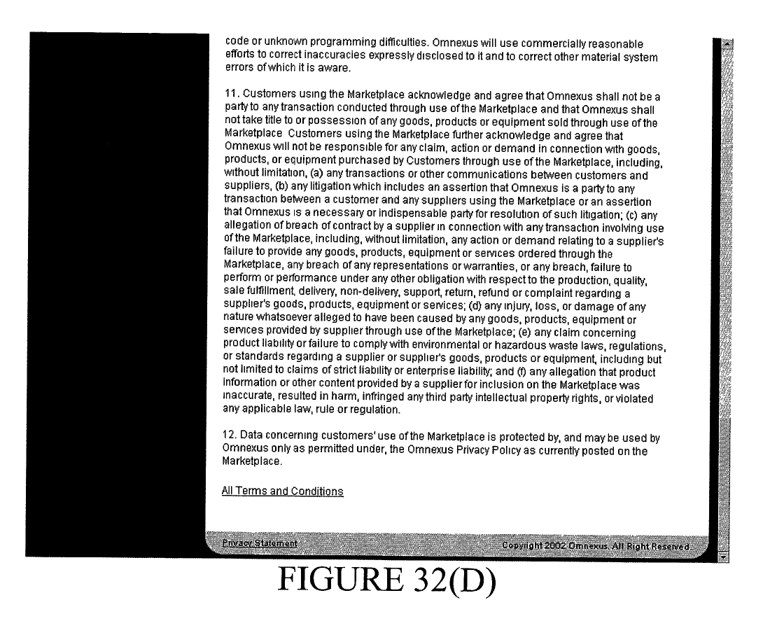

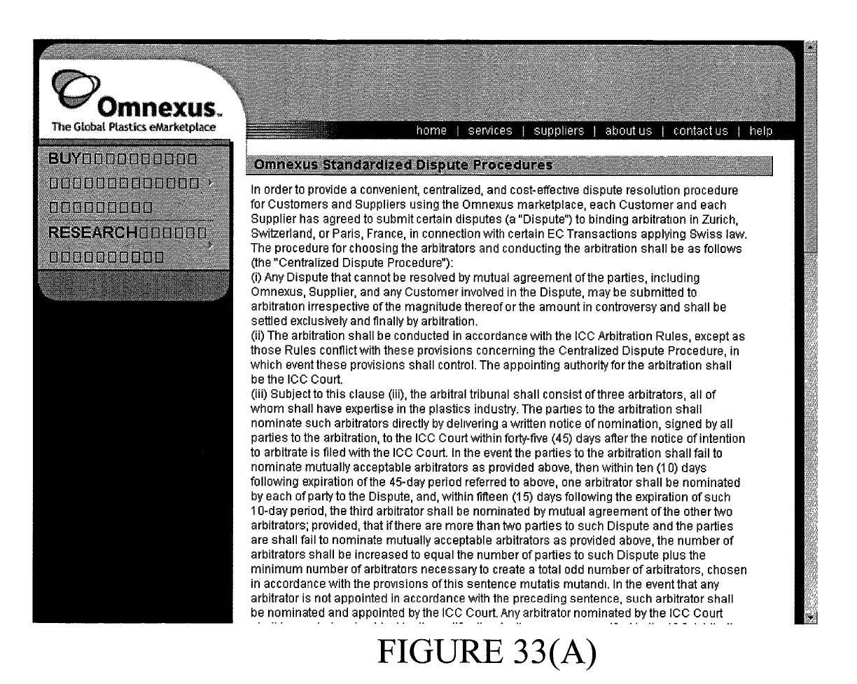

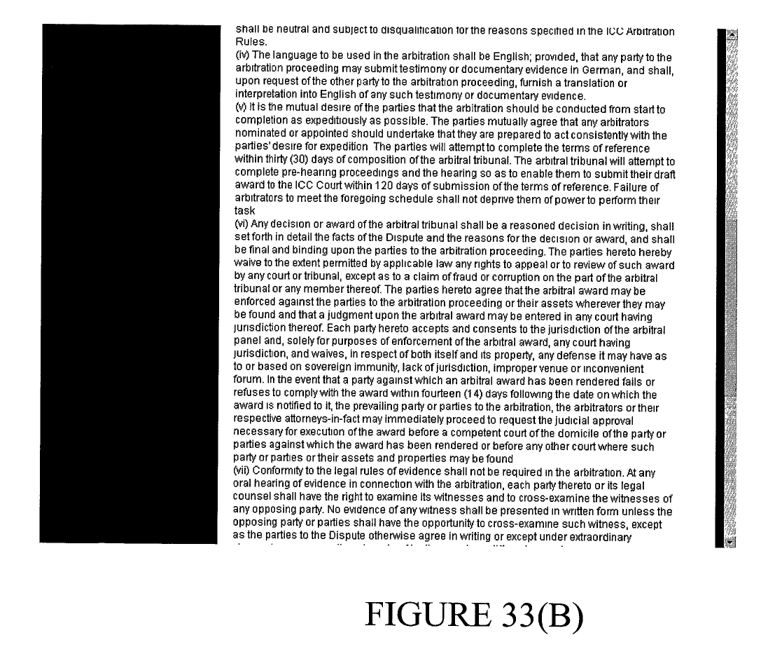

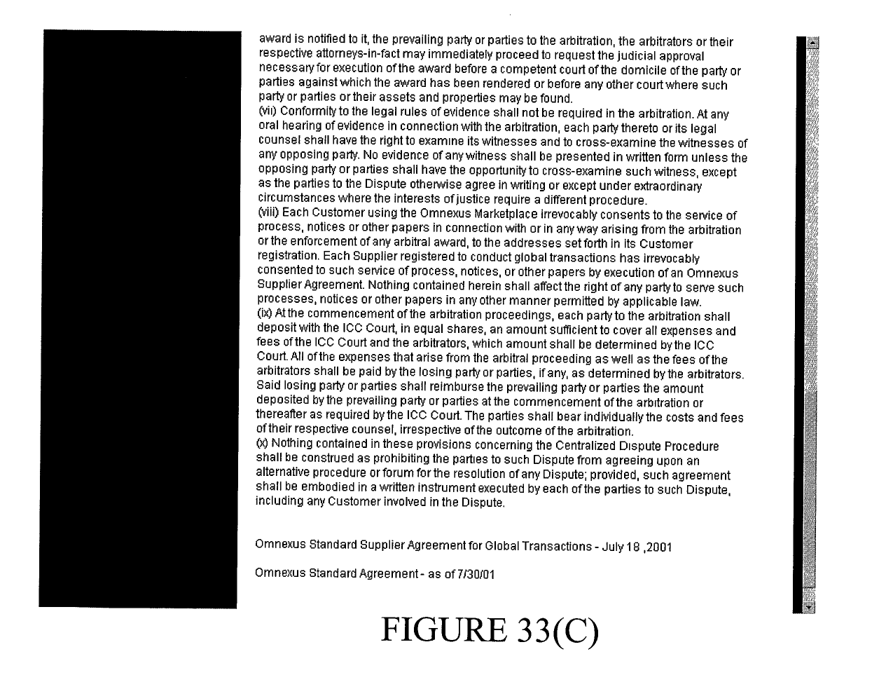

FIGS. 32(A) to 32(D) specify the terms and conditions for customers' use of the Omnexus marketplace 10. Among other things, these terms and conditions specify the geographical reach of the marketplace, the limitation that the customers or users must be businesses and not consumers, that the customer has the option to review the terms and conditions of an order in a downloadable format before submitting it to the supplier and the ability to discontinue processing of an order based on input error. The users must agree to these terms and conditions as part of their use of the marketplace. The terms and conditions also refer to a centralized dispute resolution procedure which users agree to use in settling any disputes for European Community (EC) transactions. Additional details on the dispute procedures are shown in FIGS. 33(A) to 33(C).

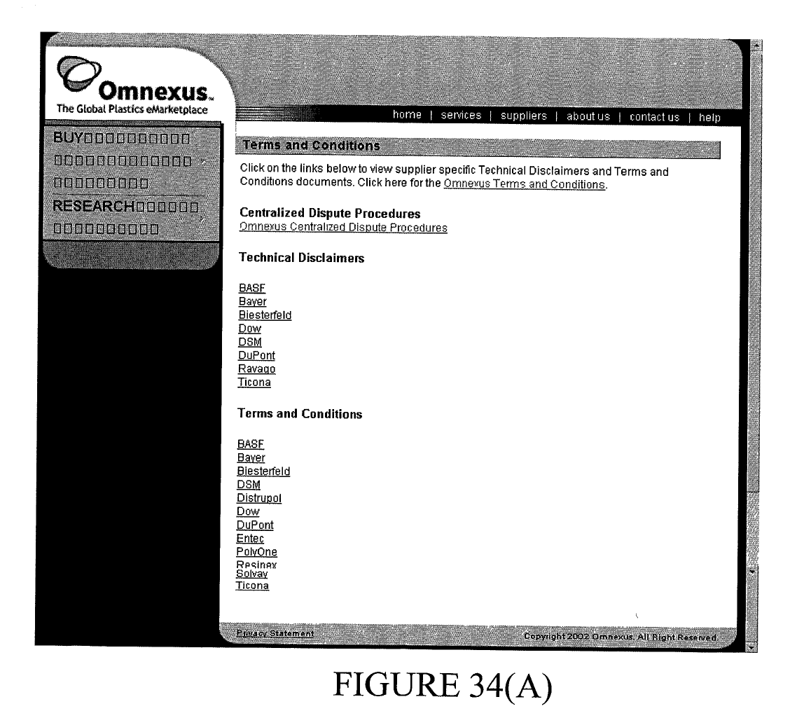

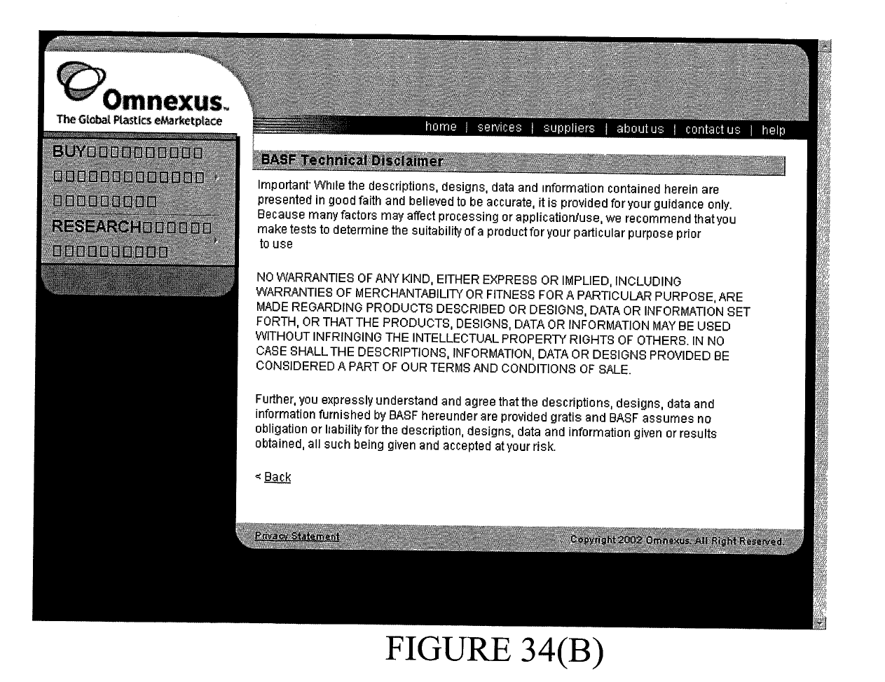

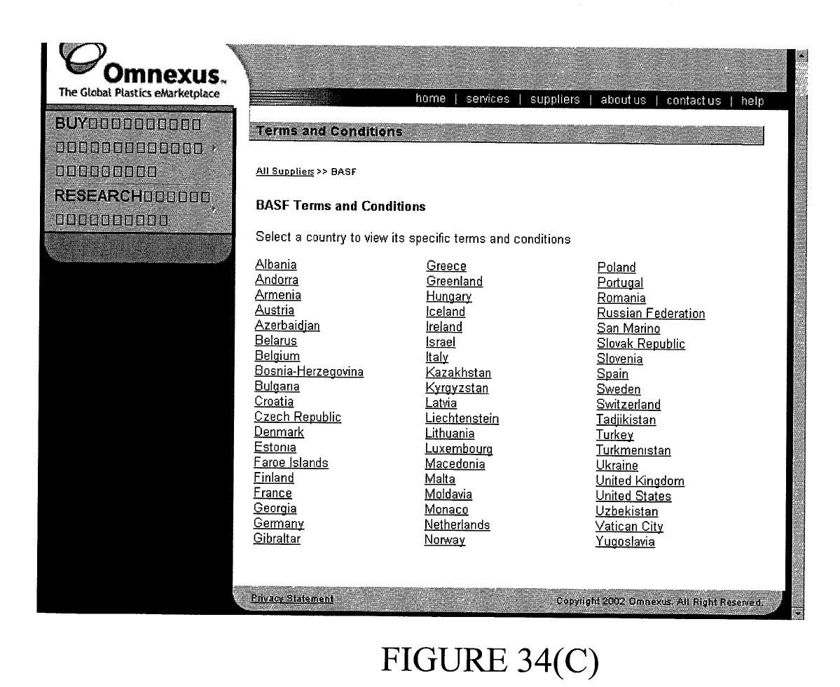

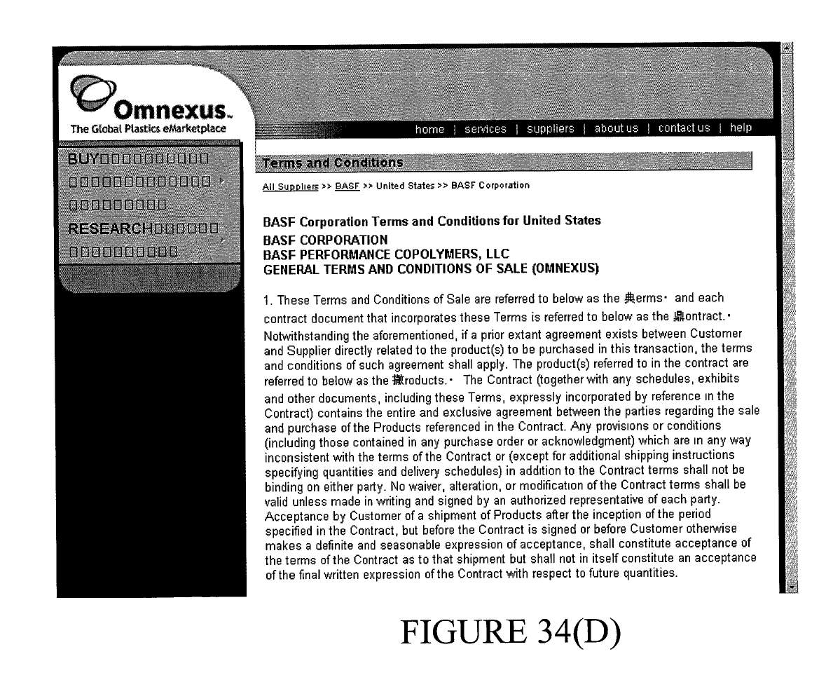

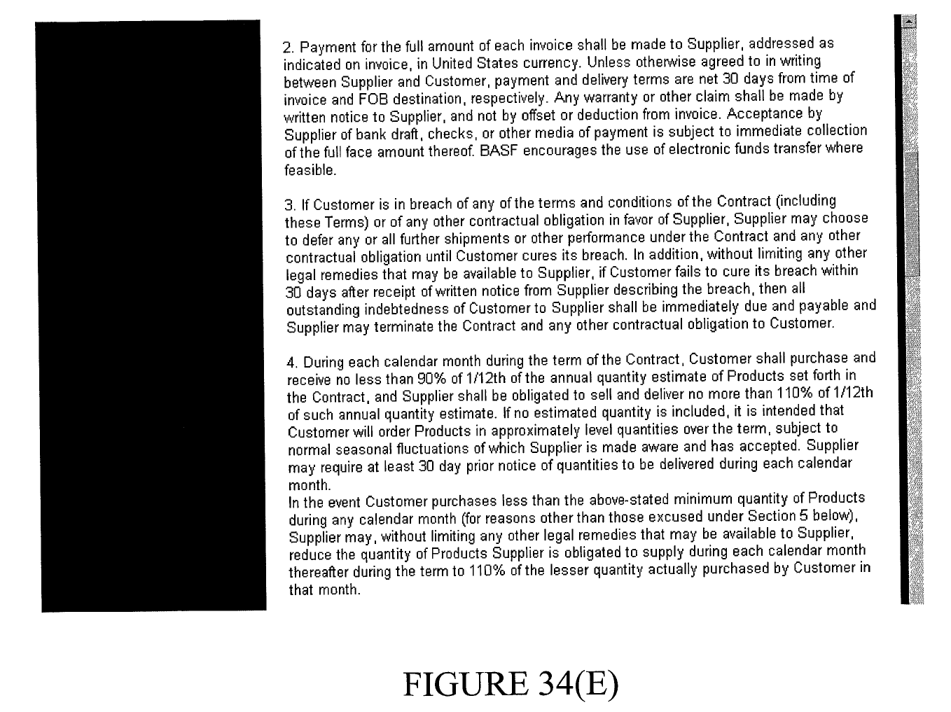

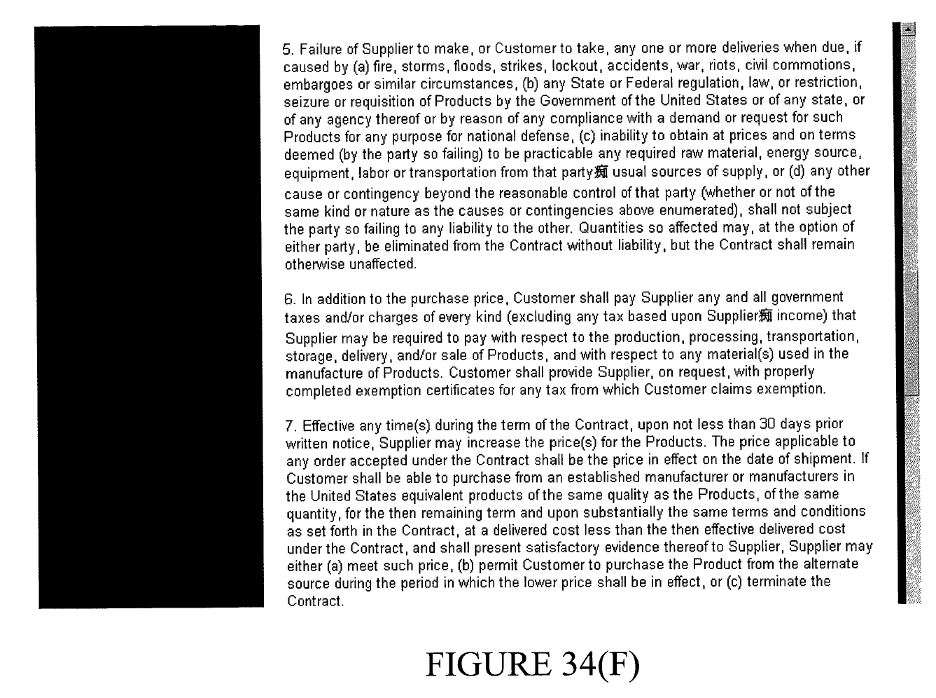

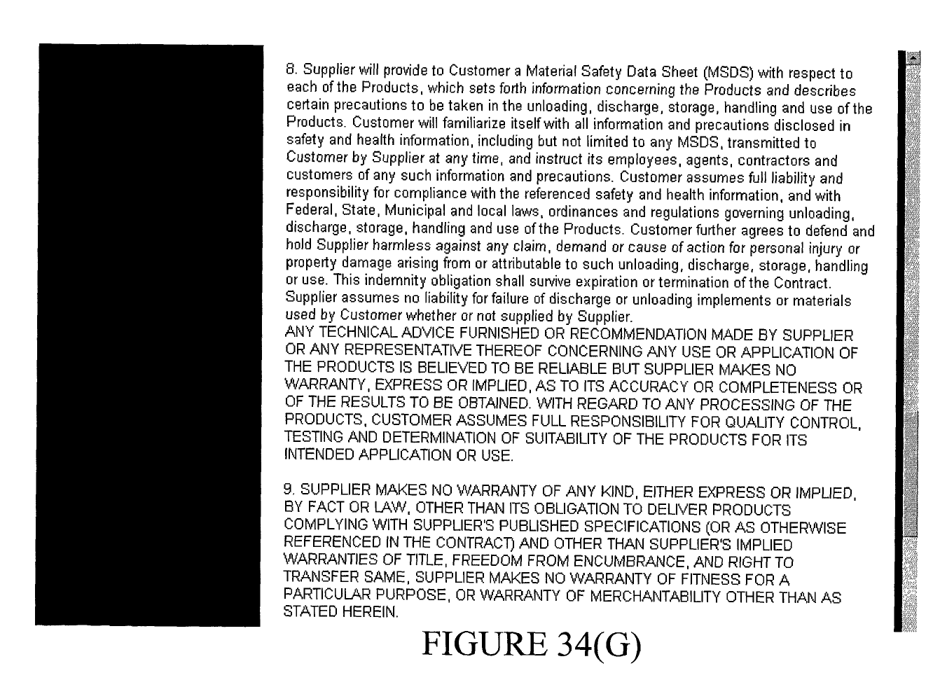

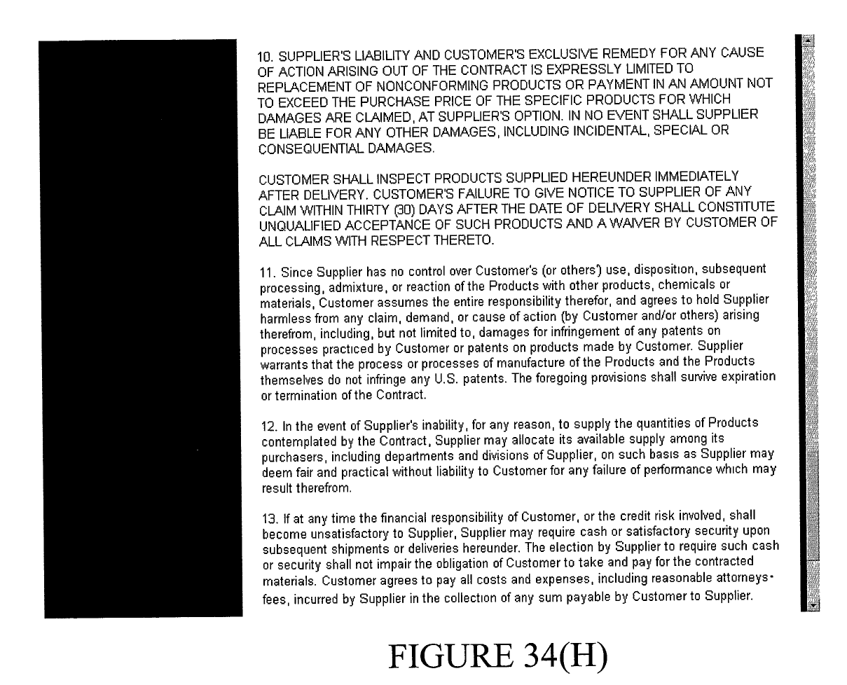

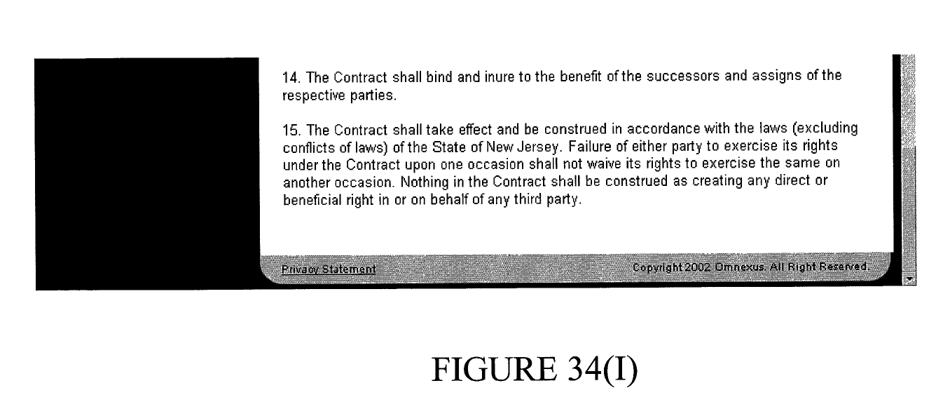

The terms and conditions also explain that any agreement reached between a customer and supplier encompasses any terms and conditions specific for a supplier. FIGS. 34(A) to 34(I) provide examples of the terms and conditions of suppliers as well as their technical disclaimers. As shown in these figures, the terms and conditions may vary according to the country and also according to the goods.

The use of the marketplace by a buyer and seller preferably does not replace any existing relationships or agreements between the parties. Instead, by accepting an offer, the buyer accepts (1) the terms and conditions previously agreed to between the buyer and supplier, such as in a master agreement; (2) the terms and conditions specifically agreed to by the buyer and supplier in the processing of the order, such as in comments or mutually agreed to exceptions; and (3) the supplier's general terms and conditions for the country where the product will be delivered.

For example, a buyer and seller may have entered into a master agreement or some other agreement that dictates terms and conditions of any orders requested by the buyer and accepted and fulfilled by the seller. The terms and conditions of using the marketplace 10 make clear that any prior such agreement will continue to govern transactions handled by the marketplace 10, unless otherwise noted by the supplier in its communications for a specific order through the marketplace 10. Any previous agreement between the buyer and seller would govern the general terms and conditions of the contract while the price and quantity would be governed by messaging between the parties through the marketplace 10. If no such master agreement is in place, then the terms and conditions loaded on the marketplace 10 will govern the transactions between the parties, again subject to any exceptions mutually agreed upon by the parties.

As will be explained in more detail below, the formation of the contract between the parties is structured to be in compliance with EU directives on e-commerce and any other applicable laws of a country. When placing an order, the buyer is able to review the governing terms and conditions of the contract and is able to download and print them out for review. As a result, the buyer is able to discontinue the processing of an order due to a typographical or input error before it becomes a binding contract. The marketplace links the appropriate set of terms and conditions for each supplier for each country based upon where the goods will be shipped. In other words, the terms and conditions of a particular transaction may very well differ between suppliers and even between countries for a single supplier. The marketplace furthermore permits the buyer and seller to depart in mutually agreeable ways from either a previously entered master agreement or from the terms and conditions provided through the marketplace. Thus, when the buyer submits an order the buyer is essentially making an offer to purchase goods at a given price and quantity and this offer includes all of the relevant terms and conditions associated with any master agreement, the terms and conditions loaded on the site by suppliers, or variances from those terms. When the seller then accepts the order, the seller is providing assent to the price and quantity and to all other terms and conditions.

E. Order Process

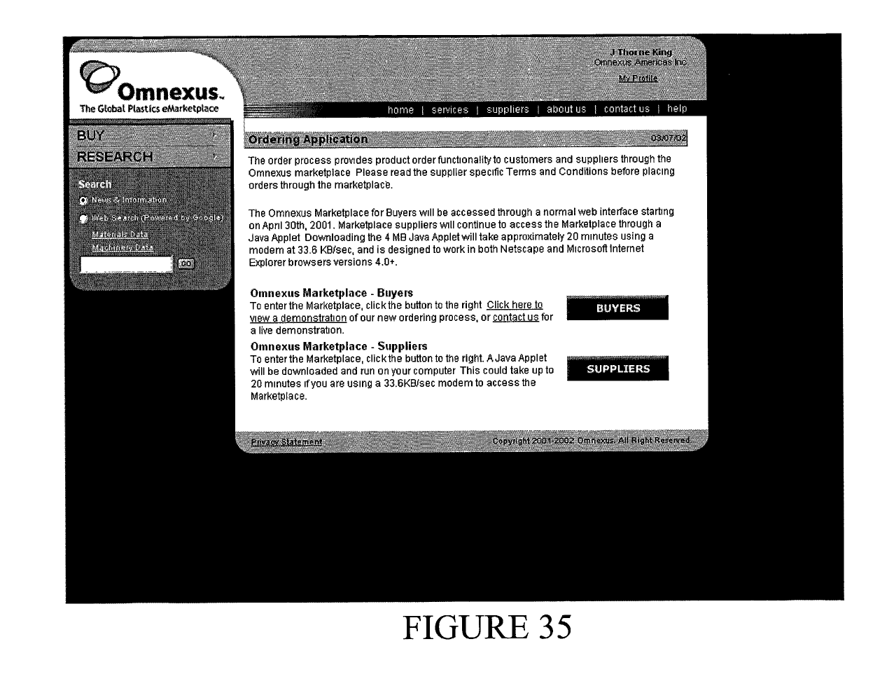

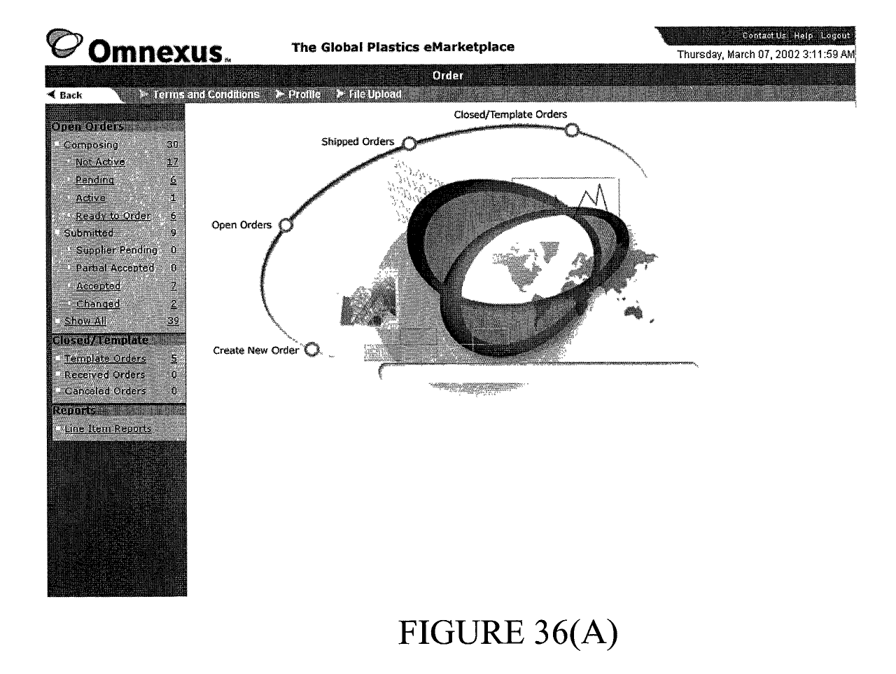

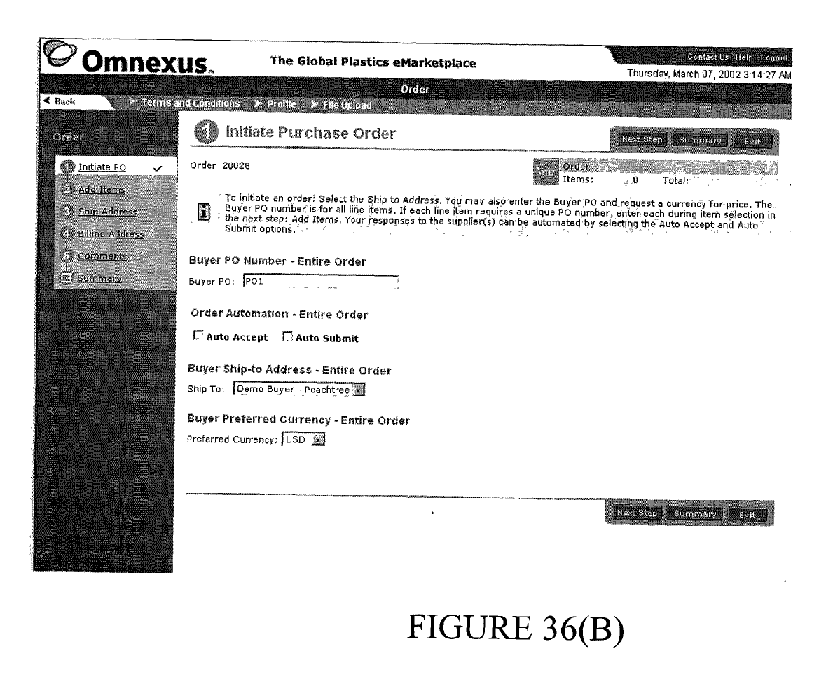

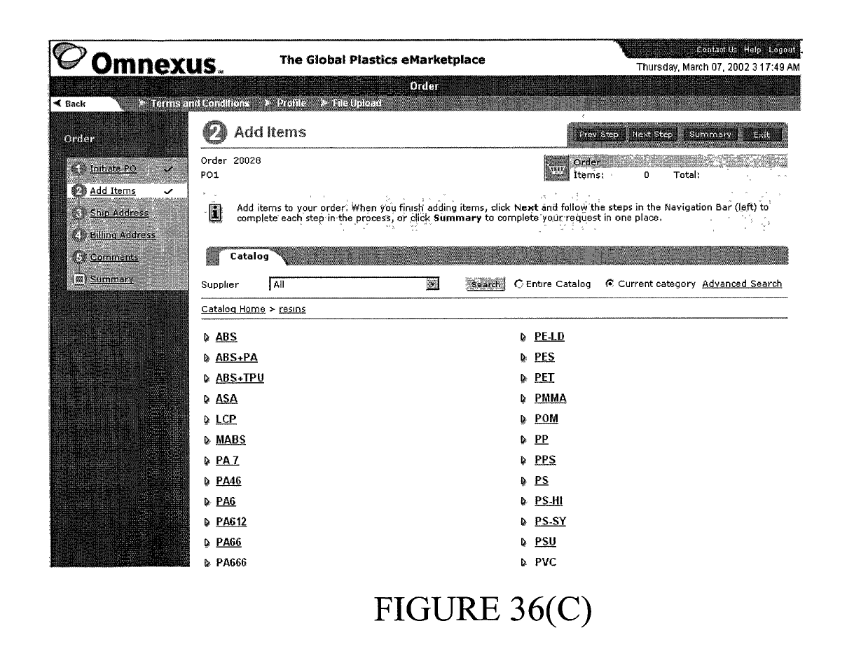

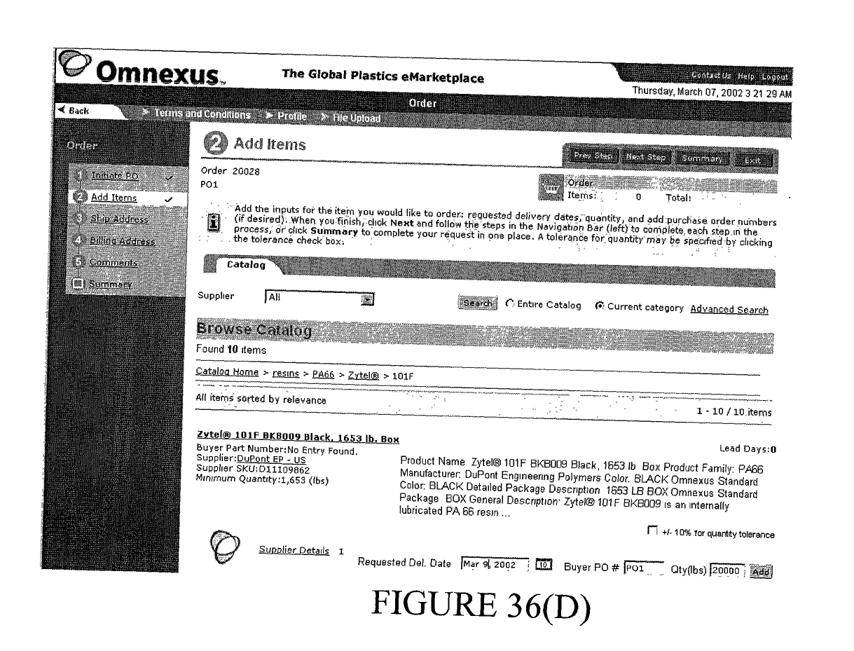

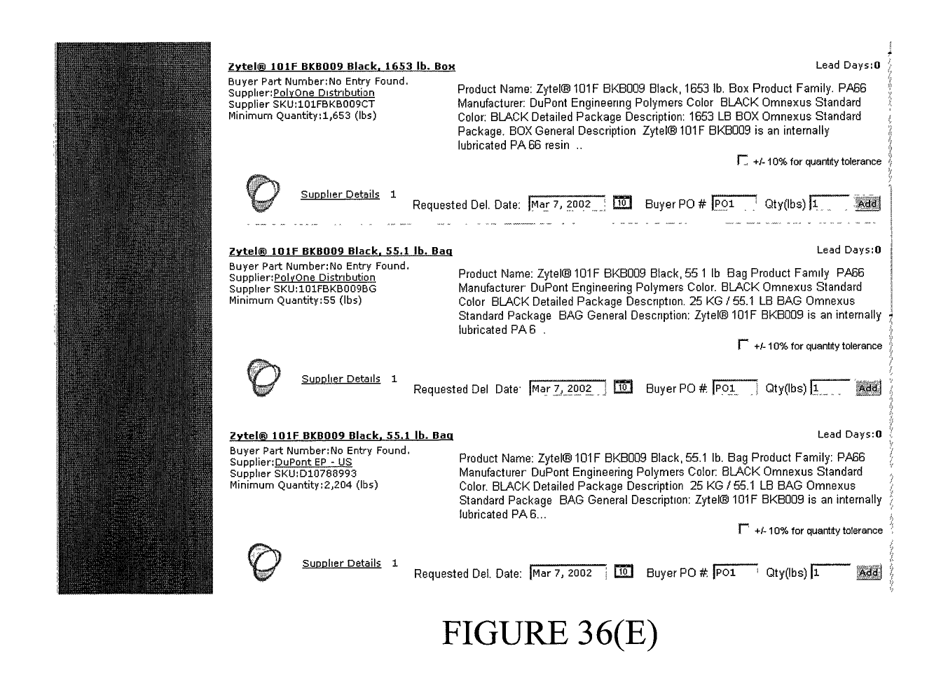

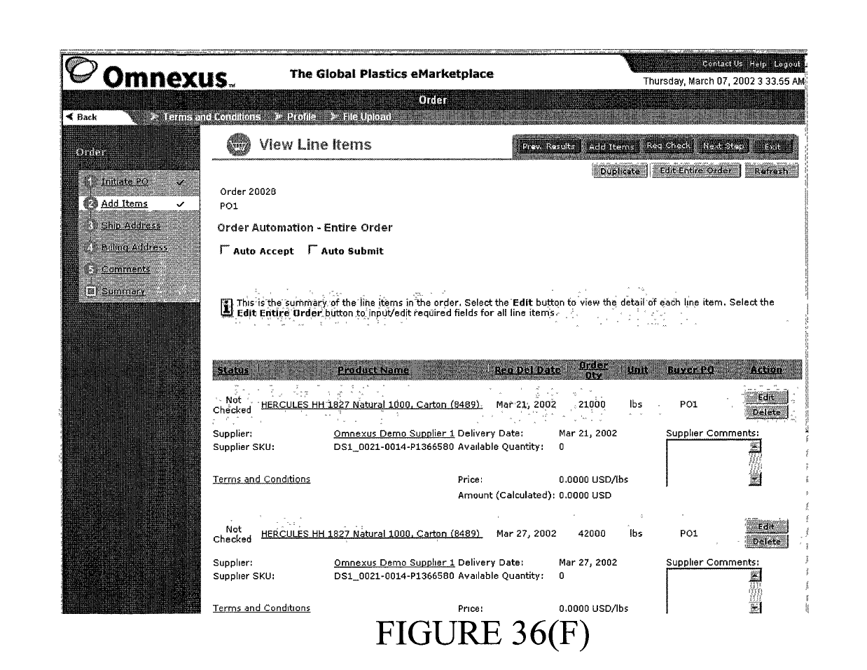

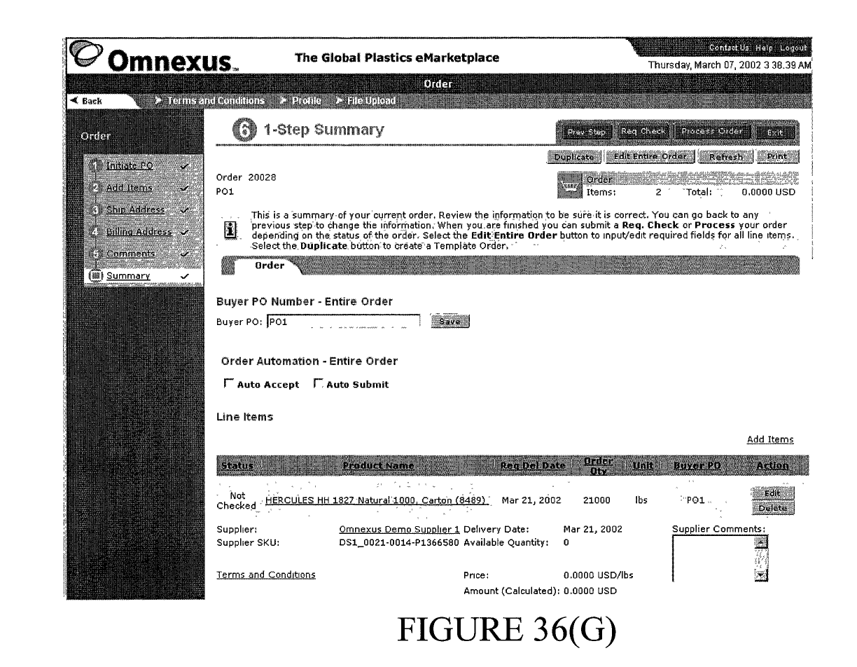

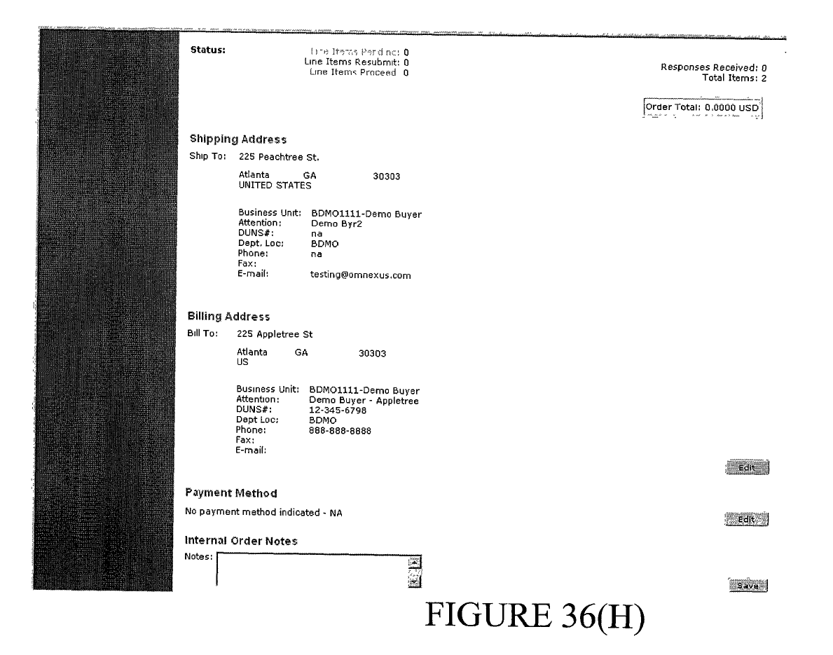

An exemplary set of interfaces regarding the ordering process will now be described with reference to FIGS. 35 to 47. With reference to FIG. 35, the marketplace 10 provides an interface to allow buyers and suppliers manage their orders on the marketplace 10. For buyers, the marketplace 10 provides the interface shown in FIG. 36(A). From this interface, buyers can create a new order, open existing orders, review ship orders, and review closed/template orders. This interface also summarizes the respective numbers of orders and their status, as shown on the left hand side of the interface. Through this summary, buyers can quickly assess the status of all orders and also quickly go to a desired order or set of orders. FIG. 36(B) illustrates the first step in initiating a purchase order, which involves entering a PO number, selecting the automation options, namely Auto-Accept or Auto-Submit, specifying the Ship-To address, and the preferred currency.

Next, as shown in FIGS. 36(C) to 36(F), the buyer adds items to the order. As shown in FIG. 36(C), the buyer can search for desired goods through a catalog and then, as shown in FIGS. 36(D) to 36(F), view the results of a search. From this listing of items, the buyer can specify a requested delivery date, input a PO number, and specify a quantity. The buyer can also select the option to have some quantity tolerance, which in this example is ±10%. After selecting the items, the buyer receives the interface shown in FIG. 36(F) at which time the buyer can choose to Auto-Accept and/or Auto-Submit, can review the terms and conditions associated with each selected item, and can obtain additional information on the product or supplier. After the buyer enters the shipping address and billing address, and comments, the marketplace then provides the buyer with an order summary, such as the one shown in FIGS. 36(G) and 36(H).

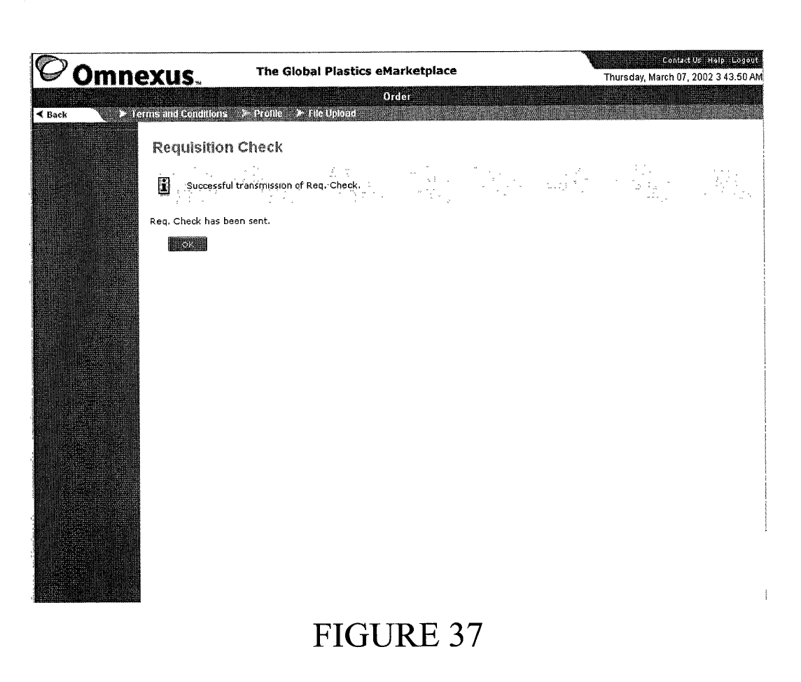

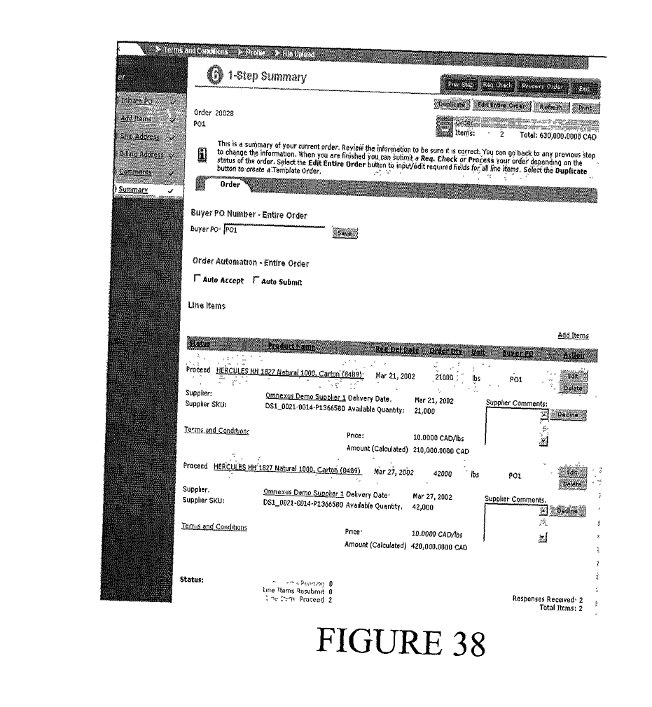

After the order is completed, the buyer can submit a requisition check by selecting the “Req Check” button at the top of the interface shown in FIG. 36(G). If the buyer did select that button, the buyer would then be presented with the interface shown in FIG. 37 which in this example indicates that the requisition check was successfully transmitted. When the marketplace receives the requisition check response from the supplier, the marketplace 10 updates the relevant orders with the information in that response. For example, as shown in FIG. 38, the items in the order are assigned the status of “Proceed” whereas before the requisition check was sent the status of those items was “Not Checked” as shown in FIG. 36(G). Alternatively, the buyer can select the “Process Order” button to have the order sent to the seller.

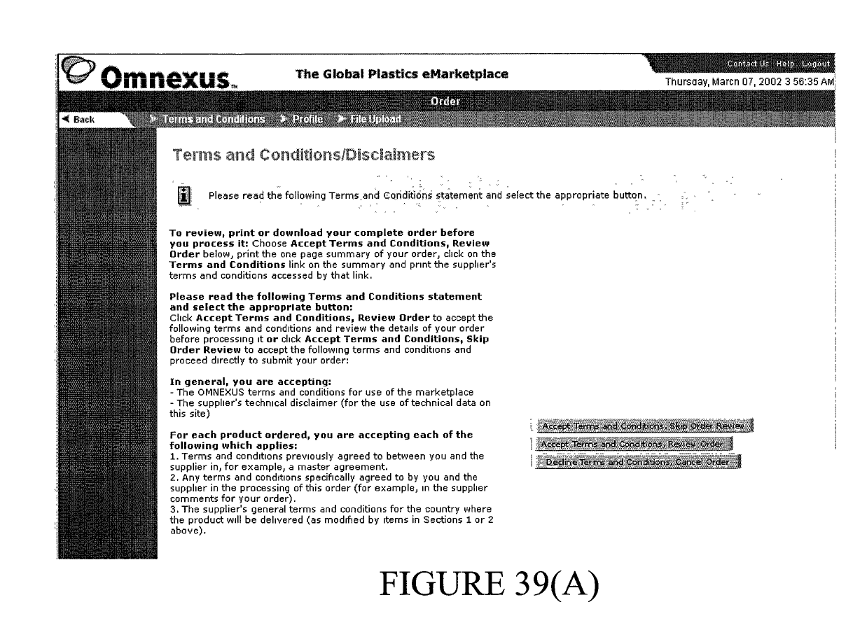

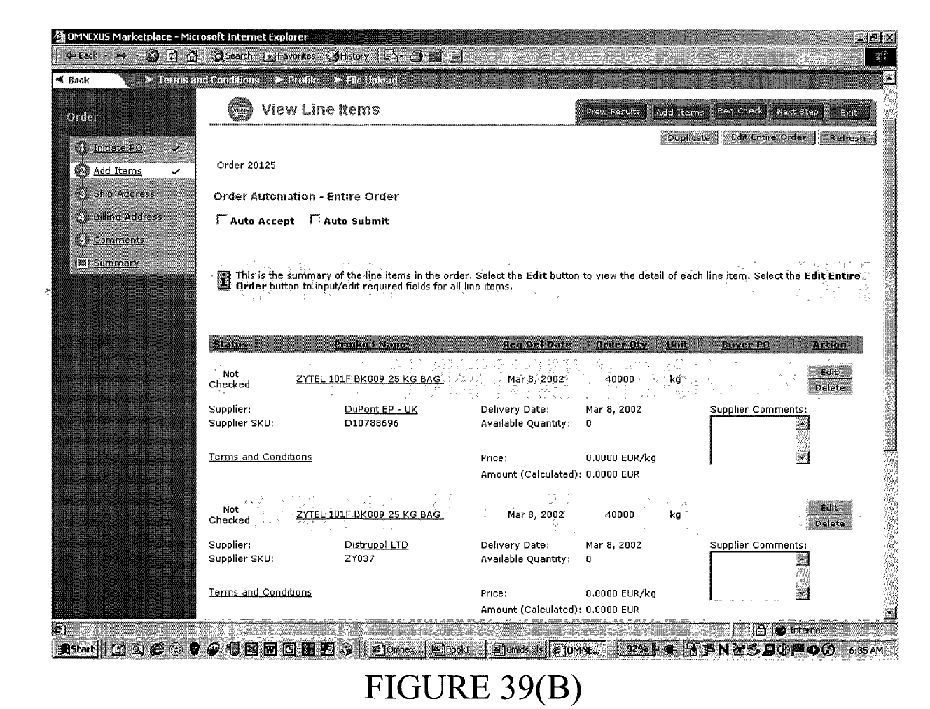

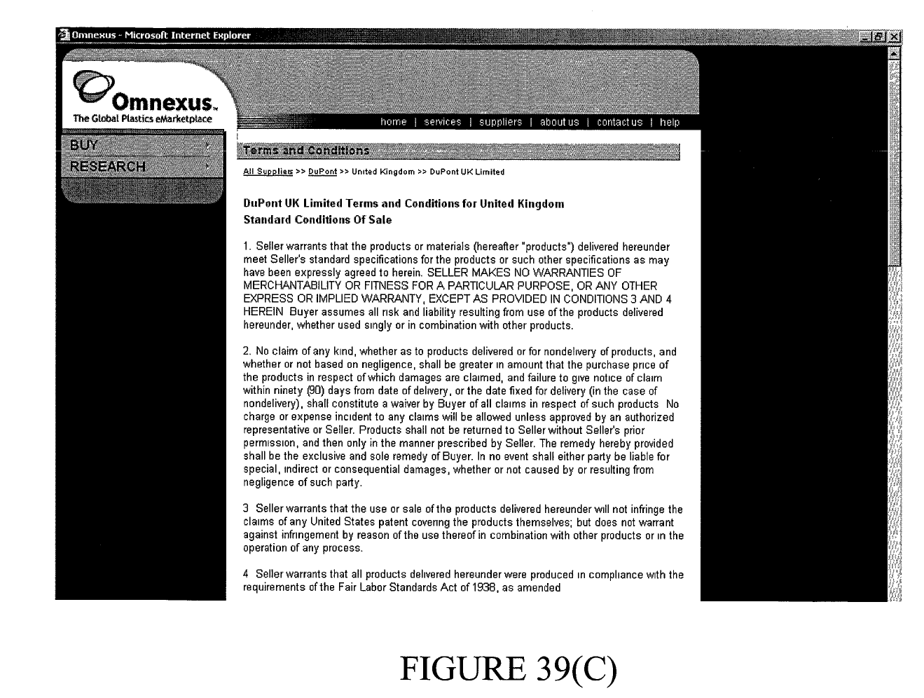

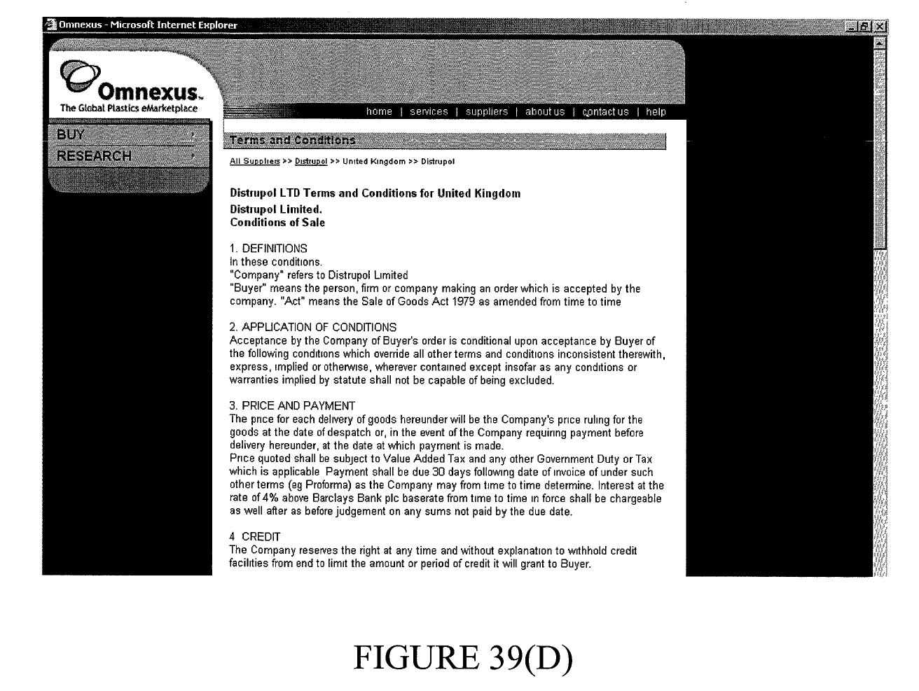

After an order has been completed, and the buyer selected the “Process Order” button, the marketplace then provides the buyer with the interface shown in FIG. 39(A). The buyer is given options to accept the terms and conditions skipping an order review, to accept the terms and conditions and reviewing the order, or to decline terms and conditions and canceling the order. If the Review Order option is selected, the buyer receives a one page summary of the order, similar to the interface shown in FIG. 36(G). By clicking on the “Terms and Conditions” link associated with an item listed in the summary, the buyer can access the terms and conditions governing the purchase of those items from that supplier. As mentioned above, these terms and conditions are specific for that order in that the terms and conditions vary with the country to which the goods are shipped and to the supplier. Significantly, consistent with principles in EU directives focused primarily on protection of consumers in cross-border e-commerce transactions, customers are given an opportunity to review all of the terms and conditions surrounding a transaction before creating a binding on-line contract. As summarized in FIG. 39(A), by selecting one of the accept buttons, the buyer is accepting the terms and conditions for use of the marketplace and the suppliers technical disclaimer. Furthermore, by accepting, the buyer is accepting the terms and conditions from a prior agreement, terms and conditions agreed to in the processing of the order, and the suppliers′ general terms and conditions for the country where the product will be delivered.

The terms and conditions may be reviewed throughout the ordering process. For example, as shown in FIG. 39(B), when adding items to an order the buyer can select the “Terms and Conditions” link to review the contract terms. Upon selection of the “Terms and Conditions” link for items supplied by DuPont, the buyer receives the interface shown in FIG. 39(C) which lists DuPont's terms and conditions for the UK, which is where the items are being shipped. Similarly, when the buyer selects the “Terms and Conditions” link for the items supplied by Distrupol, the buyer receives the interface shown in FIG. 39(D) which has Distrupol's terms and conditions for the UK.

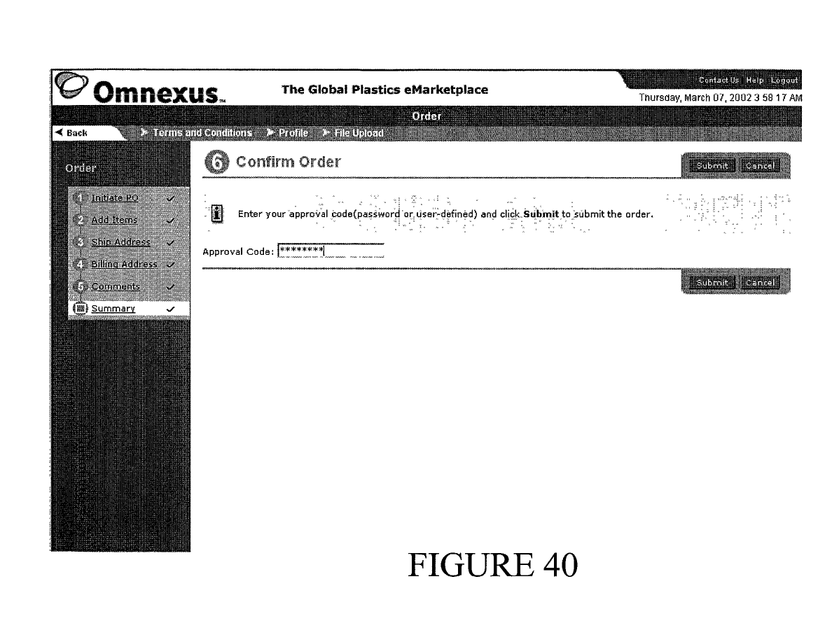

Prior to final submission of the order, the buyer is presented with the interface shown in FIG. 40 in which the buyer confirms the order and also enters an approval code. The approval code provides validation that only authorized users can submit an order and also identifies that particular user.

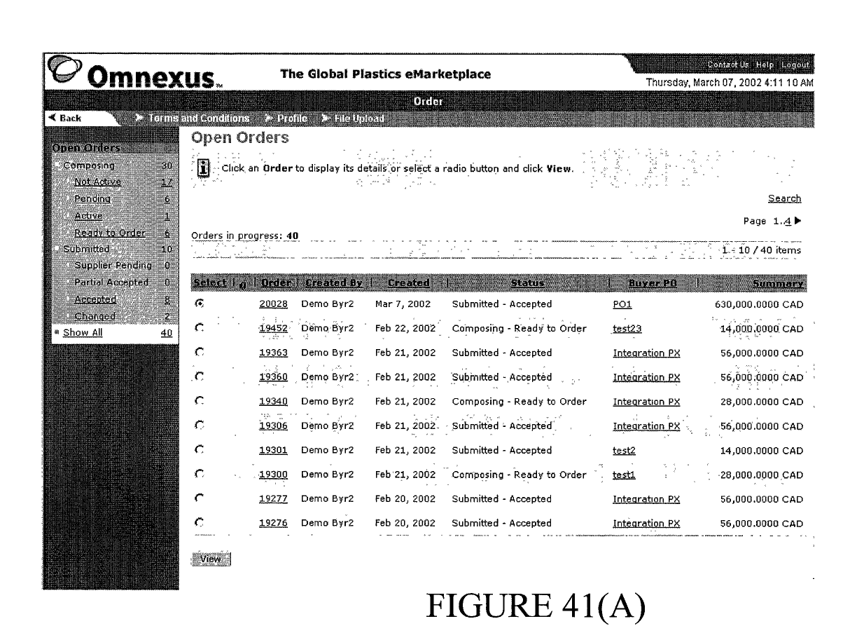

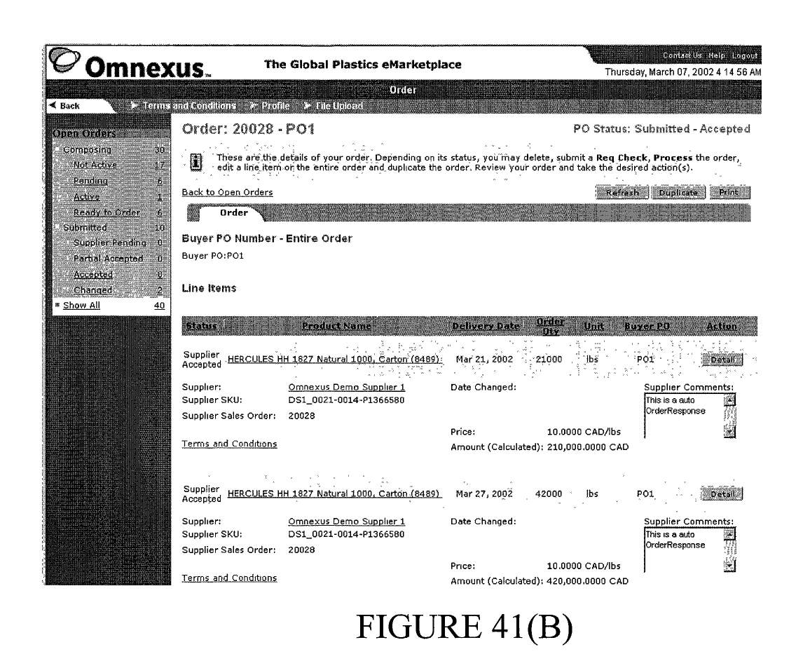

As discussed above with reference to FIG. 36(A), a buyer can view the status of various orders. FIG. 41(A) provides an example of an interface showing a summary of open orders. In this summary, the marketplace provides the buyer with a listing of all open orders, the date the orders were created, the status of each order, the buyer's PO number, and a summary of the order. The buyer can select any one of these orders from the list to view additional details. For example, upon selecting order no. 20028 and selecting the “View” button, the marketplace provides the prior with the interface shown in FIG. 41(B). From this interface, the buyer can review the quantity ordered, the delivery date, the goods themselves, the status, as well as the terms and conditions.

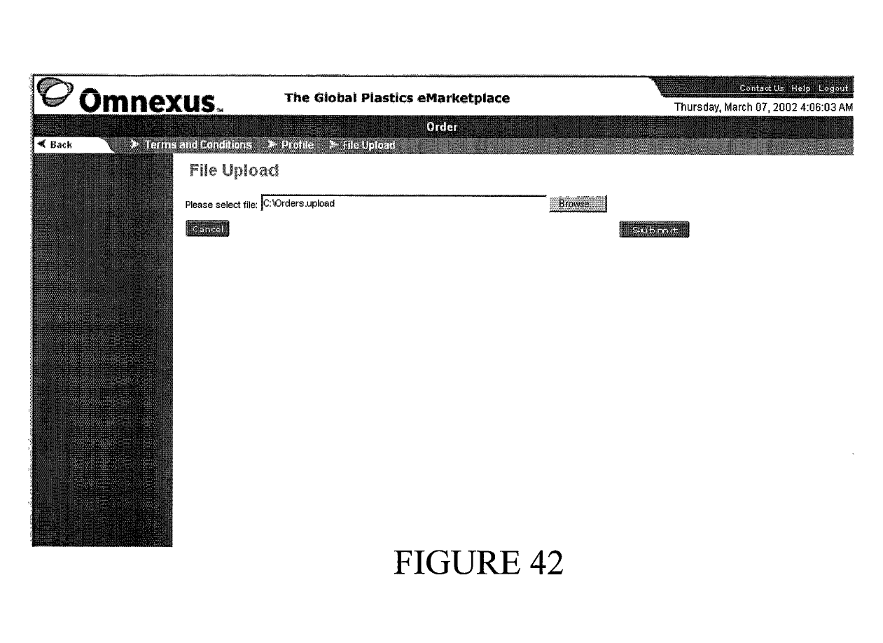

FIG. 42 provides an example of an interface for submitting an order through the UltraLite integration. As discussed above, the buyer may elect to have messaging integration to eliminate the amount of work required by the buyer. Thus, in submitting an order, the buyer can upload a file to the marketplace. With either the UltraLite integration or the order processing described above, the buyer is still presented with all of the terms and conditions to make the submission of the order an offer, which if accepted, creates a binding contract.

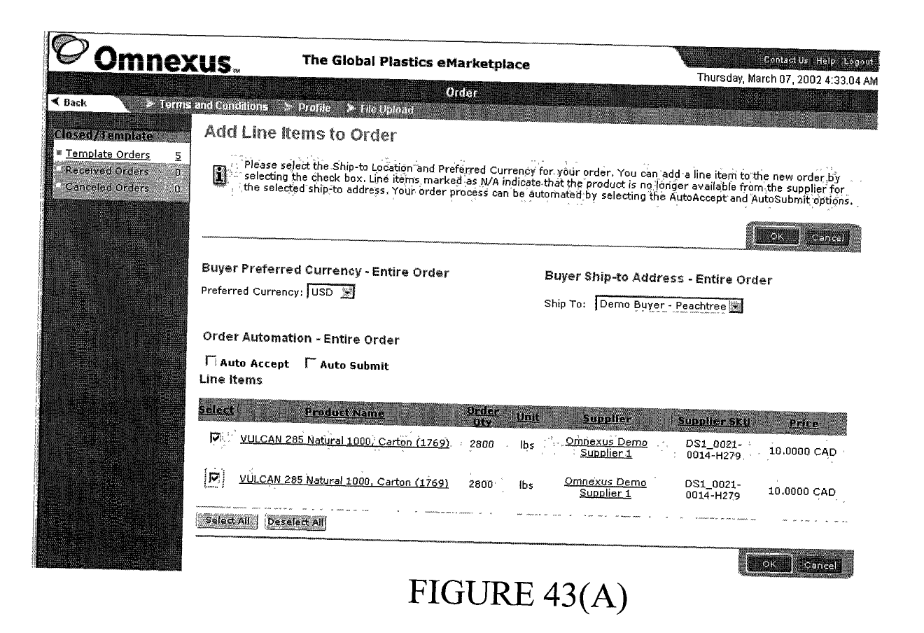

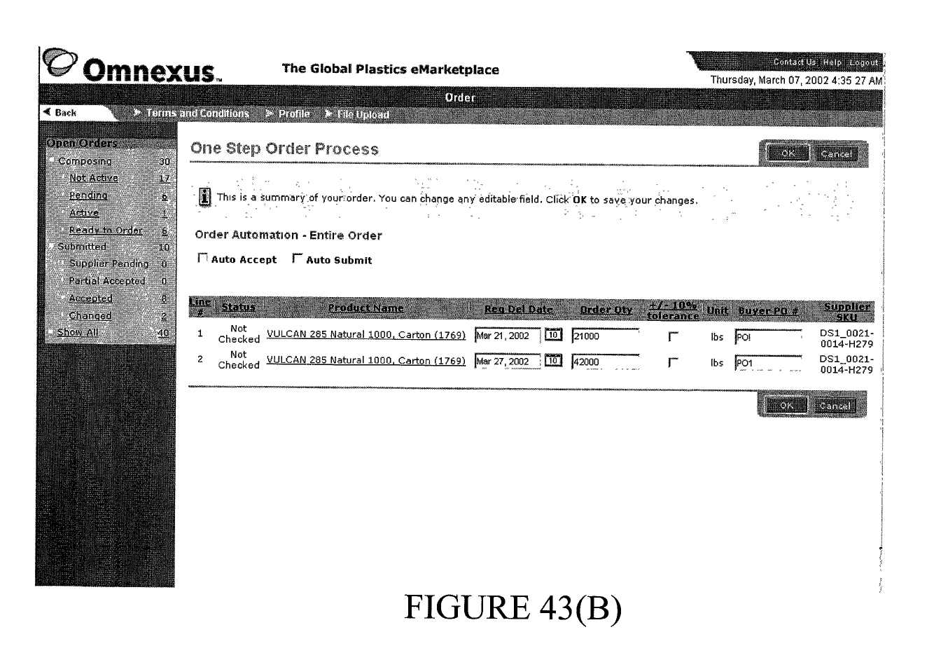

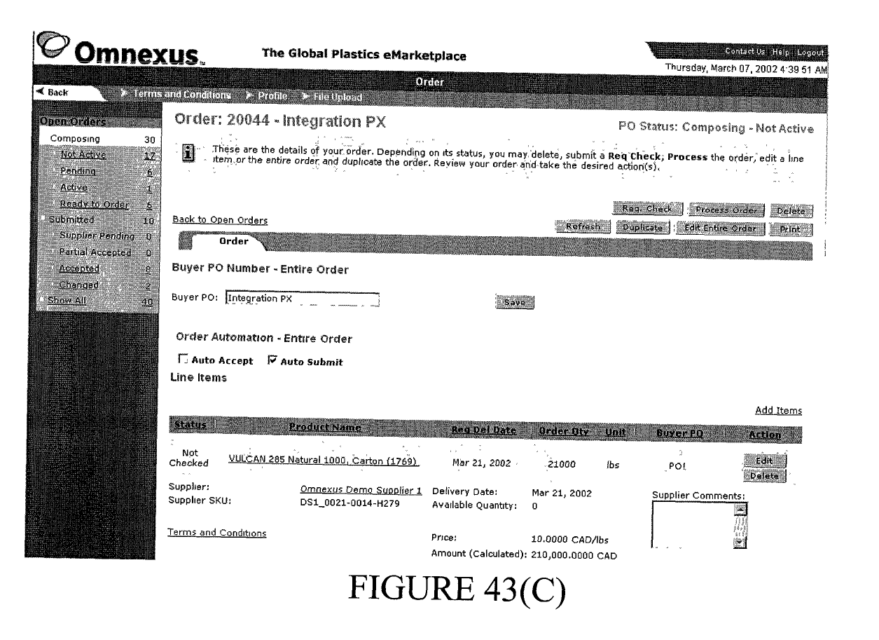

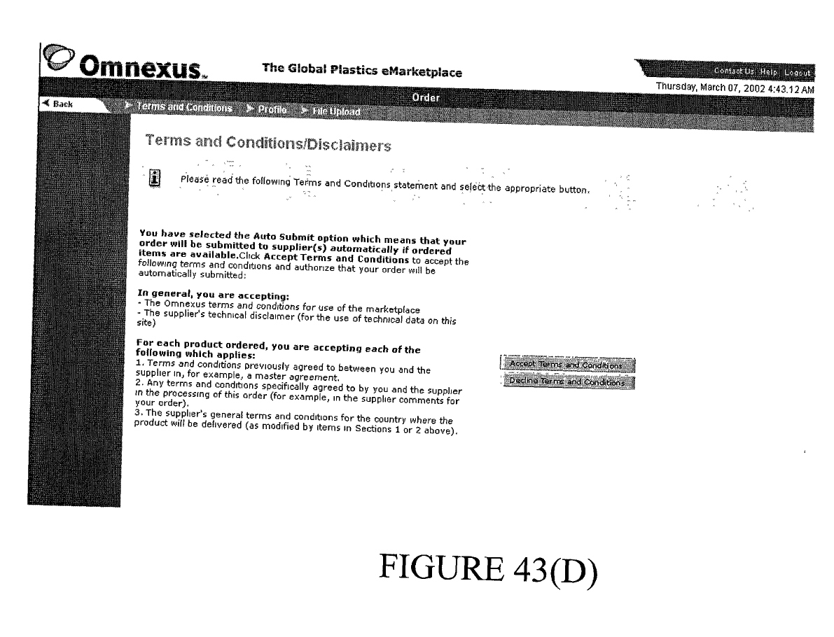

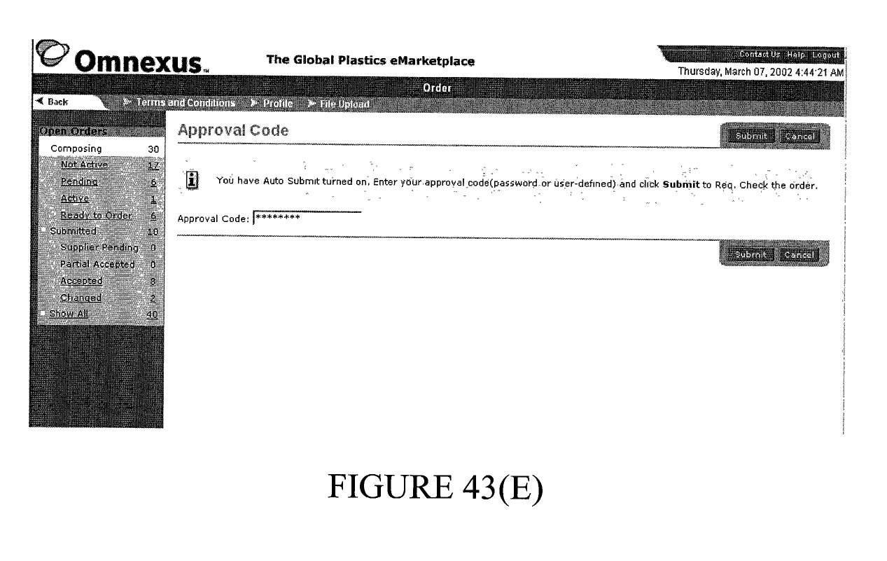

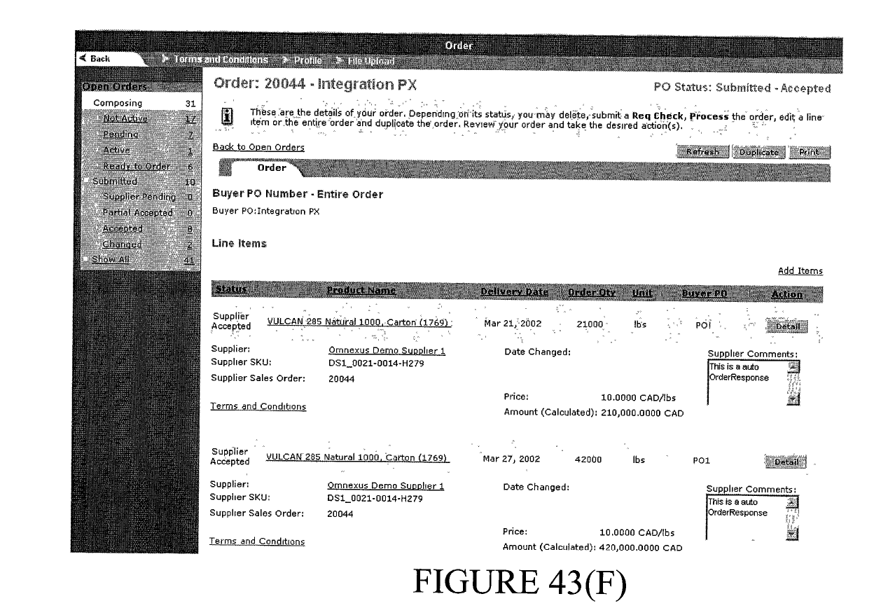

As mentioned above, one of the options available through the interface shown in FIG. 36(A) is to review closed/template orders. FIG. 43(A) provides an example of an interface showing template orders. The buyer can select from previously stored template orders to receive a template order entry interface shown in FIG. 43(B). The buyer can enter a requested delivery date, specify a desired quantity, input a buyer's PO number, and permit some tolerance, if desired. The buyer is then presented with the interface shown in FIG. 43(C) which provides a template order summary. Through this interface, the buyer can initiate a requisition check or process the order. If the buyer chooses to process the order, the buyer is presented with the interface shown in FIG. 43(D) in which the buyer can accept the terms and conditions governing the transaction or decline them. The buyer preferably has the ability to review the terms and conditions prior to accepting them. As shown in FIG. 43(E), the buyer next needs to enter an approval code and then submit the order. When the order was placed with reference to FIG. 43(C), the buyer selected the “Auto-Submit” option. As explained in FIG. 43(D), by selecting the Auto-Submit option, the order is submitted to the supplier automatically if the ordered items are available. As shown in FIG. 43(F), the supplier accepted the order and the status of the orders are shown as “Supplier Accepted.”

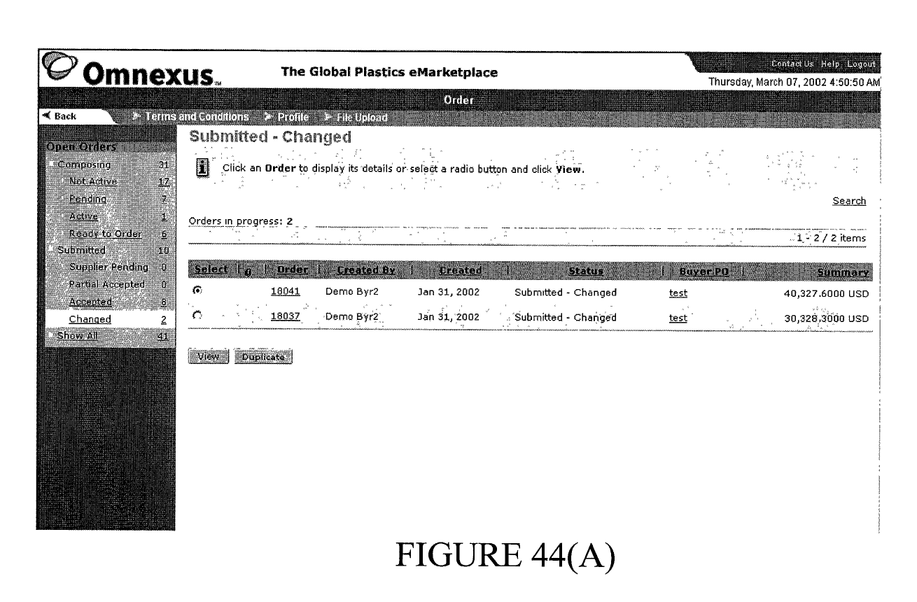

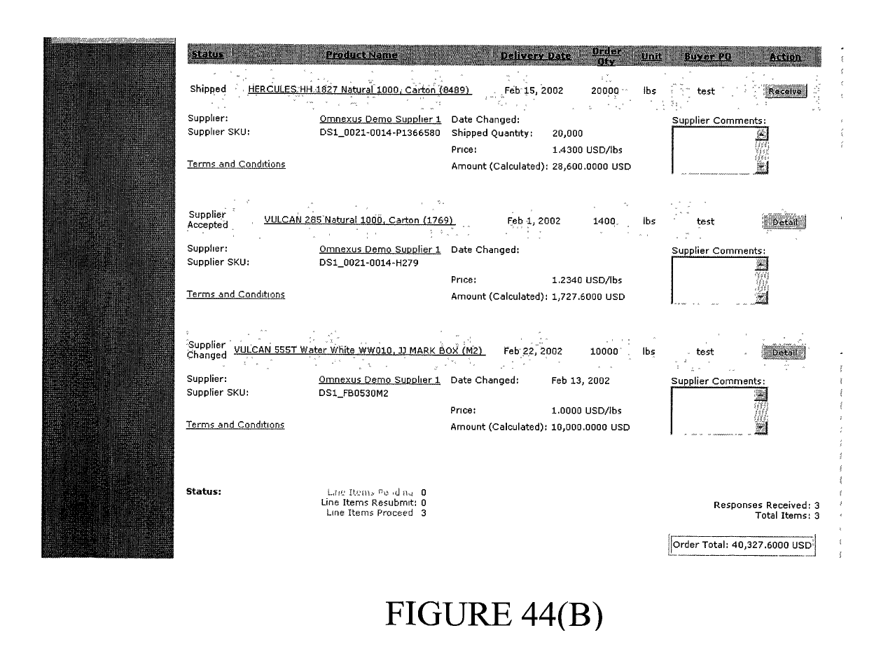

From the interface shown in FIG. 36(A), a customer can also obtain a summary of all changed orders, such as the change orders shown in FIG. 44(A). The customer can select desired orders from the list and click on the “View” button and obtain details of the orders, as shown in FIG. 44(B). FIG. 44(B) is an example of an interface providing change order details.

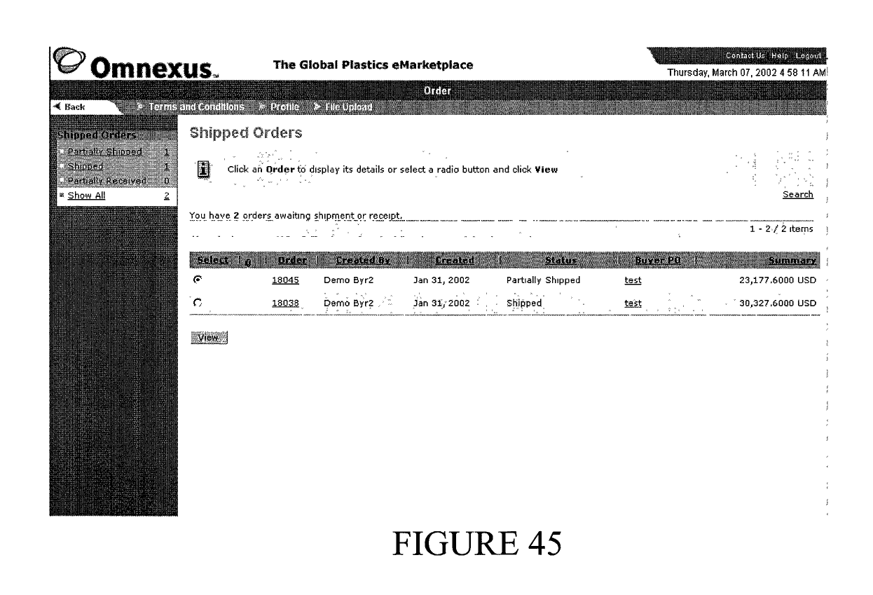

Another group of orders that a customer can review are shipped orders. FIG. 45 provides an example of an interface showing a list of shipped orders and the status of those orders, such as shipped, partially shipped, and partially received.

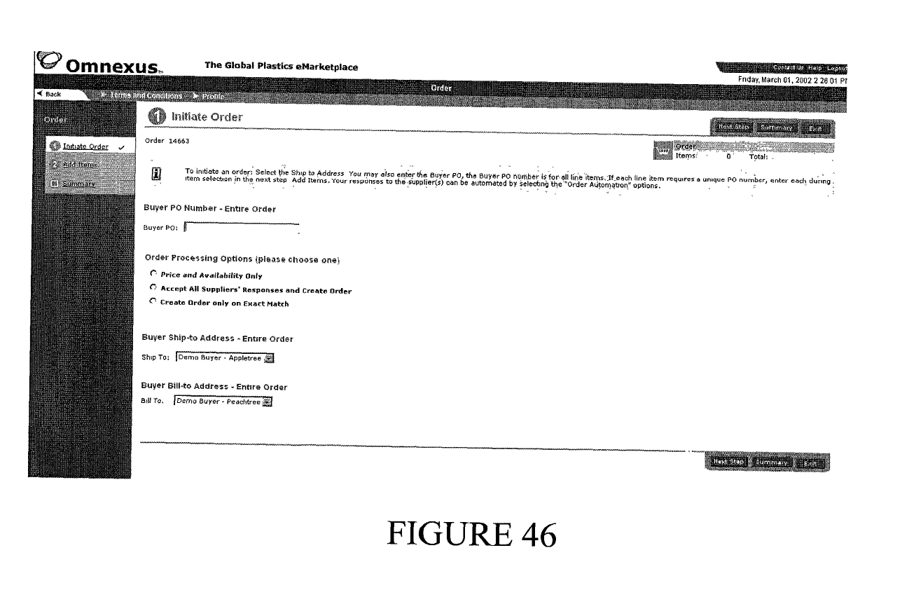

FIG. 46 illustrates a simplification of the ordering process according to another embodiment of the invention. As shown in FIG. 46, when initiating an order, the customer has the option of selecting a price and availability check only, to accept all suppliers responses and create an order, or to create an order only on an exact match.

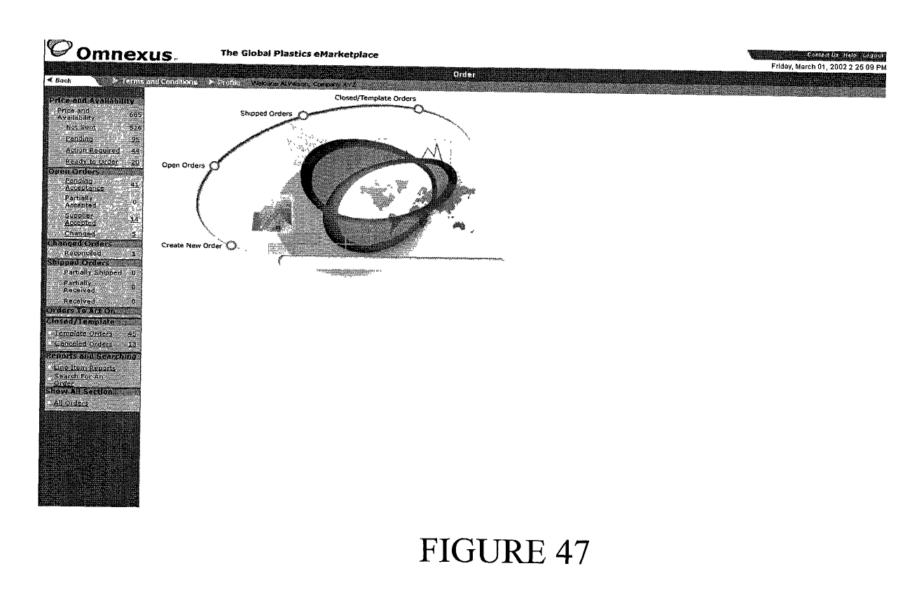

FIG. 47 illustrates an interface which is an alternative to the interface shown in FIG. 36(A). With the interface in FIG. 47, customers can see more clearly the logical cycle of the ordering process from the price and availability checks, to open orders, to change orders, to shipped orders, to orders to act on, to closed/template orders, to reports and searching, and an option to show all orders.

B. Cash Process

The marketplace 10 preferably permits electronic invoice presentment and payment (EIPP) for the buyers and suppliers. One suitable EIPP solution is provided by BillingZone, LLC of Pittsburgh, Pa. The invention is not limited to this particular solution but may employ other EIPP solutions for effectuating payment between the buyers and suppliers.

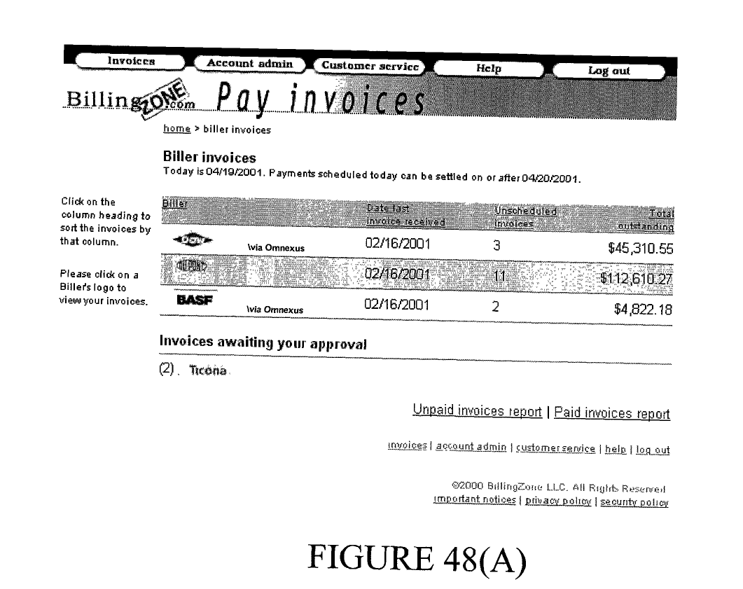

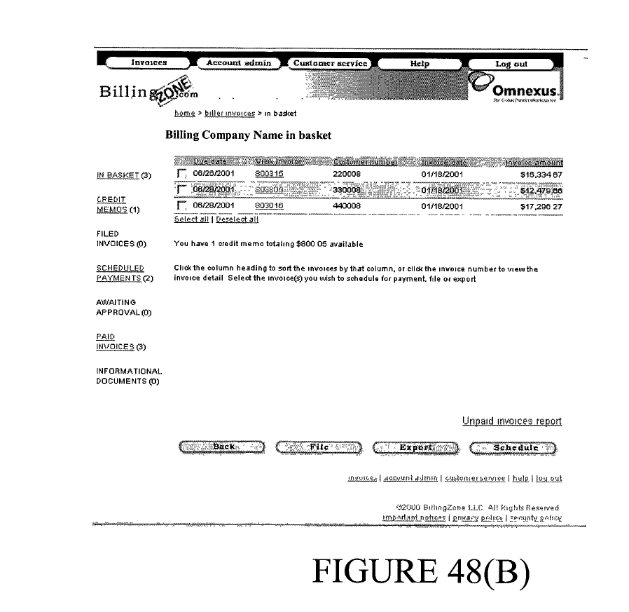

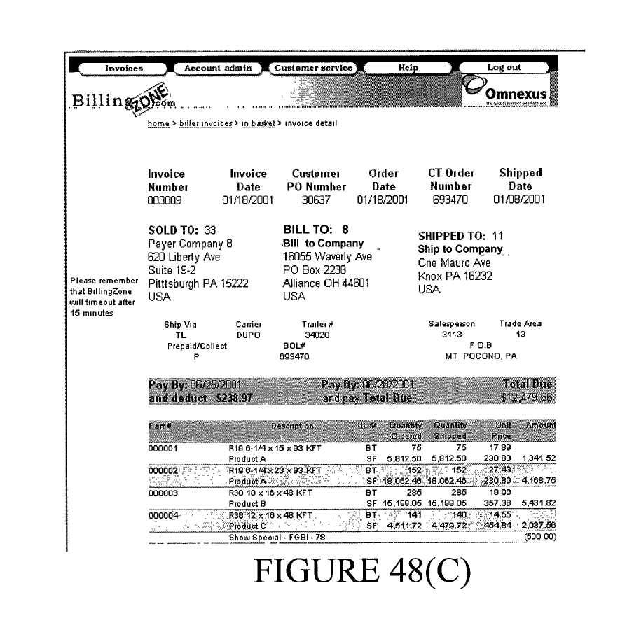

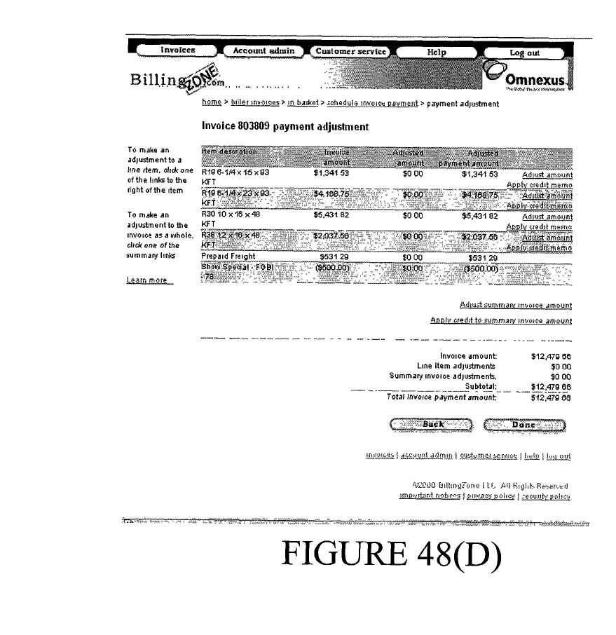

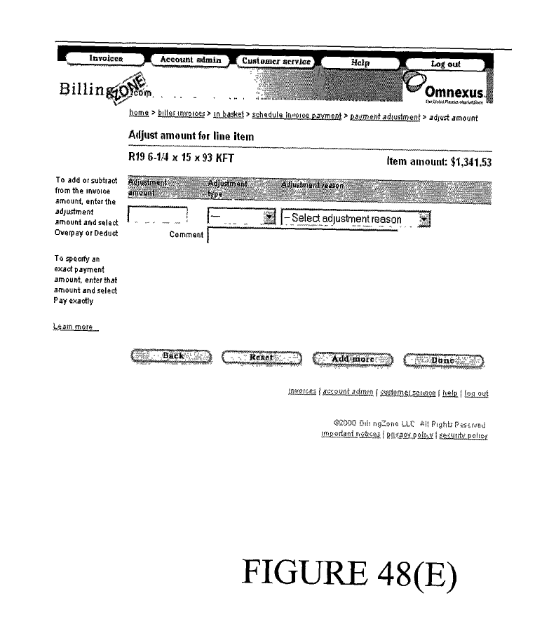

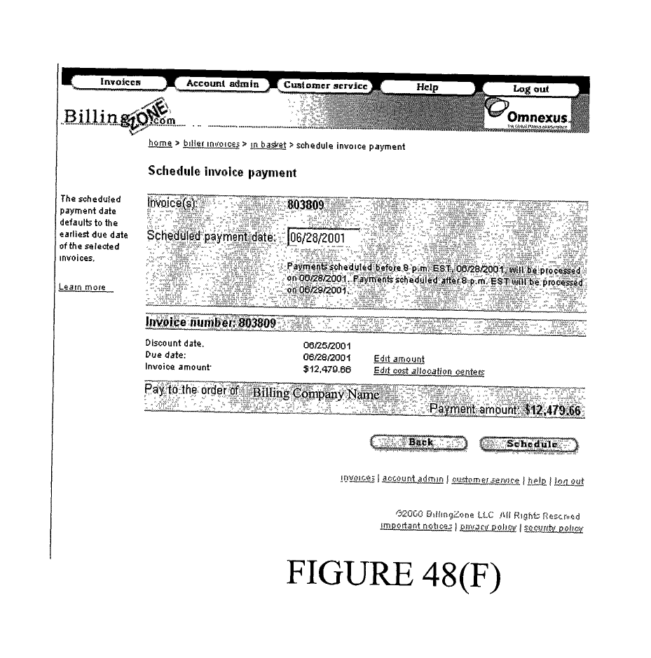

An explanation will now be given on the invoicing and payment aspects of the marketplace 10. FIG. 48(A) illustrates an invoice summary that is presented to the buyer. From this summary page, the buyer can sort invoices by the biller, by the date the last invoice was received, based on unscheduled invoices, or based on total outstanding. In addition to biller invoices, the buyer can also review invoices awaiting approval from the buyer.

FIG. 48(B) provides an example of an invoice summary page for the supplier. From this summary page, the supplier can review invoices in basket, credit memos, filed invoices, scheduled payments, invoices awaiting approval, paid invoices, as well as informational documents. Upon selecting one of the invoices, such as invoice 803809, the supplier can view the invoice in greater detail, as shown in FIG. 48(C). The adjustments that have been made in the amount billed can be viewed in a summary form in FIG. 48(D) and the supplier can make an adjustment in an amount by selecting one of the items, at which time the supplier will receive the interface shown in FIG. 48(E). Finally, the supplier can receive a settlement view in the interface shown in FIG. 48(F).

C. Sourcing

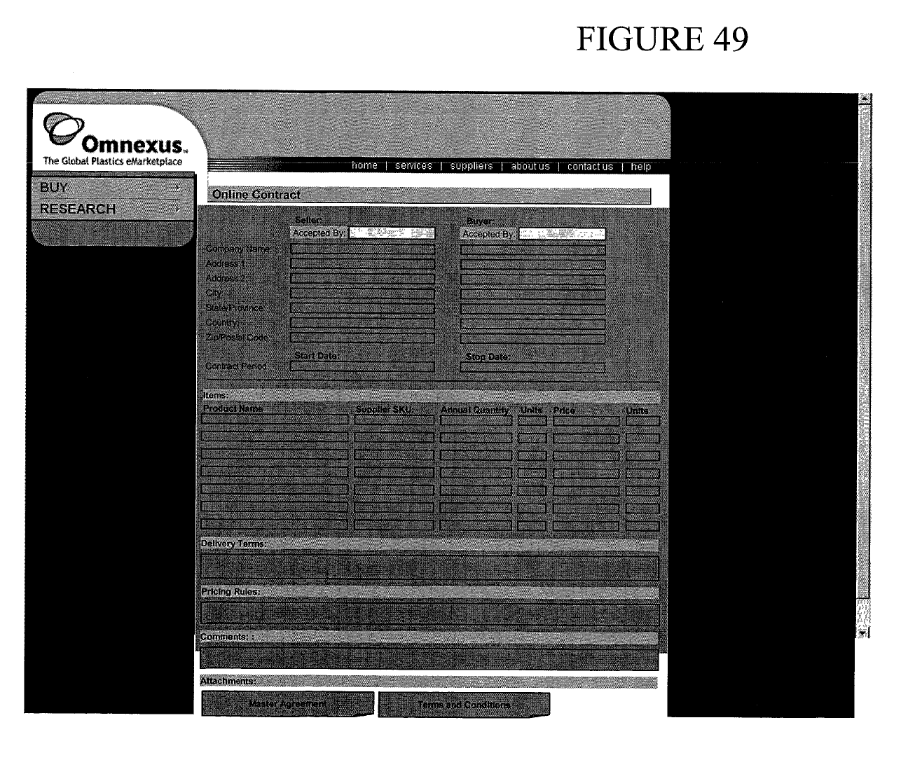

An example of an interface for sourcing goods is illustrated in FIG. 49. As shown in this Figure, the buyer and supplier can specify a contract period and the items to be delivered over that contract period. The parties can also specify the annual quantity for each of the items, the delivery terms, pricing rules, and attach any existing Mater Agreement between the parties. Thus, marketplace 10 gives the parties the opportunity to review all terms and conditions of the contract between the parties, including terms in any Master Agreement and the terms supplied by default through the marketplace 10.

VI. System Architecture

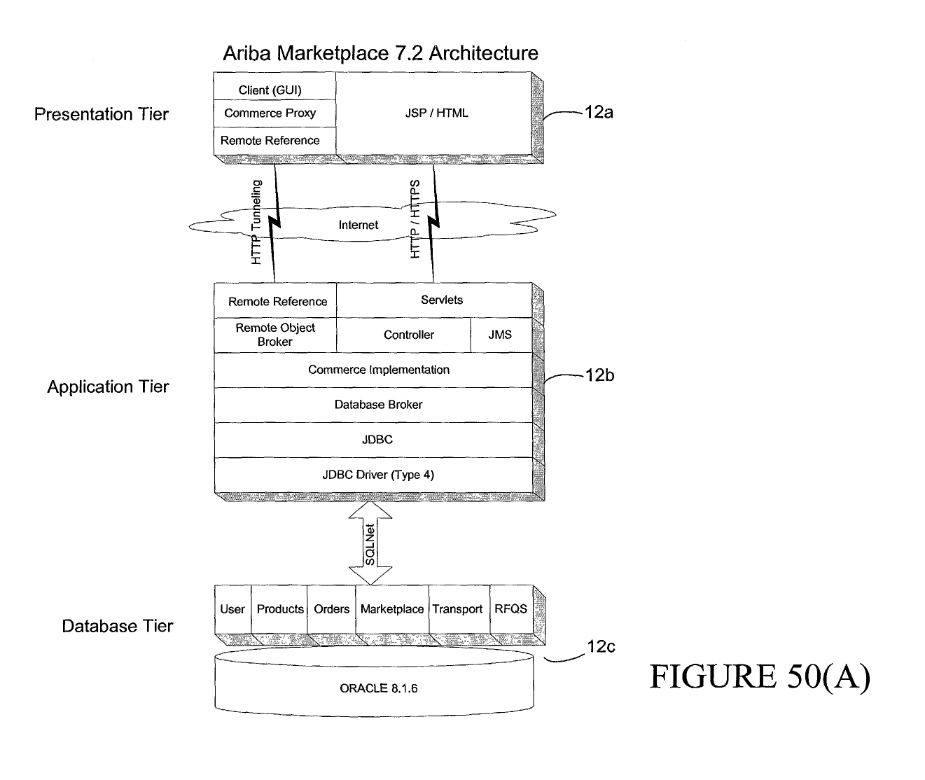

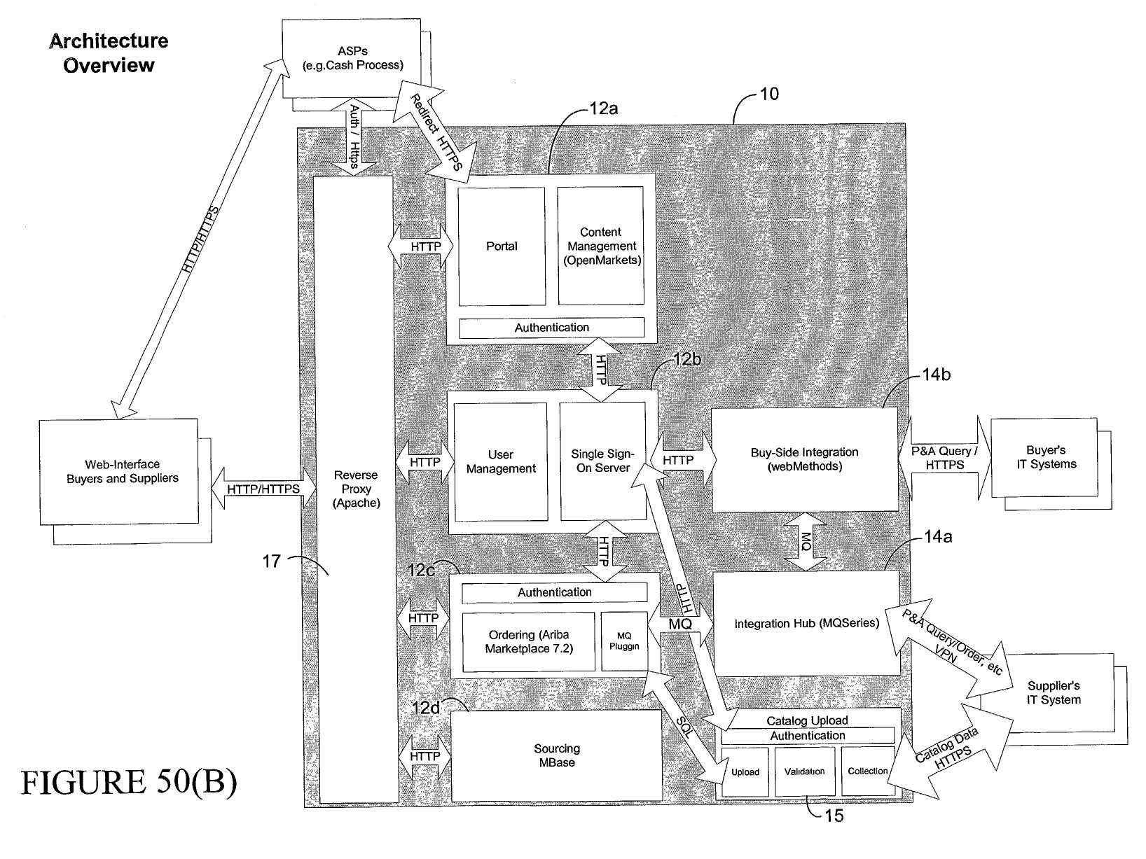

The processes described above may be implemented in a number of different ways with a number of different configurations of systems. FIGS. 50 and 51 provide one example of a system for executing the process flows. FIG. 50(A) illustrates a logical diagram of the architecture for the marketplace 10, illustrating the presentation layer 12a, the application layer 12b, and the database layer 12c. The database layer 12c includes data on the users, products, orders, marketplace, transports, and RFQs. The application layer 12b includes a database broker for use in accessing the database layer 12c, servlets for use in interfacing with the presentation layer 12a, and a commerce implementation for performing the execution of process flows.

A more detailed diagram of the architecture is shown in FIG. 50(B). The marketplace 10 includes the integration hub 14 for messaging with the buyers and suppliers. The integration hub 14 includes an integration hub for messaging with suppliers and a buy-side integration hub 14b for messaging with buyers. The order application unit 12 includes a unit 12a comprising a portal, OpenMarket, now known Divine, content management, an authentication unit, a unit 12b for user management and single sign-on server, a unit 12c for authentication and ordering such as the Ariba Marketplace 7.2, and a unit 12d for sourcing. The marketplace 10 also includes a catalog unit 15 handling the upload, validation, and collection of catalog data. The marketplace 10 also includes a reverse proxy, such as one from Apache, for handling communications between customers and ASPs.

Automation of the source-order to cash process and components thereof through the marketplace 10 for direct materials offers significant value to buyers and sellers. Due to the complexity of supply chains and trading partner relationships within supply chains, many companies get involved in the manufacture of finished products. This is particularly true in a supply chain where one or more levels is fragmented with many smaller companies serving fewer larger companies. The processes described above provide significant productivity improvements within the supply chain by improving the information flow and automating the transaction process through e-commerce. Specifically, value is created by reducing the cost for individual companies to execute the sourcing process, which includes present, select quote, contract, forecast demand, and audit contracts. Also, value is created by reducing the cost for individual companies to execute the order to cash process, which includes negotiating for price, negotiating availability, processing orders, tracking order status, invoicing, acknowledging receipt of goods, and paying for goods purchased. Additionally, value is created by integrating the sourcing and order to cash processes.

A source of value creation is the more efficient use of assets. This includes increased human resource productivity, lower inventories, higher manufacturing capacity utilization and elimination of redundant information technology costs.

Core to the sourcing-order to cash process shown in FIG. 25(A) is the support of contract formation between the buyer and seller for Master Agreements and other repeated purchases under one contract over time and orders, such as specific purchase events within or without a Master Agreement. The processes and the marketplace 10 comply with controlling law, which is of particular value in providing a multi-country or global solution by meeting local legal requirements, language requirements and business practices.

By integrating both the sourcing and order-to-cash process, the value creation is significantly increased. This solution supports existing business practiced in the industry, enables individual companies participating in the marketplace to independent set prices and business policies and practices while providing standardization of information flows and formats. Additionally, the processes minimize the cost of integration with the marketplace to lower the barrier to participation, enabling adoption of this more productive business process.

The marketplace 10 and processes offer a number of improvements. With respect to human resource productivity, the marketplace 10 automates each sub process to minimize involvement by people, integrates information technology systems of all participating buyers and suppliers, provide alert notification to advise users of exceptions, provides a manual interface for management of exceptions, minimizes the manual processing steps, automates information flow among steps, offers centralized system administration for industry system and standardized master account information, automates work flow in decision making processes, maximizes the number of transactions or events that cam be managed between information technology systems by standardizing information format and flows and enabling business rules for trading partners. The marketplace 10 and processes provide automated reconciliation across the source order to cash process, reconciliation of prices, quantities, materials for contracts (Master Agreements) with demand forecasts, orders, invoices, receipt of goods, and payments with discrepancies identified, reconciliation of prices, quantities, materials for price and availability requests with orders, invoices, receipt of goods, and payments, and reconciliation requests for quotes with contracts.

The marketplace 10 and processes also permit lower inventories. The marketplace 10 and processes increase the time period between order and delivery of order, increase the accuracy of demand forecast, and increase the coverage of improved demand forecasting and orders with increased period between order and delivery.

The marketplace 10 and processes permit higher manufacturing capacity utilization. The marketplace 10 and processes increase the time period between order and delivery of order, increase the accuracy of demand forecast, increase the coverage of improved demand forecasting and orders with increased period between order and delivery, and increase supplier reach, to quickly locate buyer for incremental capacity.

The marketplace 10 and processes eliminate redundant information technology costs. The cost of an independent marketplace that services an industry or multiple industries for the sourcing-order to cash business process or components thereof is similar to the cost for any individual marketplace participant to provide a similar solution. This creates significant cost leverage.

The UltraLite integration is another advantage of the invention. The UltraLite integration offers the lowest incremental cost for integration with Buyer for e-marketplace order placement which leverages existing ERP system, leverages existing access to the internet, and requires a minimal one time set up cost. The UltraLite integration can be expanded incrementally to additional levels of integration including change request, order response, change request response, shipping notice, invoice, etc.

The P&A query is another benefit to buyers and suppliers provided by the marketplace 10. Currently prices and availability are determined by dialog between buyer and seller for each specific order. The marketplace 10 and processes permit this P& A query to occur as part of the ordering process.

With both UltraLite integration and the P&A query, an order process can be initiated through an integration hub or browser accessed marketplace 10 without human intervention, following the initial setup. This order can be automatically process through the marketplace 10 with directly to ERP systems of integration suppliers. Other than for exceptions identified by the marketplace 10, where the request did not match the response, no manual intervention is required.

The foregoing description of the preferred embodiments of the invention has been presented only for the purpose of illustration and description and is not intended to be exhaustive or to limit the invention to the precise forms disclosed. Many modifications and variations are possible in light of the above teaching.

The embodiments were chosen and described in order to explain the principles of the invention and their practical application so as to enable others skilled in the art to utilize the invention and various embodiments and with various modifications as are suited to the particular use contemplated.

What is claimed:

1. A method of forming an on-line contract between a buyer and a seller for the purchase of goods, comprising:
the buyer requesting a requisition check on desired goods and generating an electronic requisition check message;
the seller receiving the electronic requisition check message;
the seller determining the ability to fulfill the requisition check on the desired goods requested by the buyer;
the seller generating an electronic requisition check response reflecting the ability of the seller to fulfill the requisition check on the desired goods;
the buyer generating an order based on the response to the requisition check on the desired goods;
the seller receiving the order and generating an order response, the order response containing an indication of the seller's acceptance of the order.

2. The method as set forth in claim 1, wherein requesting a requisition check comprises requesting a check on price of goods and determining the ability to fulfill the requisition check comprises responding to the check on the price of goods.

3. The method as set forth in claim 1, wherein requesting a requisition check comprises requesting a check on availability of goods and determining the ability to fulfill the requisition check comprises responding to the check on the ability of the availability of goods from the seller.

4. The method as set forth in claim 1, wherein requesting a requisition check comprises requesting a check on price and availability of goods and determining the ability to fulfill the requisition check comprises responding to the check on the price and availability of the goods from the seller.

5. The method as set forth in claim 1, wherein the buyer requesting a requisition check involves items from multiple sellers and wherein the seller receiving the electronic requisition check message comprises a plurality of sellers receiving the electronic requisition check message for goods associated with each seller.

6. The method as set forth in claim 1, wherein requesting a requisition check comprises issuing the requisition check from the buyer's enterprise resource system.

7. The method as set forth in claim 1, further comprising receiving a change order request from one of the buyer and seller on an order and receiving a response from the other of the buyer and seller on the change order request.

8. A method of enabling an on-line contract to be created between a buyer and a seller for the purchase of goods through an on-line marketplace, comprising:
receiving a price and availability check message from a buyer at the on-line marketplace, the price and availability check message requesting information from a seller on the availability and price of desired goods from the seller;
forwarding the price and availability check message from the on-line marketplace to the seller associated with the desired goods;
receiving a price and availability response at the on-line marketplace from the seller reflecting the availability of the desired goods requested by the buyer;
forwarding the price and availability response from the on-line marketplace to the buyer;
receiving an order from the buyer for the desired goods at the on-line marketplace, the order identifying the availability and price of the desired goods;
forwarding the order from the on-line marketplace to the seller;
receiving an order response from the seller at the on-line marketplace, the order response containing an indication of the seller's acceptance of the order.

9. The method as set forth in claim 8, wherein receiving the price and availability request message comprises receiving the price and availability request message related to multiple items from multiple sellers and forwarding the price and availability request message comprises forwarding the price and availability request message to the multiple sellers.

10. The method as set forth in claim 8, wherein receiving the price and availability check message from the buyer comprises receiving the price and availability check message through a file transfer from the buyer.

11. The method as set forth in claim 8, wherein receiving the order from the buyer comprises receiving authorization from the buyer to automatically accept the order.

12. The method as set forth in claim 8, wherein receiving the price and availability check message comprises receiving the price and availability check message from a buyer's enterprise resource planning system.

13. The method as set forth in claim 8, further comprising receiving a change order request specifying a change in the order from one of the buyer and seller and receiving a change order response from the other of the buyer and seller.

14. The method as set forth in claim 8, further comprising forming a master agreement between the buyer and the seller governing sourcing of goods from the seller to the buyer and receiving the order from the buyer and receiving the order response from the seller are for fulfilling an order under the master agreement.

15. The method as set forth in claim 8, further comprising demand forecasting and initiating the price and availability request based on the demand forecasting.

16. The method as set forth in claim 8, further comprising providing notification to the buyer on a shipping status of the goods.

17. The method as set forth in claim 8, further comprising providing notification to the seller upon receipt of the goods by the buyer.

18. The method as set forth in claim 8, further comprising invoicing the buyer on behalf of the seller.

19. The method as set forth in claim 8, further comprising assisting in payment of the seller by the buyer.

20. A method of enabling sourcing of goods from a seller to a buyer through an online marketplace, comprising:
receiving a selection of desired goods from the buyer at the on-line marketplace;
receiving a request for a quote from the buyer at the on-line marketplace, the request for the quote seeking the quote for the seller to source the desired goods to the buyer;
forwarding the request for the quote from the on-line marketplace to the seller;
receiving a response to the request for quote from the seller at the on-line marketplace, the response from the seller providing the quote for the seller to source the desired goods to the buyer;
generating at the on-line marketplace terms of a master agreement between the buyer and seller;
forecasting at the on-line marketplace demand by the seller for the desired goods; and
facilitating at the on-line marketplace orders dictated by the terms of the master agreement.

21. The method as set forth in claim 20, further comprising:
receiving a price and availability check message from the buyer at the on-line marketplace, the price and availability check message requesting information from a seller on the availability and price of desired goods from the seller;
forwarding the price and availability check message from the on-line marketplace to the seller associated with the desired goods;
receiving a price and availability response at the on-line marketplace from the seller reflecting the availability of the desired goods requested by the buyer;
forwarding the price and availability response from the on-line marketplace to the buyer;
receiving an order from the buyer for the desired goods at the on-line marketplace, the order identifying the availability and price of the desired goods;
forwarding the order from the on-line marketplace to the seller; and
receiving an order response from the seller at the on-line marketplace, the order response containing an indication of the seller's acceptance of the order.

22. The method as set forth in claim 20, further comprising receiving a change order request specifying a change in the order from one of the buyer and seller and receiving a change order response from the other of the buyer and seller.

23. The method as set forth in claim 20, further comprising providing an on-line catalog of goods from the sellers.

24. The method as set forth in claim 20, further comprising reconciling orders with the master agreement.

25. The method as set forth in claim 20, further comprising managing payment between the buyer and the seller.

26. The method as set forth in claim 25, further comprising reconciling payment with the master agreement.

27. A method of forming an on-line contract between a buyer and a seller, comprising:
providing an on-line marketplace for the sale of goods from the seller to the buyer;
receiving an order for goods from the buyer, the order specifying a country where the goods will be shipped;
providing terms and conditions from the seller governing transactions in a plurality of countries;
linking, with the order, the terms and conditions from the seller for the country where the goods will be shipped as specified in the order;
providing an opportunity for the buyer to review the terms and conditions from the seller for the country where the goods will be shipped; and
receiving acceptance of the order from the seller;
wherein receiving the order from the buyer constitutes an offer under the on-line contract and receiving the acceptance results in the forming of the on-line contract.

28. The method as set forth in claim 27, further comprising providing both the buyer and the seller an opportunity to abort an order based on input error.

29. The method as set forth in claim 27, further comprising providing a centralized dispute resolution procedure for the buyer and seller.

30. The method as set forth in claim 27, further comprising permitting the on-line contract to be governed by terms and conditions provided through an existing agreement between the buyer and seller.

31. The method as set forth in claim 27, further comprising permitting the buyer and seller to depart from the terms and conditions provided by the seller for the country where the goods will be shipped.

32. The method as set forth in claim 27, wherein providing terms and conditions from the seller governing transactions in a plurality of countries comprises receiving the terms and conditions from the seller.

33. The method as set forth in claim 32, wherein receiving the terms and conditions comprises receiving terms and conditions that vary with each country.

34. The method as set forth in claim 32, wherein receiving the terms and conditions comprises receiving technical disclaimer on the goods from the seller.

35. The method as set forth in claim 32, wherein receiving the terms and conditions comprises receiving terms and conditions from multiple sellers.

36. The method as set forth in claim 35, wherein receiving the terms and conditions from multiple sellers comprises receiving different terms and conditions from the sellers for each country.
